(19) United States
(12) Patent Application Publication
(10) Pub. No.: US 2025/0105291 A1
(43) Pub. Date: Mar. 27, 2025

(54) BATTERY

(71) Applicant: Semiconductor Energy Laboratory Co., Ltd., Atsugi-shi (JP)

(72) Inventors: Takuya ISHIMOTO, Isehara (JP); Shotaro MURATSUBAKI, Hachioji (JP); Naoto OKUZAWA, Atsugi (JP); Tatsuyoshi TAKAHASHI, Atsugi (JP); Masayuki KIMURA, Atsugi (JP); Kazutaka KURIKI, Ebina (JP)

(21) Appl. No.: 18/773,889

(22) Filed: Jul. 16, 2024

(30) Foreign Application Priority Data
Jul. 21, 2023 (JP) 2023-119024

(51) Int. Cl. H01M 4/587; H01M 4/02; H01M 4/525; H01M 10/0525; H01M 10/0567; H01M 10/0568; H01M 10/0569

(52) U.S. Cl. CPC H01M 4/587; H01M 4/525; H01M 10/0525; H01M 10/0567; H01M 10/0568; H01M 10/0569; H01M 2004/027; H01M 2004/028; H01M 2300/0034; H01M 2300/0037

(57) ABSTRACT

To provide a battery having excellent charge-discharge characteristics even in a low-temperature environment. The battery includes a positive electrode, a negative electrode, an electrolyte solution, and a separator. The electrolyte solution and the separator are included between the positive electrode and the negative electrode; the negative electrode includes a carbon material; and the electrolyte solution includes a lithium salt, a potassium salt, a fluorinated cyclic carbonate, a fluorinated linear carbonate, and at least one kind of anion. The carbon material includes graphite; the lithium salt includes LiPF₆; the potassium salt includes KFSI; the fluorinated cyclic carbonate includes fluoroethylene carbonate; and the fluorinated linear carbonate includes methyl trifluoropropionate.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device, or a vehicle each including a battery (also referred to as a secondary battery) or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium ion batteries, lithium ion capacitors, and air batteries have been actively developed. In particular, demand for lithium-ion batteries with high output and high capacity has rapidly grown with the development of the semiconductor industry. The lithium-ion batteries are essential as supply sources of rechargeable energy for today's information society.

In particular, batteries for mobile electronic devices, for example, are highly demanded to have high discharge capacity per weight and excellent cycle performance. In order to meet such demands, positive electrode active materials in positive electrodes of batteries have been improved. Crystal structures of positive electrode active materials have also been studied (Non-Patent Documents 1 to 3).

X-ray diffraction (XRD) is one of methods used for analysis of a crystal structure. With the use of the Inorganic Crystal Structure Database (ICSD) introduced in Non-Patent Document 4, XRD data can be analyzed. For example, the ICSD can be referred to for the lattice constant of the lithium cobalt oxide described in Non-Patent Document 5.

General lithium-ion batteries have a problem in charge and discharge at low temperatures. In particular, there is a problem of insufficient charge-discharge characteristics in a low-temperature environment of 0° C. or lower. However, the battery is desired to have stable performance regardless of the environment; thus, in order to obtain sufficient charge-discharge characteristics even in a low-temperature environment of 0° C. or lower, battery materials (e.g., a positive electrode active material, a negative electrode active material, and an electrolyte) used for lithium-ion batteries have been developed (Patent Document 1).

As a method for improving the battery performance of a lithium-ion battery, Patent Document 2 discloses a method in which a sodium ion or a potassium ion is inserted into graphite as a conditioning method for reducing the reaction resistance in a negative electrode active material.

Furthermore, a phenomenon in which potassium ions are inserted into graphite is reported in detail in Non-Patent Document 6 and the like.

In the calculation of graphite, it is important to consider the Van der Waals force. Correction relating to the dispersion force such as the Van der Waals force in computational science is reported in Non-Patent Document 7 and the like.

### REFERENCE

Patent Document 1: PCT International Publication No. WO2023/73480

Patent Document 2: Japanese Published Patent Application No. 2005-302630

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.

[Non-Patent Document 2] T. Motohashi et al., “Electronic phase diagram of the layered cobalt oxide system LiₓCoO₂ (0.0≤x≤1.0)”, Physical Review B, 80 (16); 165114.

[Non-Patent Document 3] Zhaohui Chen et al., “Staging Phase Transitions in LiₓCoO₂”, Journal of The Electrochemical Society, 149 (12), 2002, A1604-A1609.

[Non-Patent Document 4] Belsky, A. et al., “New developments in the Inorganic Crystal Structure Database (ICSD): accessibility in support of materials research and design”, Acta Cryst., (2002), B58, 364-369.

[Non-Patent Document 5] Akimoto, J.; Gotoh, Y.; Oosawa, Y. “Synthesis and structure refinement of LiCoO₂ single crystals”, Journal of Solid State Chemistry (1998) 141, pp. 298-302.

[Non-Patent Document 6] H. Onuma et al., “Phase evolution of electrochemically potassium intercalated graphite” Journal of Materials Chemistry A 9.18 (2021), pp. 11187-11200

[Non-Patent Document 7] S. Grimme “Semiempirical GGA-type density functional constructed with a long-range dispersion correction” Journal of computational chemistry 27.15 (2006), pp. 1787-1799.

### SUMMARY OF THE INVENTION

Patent Document 1 describes that a battery capable of operating even in a low-temperature environment can be obtained with the use of the nonaqueous solvent described in Patent Document 1. However, at the time of the application of the present invention, even the battery described in Patent Document 1 does not have so high a discharge capacity in discharging at a temperature of 0° C. or lower, and further improvement is desired.

For example, Patent Document 1 describes that the use of hard carbon in a low-temperature environment of 0° C. or lower facilitates charge and discharge; however, at 25° C., a reaction potential of hard carbon with lithium ions is higher than a reaction potential of graphite with lithium ions. In other words, a battery using hard carbon as a negative electrode active material of a negative electrode has a lower operating voltage than a battery using graphite as a negative electrode active material of a negative electrode.

Patent Document 2 discloses a method for reducing the reaction resistance in a negative electrode including graphite but does not describe the use of graphite in a low-temperature environment of 0° C. or lower. Furthermore, there is no description on an electrolyte solution or an organic solvent suitable for charge and discharge in a low-temperature environment.

In view of the above, an object of one embodiment of the present invention is to provide a battery using graphite as a negative electrode active material and having excellent battery characteristics even in a low-temperature environment (e.g., 0° C. or lower, preferably −20° C. or lower, further preferably −30° C. or lower, still further preferably −40° C. or lower). Note that the battery characteristics represent charge capacity, discharge capacity, charge-discharge cycle performance, safety, reliability, and the like, and a battery that excels in one or more of these characteristics can be regarded as the battery having excellent battery characteristics.

Another object is to provide a battery with high charge voltage. Another object is to provide a highly safe or highly reliable battery. Another object is to provide a battery with less deterioration. Another object is to provide a long-life battery. Another object is to provide a novel battery.

Another object is to provide a novel substance, a novel active material, or a novel battery or a novel manufacturing method thereof.

Note that the description of these objects does not preclude the presence of other objects. In one embodiment of the present invention, there is no need to achieve all these objects. Other objects can be derived from the description of the specification, the drawings, and the claims.

One embodiment of the present invention is a battery including a positive electrode, a negative electrode, an electrolyte solution, and a separator. The electrolyte solution and the separator are included between the positive electrode and the negative electrode, the negative electrode includes a carbon material, and the electrolyte solution includes a lithium salt, a potassium salt, a fluorinated cyclic carbonate, a fluorinated linear carbonate, and at least one kind of anion.

In the above, the carbon material is preferably graphite, further preferably natural graphite.

In any one of the above batteries, preferably, the lithium salt includes LiPF₆, the potassium salt includes KFSI, the fluorinated cyclic carbonate includes fluoroethylene carbonate, and the fluorinated linear carbonate includes methyl trifluoropropionate.

In the above, preferably, the positive electrode includes lithium cobalt oxide to which magnesium, aluminum, and nickel are added, or the positive electrode includes lithium cobalt oxide to which magnesium, aluminum, nickel, and titanium are added.

One embodiment of the present invention can provide a battery using graphite as a negative electrode active material and having excellent battery characteristics even in a low-temperature environment (e.g., 0° C. or lower, preferably −20° C. or lower, further preferably −30° C. or lower, still further preferably −40° C. or lower).

According to another embodiment of the present invention, a battery with high charge voltage can be provided. A highly safe or highly reliable battery can be provided. A battery with less deterioration can be provided. A long-life battery can be provided. A novel battery can be provided.

According to another embodiment of the present invention, a novel substance, a novel active material, or a novel battery or a novel manufacturing method thereof can be provided.

Note that the description of these effects does not preclude the presence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate examples of cross-sectional views of an electrode;

FIGS. 2A and 2B illustrate a calculation model;

FIGS. 3A and 3B illustrate a calculation model;

FIGS. 4A and 4B illustrate a calculation model;

FIGS. 5A and 5B are graphs showing calculation results;

FIGS. 6A and 6B are graphs showing calculation results;

FIG. 7 is an external view of a secondary battery;

FIGS. 8A to 8C illustrate a manufacturing method of a secondary battery;

FIG. 9A is a cross-sectional view of a positive electrode active material, and FIG. 9B is a diagram illustrating distribution of an additive element in the positive electrode active material;

FIG. 10 shows results of DSC analysis;

FIG. 11 shows an example of a TEM image showing crystal orientations substantially aligned with each other;

FIG. 12A shows an example of an STEM image showing crystal orientations substantially aligned with each other, FIG. 12B shows an FFT pattern of a region of a rock-salt crystal RS, and FIG. 12C shows an FFT pattern of a region of a layered rock-salt crystal LRS;

FIG. 13 illustrates crystal structures of a positive electrode active material;

FIG. 14 illustrates crystal structures of a conventional positive electrode active material;

FIG. 15 shows XRD patterns calculated from crystal structures;

FIG. 16 shows XRD patterns calculated from crystal structures;

FIGS. 17A and 17B show XRD patterns calculated from crystal structures.

FIG. 18 is a cross-sectional view of a positive electrode active material;

FIG. 19 illustrates a manufacturing method of a positive electrode active material;

FIGS. 20A to 20C illustrate a manufacturing method of a positive electrode active material;

FIGS. 21A and 21B illustrate a manufacturing method of a positive electrode active material;

FIGS. 22A to 22H illustrate examples of electronic devices;

FIGS. 23A to 23D illustrate examples of electronic devices;

FIGS. 24A to 24C illustrate examples of electronic devices;

FIGS. 25A to 25C illustrate examples of vehicles;

FIGS. 26A to 26D illustrate examples of space equipment;

FIGS. 27A and 27B are graphs showing results of Example; and

FIGS. 28A and 28B are graphs showing results of Example.

### DETAILED DESCRIPTION OF THE INVENTION

Hereinafter, embodiments of the present invention will be described in detail with reference to the drawings. However, the present invention is not limited to the description given below, and it is easily understood by those skilled in the art that modes and details disclosed herein can be modified in various ways. In addition, the present invention should not be construed as being limited to the description in the following embodiments.

Note that in structures of the invention described below, the same portions or portions having similar functions are denoted by the same reference numerals in different drawings, and the description thereof is not repeated. The same hatching pattern is used for portions having similar functions, and the portions are not denoted by specific reference numerals in some cases.

For easy understanding, the position, size, range, and the like of each component illustrated in drawings do not represent the actual position, size, range, and the like in some cases. Therefore, the disclosed invention is not necessarily limited to the position, size, range, or the like disclosed in the drawings.

Note that ordinal numbers such as “first” and “second” in this specification and the like are used for convenience and do not limit the number or the order (e.g., the order of steps or the stacking order) of components. The ordinal number added to a component in a part of this specification may be different from the ordinal number added to the component in another part of this specification or the scope of claims.

### Embodiment 1

### [Battery]

A battery of one embodiment of the present invention includes a positive electrode, a negative electrode, an electrolyte, and a separator. The battery of one embodiment of the present invention may include an exterior body covering at least part of peripheries of the positive electrode, the negative electrode, and the electrolyte.

The description of this embodiment will focus on the structure of a battery that is needed to achieve excellent battery characteristics even in a low-temperature environment (e.g., 0° C. or lower, preferably −20° C. or lower, further preferably −30° C. or lower, still further preferably −40° C. or lower). Specifically, a negative electrode active material that is included in a negative electrode and an electrolyte are mainly described.

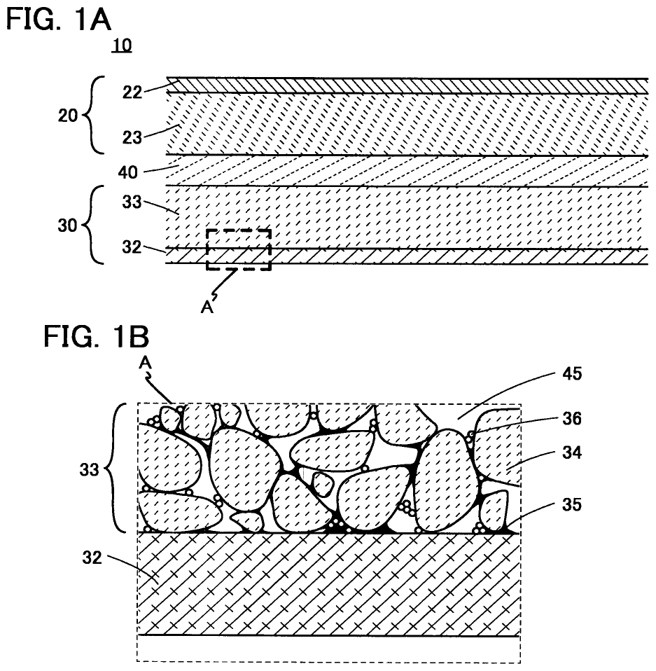

FIG. 1A is a schematic cross-sectional view illustrating an inner structure of a battery 10 according to one embodiment of the present invention. FIG. 1B is an enlarged view of a region A surrounded by dashed lines in FIG. 1A.

In the schematic cross-sectional view illustrated in FIG. 1A, a positive electrode 20 includes a positive electrode current collector 22 and a positive electrode active material layer 23. A negative electrode 30 includes a negative electrode current collector 32 and a negative electrode active material layer 33. The positive electrode 20 and the negative electrode 30 overlap with each other such that the positive electrode active material layer 23 faces the negative electrode active material layer 33 with the separator 40 therebetween. The battery includes an electrolyte in each of spaces in the positive electrode active material layer 23, the negative electrode active material layer 33, and the separator 40.

### [Negative Electrode 1]

The negative electrode 30 is described with reference to FIG. 1B. The negative electrode active material layer 33 is provided over the negative electrode current collector 32. The negative electrode active material layer 33 includes a negative electrode active material 34 and a binder 35. In addition, an electrolyte 45 is included in spaces in the negative electrode active material layer 33. Note that the negative electrode active material layer 33 may further include a conductive material 36.

For example, metal foil can be used for the negative electrode current collector 32. The negative electrode active material layer 33 can be formed by applying slurry onto the negative electrode current collector 32 and drying the slurry. Note that the negative electrode active material layer 33 after drying may be pressed.

Slurry refers to a dispersion solution that is used to form an active material layer over the current collector and contains an active material, a binder, and a solvent, preferably also a conductive material mixed therewith. A thickener may be added together with the binder. Slurry may also be referred to as electrode slurry or active material slurry; in some cases, slurry for forming a negative electrode active material layer is referred to as negative electrode slurry.

### <Negative Electrode Active Material>

A carbon material is preferably used as the negative electrode active material 34. Graphite can be used as the carbon material, for example.

Examples of graphite include artificial graphite and natural graphite. Examples of artificial graphite include mesocarbon microbeads (MCMB), coke-based artificial graphite, and pitch-based artificial graphite. As artificial graphite, spherical artificial graphite having a spherical shape can be used. Examples of natural graphite include flake graphite and spherical natural graphite.

Graphite has a low potential substantially equal to that of lithium metal (higher than or equal to 0.05 V and lower than or equal to 0.5 V vs. Li/Li⁺) when lithium ions are inserted between crystal layers in the graphite (when a lithium-graphite intercalation compound is generated). For this reason, a lithium-ion battery using graphite can have a high operating voltage. In addition, graphite is preferable because of its advantages such as a relatively high capacity per unit volume, relatively small volume expansion, low cost, and a higher level of safety than that of lithium metal. Graphite is preferable because graphite can have a higher operating voltage when incorporated as a negative electrode of a lithium ion battery, compared with non-graphitizing carbon.

Note that one or more of graphitizing carbon (soft carbon), non-graphitizing carbon (hard carbon), carbon fiber (carbon nanotube, carbon nanofiber), graphene, carbon black, silicon (Si), tin (Sn), gallium (Ga), silicon monoxide (SiO), and lithium titanium oxide (Li₄Ti₅O₁₂) may be included as the negative electrode active material included in the negative electrode active material layer, in addition to graphite.

The negative electrode current collector 32, the binder 35, and the conductive material 36 included in the negative electrode 30 will be described later in the section [Negative electrode 2].

### [Electrolyte]

The following describes examples of an electrolyte used for the battery of one embodiment of the present invention, having favorable charge characteristics and/or favorable discharge characteristics in a low-temperature environment.

Note that an electrolyte described below is a liquid electrolyte in which a metal salt (e.g., a lithium salt) is dissolved in an organic solvent and is also referred to as an electrolyte solution or an organic electrolyte solution. The electrolyte solution used for the battery of one embodiment of the present invention contains a lithium salt and a metal M salt as metal salts. The molar concentration of the lithium salt contained in the electrolyte solution is preferably higher than the molar concentration of the metal M salt contained in the electrolyte solution. A battery including a large number of lithium ions as metal cations included in the electrolyte solution can be referred to as a lithium-ion battery. In the case where the electrolyte solution used in the battery of one embodiment of the present invention includes two kinds of metal cations, the battery can be referred to as a dual-cation battery or a dual-ion battery.

### <Lithium Salt>

For example, as a lithium salt, at least one of lithium salts such as LiPF₆, LiClO₄, LiAsF₆, LiBF₄, LiAlCl₄, LiSCN, LiBr, LiI, Li₂SO₄, Li₂B₁₀C₁₁₀, Li₂B₁₂Cl₁₂, LiCF₃SO₃, LiC₄F₉SO₃, LiC(CF₃SO₂)₃, LiC(C₂F₅SO₂)₃, LiN(FSO₂)₂, LiN(CF₃SO₂)₂, LiN(C₄F₉SO₂) (CF₃SO₂). LiN(C₂F₅SO₂)₂, and lithium bis(oxalate) borate (LiBOB) can be used, or two or more of these lithium salts can be used in an appropriate combination in an appropriate ratio.

### <Metal M Salt>

The metal M salt contains a metal M as a cation. An element that can be used as the metal M is described below.

Here, the element that can be used as the metal M can be regarded as an element that can enter between crystal layers in graphite and can extend the distance between crystal layers in graphite, as compared with the case where Li enters. A scientific calculation of an element that can be used as the metal M is described below.

### <<Calculation 1>>

The first-principles molecular dynamics calculation is performed using a model assuming a graphite bulk, so that graphite intercalation compound (GIC) formation energy of each intercalant and the expansion between crystal layers in graphite are calculated. Note that the intercalant refers to an element inserted (or intercalated) between crystal layers in graphite.

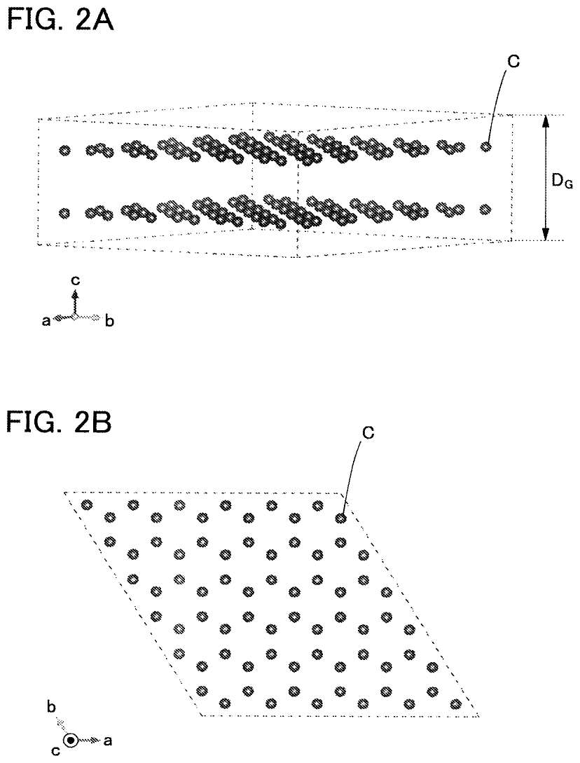

Calculation of insertion of one intercalant between crystal layers in graphite is performed. The calculation is performed on each of the following elements: lithium (Li), sodium (Na), potassium (K), rubidium (Rb), cesium (Cs), magnesium (Mg), calcium (Ca), strontium (Sr), barium (Ba), aluminum (Al), scandium (Sc), yttrium (Y), and lanthanum (La, La is used as a representative of lanthanoid). For other specific calculation conditions of the quantum molecular dynamics, the conditions shown in Table 1 are used. FIGS. 2A and 2B, FIGS. 3A and 3B, and FIGS. 4A and 4B show models used for the calculation.

TABLE 1

| Software | VASP |
|---|---|
| Functional | GGA (DFT-D2) |
| Pseudopotential | PAW |
| Cutoff energy (eV) | 600 |
| K-POINTS | 1 × 1 × 1 |

Conditions relating to the Van der Waals force interaction in the density functional theory (DFT-D2) calculation are shown below.
IVDW: 1
VDW RADIUS: 30
VDW_S6: 0.75
VDW D: 20
VDW_C₆: values given in Table 1 of Non-Patent Document 7 of the elements are used (but values of Cs, Ba, and La are set to 38.54)
VDW_R₀: values given in Table 1 of Non-Patent Document 7 of the elements are used (but values of Cs, Ba, and La are set to 1.771, 1.738, and 1.716, respectively).

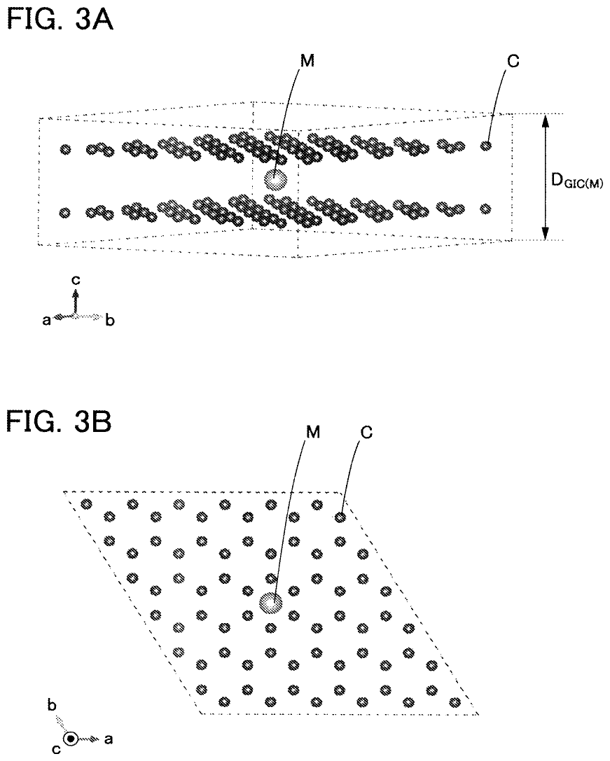

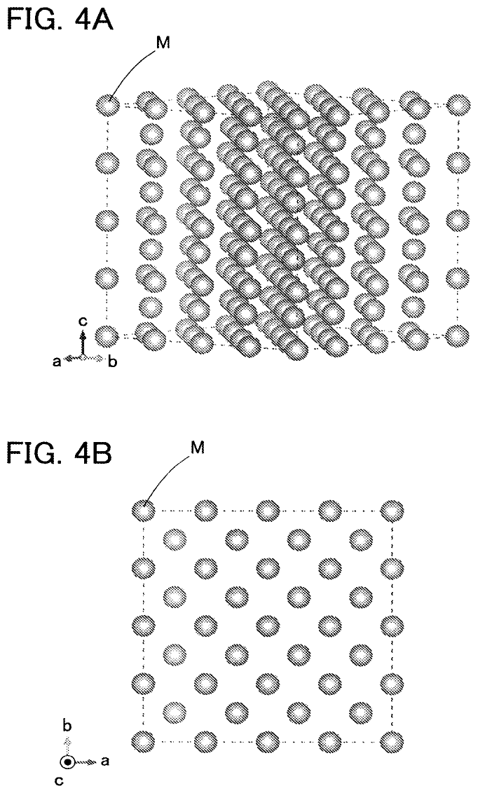

FIGS. 2A and 2B are a calculation model of graphite in which no intercalant is inserted between crystal layers, FIGS. 3A and 3B are a calculation model of graphite in which an intercalant is inserted between crystal layers, and FIGS. 4A and 4B are a calculation model of the case where the intercalant serves as a bulk metal. In each of the schematic views, a parallel hexahedron shown by a dashed line represents a lattice that is a repeating unit of a calculation model.

The calculation model in FIGS. 2A and 2B show 144 carbon atoms (C), and have a structure in which two layers each having 72 carbon atoms overlap with each other. In the calculation model in FIGS. 3A and 3B, one intercalant atom (metal M) is inserted between layers in the calculation model in FIGS. 2A and 2B. The calculation model in FIGS. 4A and 4B show 128 atoms (metal) used as intercalants in the calculation model in FIGS. 3A and 3B.

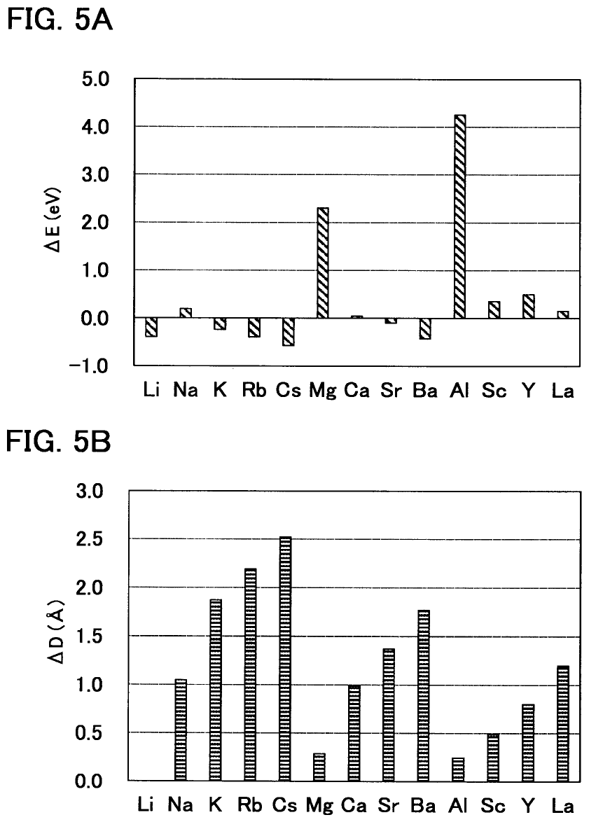

FIGS. 5A and 5B, Table 2, and Table 3 show the results of the calculation under the above conditions. FIG. 5A and Table 2 show the energy change amount ΔE due to the insertion of an intercalant between the crystal layers in graphite. FIG. 5B and Table 3 show the change amount ΔD in the c-axis length of the lattice due to the insertion of an intercalant between the crystal layers in graphite.

TABLE 2

| | Additive element | | | | | | |
|---|---|---|---|---|---|---|---|
| | Li | Na | K | Rb | Cs | Mg | Ca |
| ΔE (eV) | −0.391 | 0.190 | −0.232 | −0.393 | −0.571 | 2.300 | 0.043 |

| | Additive element | | | | | |
|---|---|---|---|---|---|---|
| | Sr | Ba | Al | Sc | Y | La |
| ΔE (eV) | −0.098 | −0.422 | 4.257 | 0.357 | 0.500 | 0.152 |

Calculation methods of ΔE shown in FIG. 5A and Table 2 are described. In the case where E_{g} is energy obtained by performing structural relaxation calculation on the calculation model shown in FIGS. 2A and 2B, E_{GIC(M)} is energy obtained by performing atomic relaxation calculation on the calculation model shown in FIGS. 3A and 3B, and E_{METAL(M)} is a value obtained by dividing 128 (the number of atoms) into an energy value obtained by performing atomic relaxation calculation on the calculation model shown in FIGS. 4A and 4B, ΔE is calculated by the calculation formula ΔE=E_{GIC(M)}−(E_{g}+E_{METAL(M)}. For example, in the case where the intercalant is lithium (Li), ΔE=E_{GIC (Li)}−(E_{g}+E_{METAL (Li)}).

An intercalant having ΔE of a negative value is likely to be inserted between crystal layers in graphite. As shown in the calculation results in FIG. 5A and Table 2, lithium, potassium, rubidium, cesium, strontium, and barium can be given as the elements that are likely to be inserted between crystal layers in graphite.

TABLE 3

| | Additive element | | | | | | |
|---|---|---|---|---|---|---|---|
| | Li | Na | K | Rb | Cs | Mg | Ca |
| ΔD (Å) | 0.00 | 1.05 | 1.87 | 2.19 | 2.52 | 0.29 | 0.99 |

Additive element

| | Sr | Ba | Al | Sc | Y | La |
|---|---|---|---|---|---|---|
| ΔD (Å) | 1.37 | 1.77 | 0.25 | 0.49 | 0.80 | 1.20 |

A method for calculating ΔD shown in FIG. 5B and Table 3 is described. When the c-axis length of the lattice after the atomic relaxation calculation is performed on the calculation model shown in FIGS. 2A and 2B is D_{g} and the c-axis length of the lattice after the atomic relaxation calculation is performed on the calculation model shown in FIGS. 3A and 3B is D_{GIC (M)}, ΔD is calculated by the calculation formula ΔD=D_{GIC (M)}−D_{g}. For example, in the case where the intercalant is lithium (Li), ΔD=D_{GIC (Li)}−D_{g} is satisfied. Note that 1 Å (angstrom) is 10⁻¹⁰ m.

The metal M is preferably an element that enables the interlayer distance D_{GIC (M)} in the case where the metal M is inserted between crystal layers in graphite to be longer than the interlayer distance D_{GIC (Li)} in the case where lithium is inserted between crystal layers in graphite. The region where the interlayer distance D_{GIC (M)} is longer than the interlayer distance D_{GIC (Li)} (the region where the metal M is inserted) is included in graphite, whereby the reaction resistance in lithium insertion between crystal layers in graphite in the region where the metal M is inserted can be expected to be reduced.

Thus, when the region where the interlayer distance D_{GIC (M)} is longer than the interlayer distance D_{GIC (Li)} is included in graphite, it is inferred that lithium can be inserted between crystal layers in graphite in the region where the metal M is inserted even in a low-temperature environment. That is, the charge-discharge characteristics of the battery can be improved in a low-temperature environment.

As shown in the calculation results in FIG. 5B and Table 3, it is expected that all the elements calculated this time can extend the distance between crystal layers in graphite as compared with the case where lithium is inserted.

### <<Calculation 2>>

Next, Calculation 2 whose calculation conditions are partly changed from those of Calculation 1 is performed.

As in Calculation 1, the calculation models described with reference to FIGS. 2A and 2B, FIGS. 3A and 3B, are FIGS. 4A and 4B are used.

Specific conditions of the first-principles molecular dynamics calculations are shown in Table 4.

TABLE 4

| Software | VASP |
|---|---|
| Functional | GGA (DFT-D3BJ) |
| Pseudopotential | PAW |
| Cutoff energy (eV) | 600 |
| K-POINTS | 1 × 1 × 1 |

As conditions relating to the Van der Waals force interaction in the density functional theory (DFT-D3BJ) calculation, IVDW is set to 12.

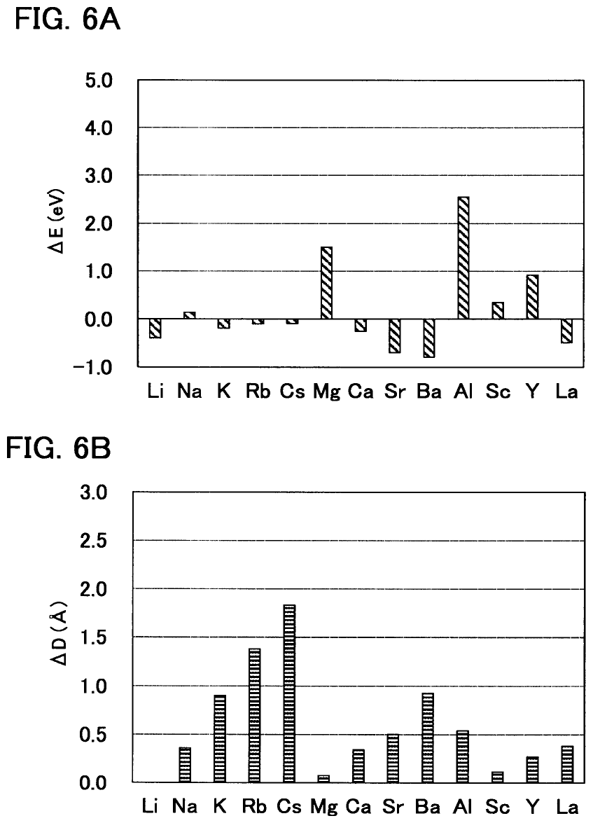

FIGS. 6A and 6B, Table 5, and Table 6 show the calculation results under the same conditions as those in Calculation 1, except for the above condition of the density functional theory. FIG. 6A and Table 5 show the change amount ΔE in energy due to insertion of an intercalant between crystal layers in graphite. FIG. 6B and Table 6 show the change amount ΔD in the c-axis length of the lattice due to insertion of the intercalant between crystal layers in graphite.

TABLE 5

| | Additive element | | | | | | |
|---|---|---|---|---|---|---|---|
| | Li | Na | K | Rb | Cs | Mg | Ca |
| ΔE (eV) | −0.394 | 0.141 | −0.187 | −0.096 | −0.090 | 1.500 | −0.248 |

| | Additive element | | | | | |
|---|---|---|---|---|---|---|
| | Sr | Ba | Al | Sc | Y | La |
| ΔE (eV) | −0.697 | −0.791 | 2.548 | 0.350 | 0.922 | −0.484 |

An element having ΔE of a negative value is likely to enter between crystal layers in graphite. As shown in the calculation results in FIG. 6A and Table 5, lithium, potassium, rubidium, cesium, calcium, strontium, barium, and lanthanum can be given as the elements that are likely to enter between crystal layers in graphite. Note that according to the result of Calculation 2, lanthanum is likely to enter between crystal layers in graphite; thus, lanthanoids other than lanthanum are inferred to be elements that are likely to enter between crystal layers in graphite.

TABLE 6

| | Additive element | | | | | | |
|---|---|---|---|---|---|---|---|
| | Li | Na | K | Rb | Cs | Mg | Ca |
| ΔD (Å) | 0.00 | 0.36 | 0.90 | 1.38 | 1.83 | 0.08 | 0.35 |

Additive element

| | Sr | Ba | Al | Sc | Y | La |
|---|---|---|---|---|---|---|
| ΔD (Å) | 0.50 | 0.93 | 0.54 | 0.12 | 0.28 | 0.39 |

As shown in the calculation results in FIG. 6B and Table 6, it is inferred that all the elements calculated this time can extend the distance between crystal layers in graphite as compared with the case where lithium is inserted.

Calculation 1 and Calculation 2 are different in correction conditions regarding the Van der Waals force. Under the calculation condition of Calculation 1, a calculation value (0.523 to 0.530 nm) close to the actual measurement value (0.535 nm) of the interlayer distance of KC₈ is obtained, and under the calculation condition of Calculation 2, a calculation value (0.359 nm to 0.360 nm) close to the actual measurement value (0.372 nm) of the interlayer distance of LiC₆ is obtained. In the calculation of a layered material such as graphite, calculation results are sometimes different depending on correction conditions of the Van der Waals force; thus, calculations are performed under a plurality of correction conditions.

The elements that can be used as the metal M are examined on the basis of the results of Calculation 1 and Calculation 2. In at least one of Calculation 1 and Calculation 2, an element having a negative value in the change amount in energy in the case of insertion of the element between crystal layers in graphite can be used as the metal M. That is, the metal M can be one or more of potassium, rubidium, cesium, calcium, strontium, barium, and lanthanum (or lanthanoid). In particular, one or both of potassium and barium each having a high level of safety are preferably used as the metal M.

As the anion of the metal M salt, at least one of bis(fluorosulfonyl)imide (FSI⁻) anion, bis(trifluoromethanesulfonyl)imide (TFSI⁻) anion, PF₆⁻ anion, ClO₄⁻ anion, BF₄⁻ anion, and SCN⁻ anion can be used, for example.

In the case where potassium is used as the metal M, at least one of the following potassium salts can be used: potassium bis(fluorosulfonyl)imide (KFSI), potassium bis(trifluoromethanesulfonyl)imide (KTFSI), KPF₆, KClO₄, KBF₄, and KSCN. KFSI is preferably used as an electrolyte solution for excellent battery characteristics in a low-temperature environment. The reason why KFSI is preferred will be described later.

### <Organic Solvent>

As an organic solvent, for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. Alternatively, any of the following organic solvents exemplified below as an organic solvent suitable for a low-temperature environment can be used.

### <<Organic Solvent 1 Suitable for Low-Temperature Environment>>

An example of the organic solvent suitable for a low-temperature environment is an organic solvent that includes EC, EMC, and DMC at the volume ratio of x:y:100−x−y (5≤x≤35 and 0<y<65) where the total amount of EC, EMC, and DMC is 100 vol %. More specifically, an organic solvent containing EC, EMC, and DMC at the volume ratio of 30:35:35 can be used. Note that the volume ratio may be the volume ratio of the electrolyte solution before mixing, and the electrolyte solution may be mixed at room temperature (typically 25° C.).

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use EC alone as the organic solvent in a low-temperature environment. Then, the organic solvent specifically described in one embodiment of the present invention includes not only EC but also EMC and DMC. EMC is a linear carbonate and has an effect of decreasing the viscosity of the electrolyte solution, and the freezing point is −54° C. In addition, DMC is also a linear carbonate and has an effect of decreasing the viscosity of the electrolyte solution, the freezing point is −43° C. An electrolyte solution formed using a mixed organic solvent that includes EC, EMC, and DMC having such physical properties at the volume ratio of x:y:100−x−y (5≤x≤35 and 0<y<65) where the total amount of the three organic solvents is 100 vol % has a feature of the freezing point of −40° C. or lower.

A general electrolyte solution used for a lithium ion battery can be solidified even at approximately −20° C.; thus, it is difficult to fabricate a battery that can be charged and discharged at −40° C. Since the electrolyte solution described as an example in this embodiment has a freezing point of −40° C. or lower, a lithium ion battery can be charged and discharged even in a low-temperature environment of −40° C.

### <<Organic Solvent 2 Suitable for Low-Temperature Environment>>

In another example of the organic solvent suitable for a low-temperature environment, a fluorinated cyclic carbonate or a fluorinated linear carbonate is preferably included. The above organic solvent preferably contains both a fluorinated cyclic carbonate and a fluorinated linear carbonate. A fluorinated cyclic carbonate and a fluorinated linear carbonate are preferable because they each include an electron-withdrawing group and thereby has a lower solvation energy of a lithium ion than those of organic compounds not having an electron-withdrawing group. Accordingly, a fluorinated cyclic carbonate and a fluorinated linear carbonate are suitable for the organic solvent.

As the fluorinated cyclic carbonate, fluoroethylene carbonate (fluoride ethylene carbonate, FEC, or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes an electron-withdrawing group and is thus presumed to have a lower solvation energy of a lithium ion than that of EC.

Structural Formula (H10) below represents FEC. The electron-withdrawing group in FEC is an F group.

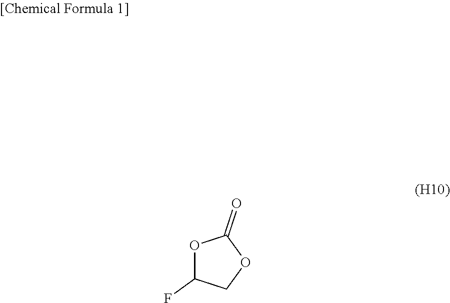

An example of the fluorinated linear carbonate is methyl 3,3,3-trifluoropropionate. Structural Formula (H22) below represents methyl 3,3,3-trifluoropropionate. An abbreviation of methyl 3,3,3-trifluoropropionate is MTFP. The electron-withdrawing group in MTFP is a CF₃ group.

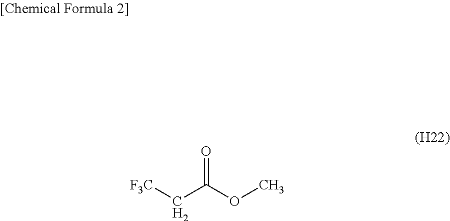

An example of the fluorinated linear carbonate is trifluoromethyl 3,3,3-trifluoropropionate. Structural Formula (H23) shown below represents trifluoromethyl 3,3,3-trifluoropropionate. The electron-withdrawing group is a CF₃ group.

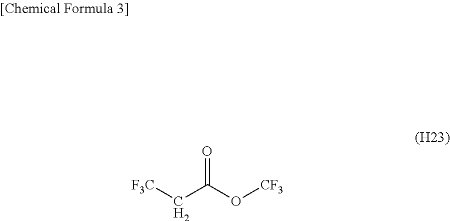 [SMILES: O=C(CC(F)(F)F)OC(F)(F)F]

An example of the fluorinated linear carbonate is trifluoromethyl propionate. Structural Formula (H24) shown below is a structural formula of trifluoromethyl propionate. The electron-withdrawing group is a CF₃ group.

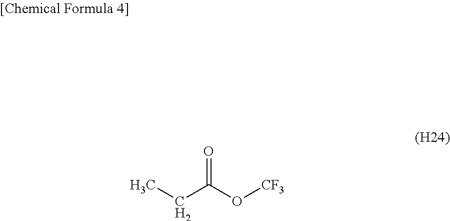

An example of the fluorinated linear carbonate is methyl 2,2-difluoropropionate. Structural Formula (H25) shown below represents methyl 2,2-difluoropropionate. The electron-withdrawing group is a CF₂ group.

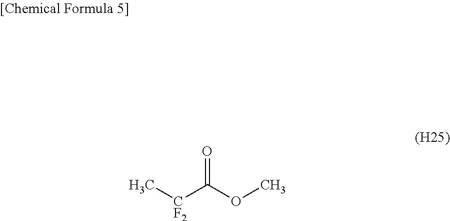

The organic solvent contained in the electrolyte solution of one embodiment of the present invention preferably includes one or more of the above-described fluorinated cyclic carbonates and one or more of the above-described fluorinated linear carbonates. For example, the organic solvent described in this embodiment preferably includes FEC and MTFP. The reason for the above is as follows.

### <<FEC and MTFP>>

FEC is one of cyclic carbonates and has a high dielectric constant and thus has an effect of promoting dissociation of a lithium salt when used in an organic solvent. Meanwhile, because FEC includes an electron-withdrawing group, a lithium ion is desolvated with FEC more easily than with ethylene carbonate (EC). Specifically, the solvation energy of a lithium ion is lower in FEC than in EC, which does not include an electron-withdrawing group. Thus, lithium ions are likely to be released from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. However, FEC disadvantageously has high viscosity. In view of this, a mixed organic solvent containing not only FEC but also MTFP is preferably used for the electrolyte solution. MTFP is one of linear carbonates and can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include an electron-withdrawing group, MTFP may solvate a lithium ion when used for the electrolyte solution.

Preferably, the above-described organic solvent is highly purified and contains a small amount of dust particles or molecules other than the constituent molecules of the organic solvent (hereinafter, also simply referred to as “impurities” including oxygen (O₂), water (H₂O), or moisture). It is preferable that generation of a reaction by-product in synthesis be inhibited through appropriate purification. Specifically, the impurity concentration of the electrolyte is less than or equal to 100 ppm, preferably less than or equal to 50 ppm, further preferably less than 10 ppm. The moisture concentration in the impurities can be detected by Karl Fischer titration.

It is preferable that peaks attributed to impurities in the above-described organic solvent be hardly observed by NMR measurement or the like. The expression “hardly observed” includes a case where the ratio of the integral area of the peak attributed to impurities to the integral area of the peak attributed to the main component is 0.005 or less, preferably 0.002 or less (the ratio of the integral area is simply referred to as an integral ratio). An apparatus used for the NMR measurement is not particularly limited, and for example, Bruker AVANCE III 400 can be used. In addition, the center peak of the five peaks of acetonitrile derived from acetonitrile-d3 used as a solvent in ¹H-NMR measurement is 1.94 ppm.

For example, in the case of MTFP, it is known that when ¹H-NMR measurement is performed using an acetonitrile-d3 solvent, four peaks are generated in the range where δ is 3.29 ppm to 3.43 ppm, inclusive. However, when another peak appears in the vicinity of the peaks, for example, in the range where δ is 3.24 ppm to 3.29 ppm, inclusive, the peak is probably derived from impurities. Thus, it can be said that a peak attributed to impurities can be hardly observed when the ratio of the peak area (an integral ratio) in the range of 3.24 ppm to 3.29 ppm, inclusive, to the peak area in the range of 3.29 ppm to 3.43 ppm, inclusive, is 0.005 or less, preferably 0.002 or less.

FEC and MTFP having the above-described physical properties may be mixed at the volume ratio of x:100−x (5≤x≤30, preferably 10≤x≤20) where the total content of the two organic solvents is 100 vol %. In other words, MTFP and FEC are preferably mixed such that the content of MTFP is larger than that of FEC in the mixed organic solvent. Note that the volume ratio may be the volume ratio of the organic solvents measured before mixing the organic solvents, and the organic solvents may be mixed at room temperature (typically 25° C.). The mixed organic solvent including FEC and MTFP is a preferred organic solvent that can exhibit a viscosity workable for a lithium-ion battery and can maintain appropriate viscosity even in a low-temperature environment.

Any of the organic compounds given as the fluorinated cyclic carbonate, including FEC described above as a typical example, has an effect of promoting dissociation of a lithium salt, have low solvation energy to be easily solvated to lithium ions, and are difficult to use alone in a low-temperature environment due to their low viscosity. In addition, any of the organic compounds given as the fluorinated linear carbonates, including MTFP described as a typical example, have an effect of lowering or maintaining the viscosity of the electrolyte solution of one embodiment of the present invention. Thus, as long as the organic solvent of one embodiment of the present invention contains a fluorinated cyclic carbonate and a fluorinated linear carbonate, a lithium-ion battery where lithium ions can be favorably inserted to and extracted from a negative electrode active material and that can perform charge and discharge in a wide temperature range including a low-temperature environment can be provided.

Thus, the electrolyte solution included in the battery of one embodiment of the present invention preferably includes a lithium salt, a metal M salt, and the “organic solvent 1 suitable for low-temperature environment” or the “organic solvent 2 suitable for low-temperature environment” described above.

As a specific example of the electrolyte solution used for the battery of one embodiment of the present invention, a structure example of the electrolyte solution in which LiPF₆ is used as a lithium salt, a potassium salt is used as a metal M salt, and the “organic solvent 2 suitable for low-temperature environment” is used as an organic solvent is described.

When a potassium salt is used as the metal M salt and a potassium ion is inserted between crystal layers in graphite, the distance between the crystal layers in graphite can be extended as compared with the case where a lithium ion is inserted. This makes it easier for lithium to enter between the crystal layers in graphite; thus, a battery in which the potassium ion is present between crystal layers in graphite has improved charge-discharge characteristics involving insertion and extraction of lithium ions in a low-temperature environment.

Preferably, the battery of one embodiment of the present invention contains a lithium salt and a metal M salt (here, a potassium salt) in an electrolyte solution and uses an organic solvent suitable for a low-temperature environment. It is particularly preferable to use a mixed solvent containing a fluorinated cyclic carbonate and a fluorinated linear carbonate, which is described as the “organic solvent 2 suitable for low-temperature environment”.

The following describes a structure in which a lithium salt and a metal M salt (here, a potassium salt) are contained in an electrolyte solution and the above-described organic solvent suitable for a low-temperature environment is used.

FEC is used as the fluorinated cyclic carbonate, MTFP is used as the fluorinated linear carbonate, and FEC and MTFP are mixed to form a mixed solvent. LiPF₆ is dissolved at 1 mol/L in the mixed solvent to form an electrolyte solution. In the case where potassium hexafluorophosphate (KPF₆) is further dissolved as the potassium salt, the potassium salt is difficult to dissolve in the electrolyte solution and the amount of potassium salt that can be added to the electrolyte solution is extremely small, and thus an insoluble residue of KPF₆ that is to be dissolved at even 0.05 mol/L is present in the electrolyte solution.

Thus, a preferred potassium salt used in the electrolyte solution of the battery of one embodiment of the present invention is not KPF₆. As a potassium salt used in the electrolyte solution of the battery of one embodiment of the present invention, for example, bis(fluorosulfonyl) imide potassium (KFSI) can be used. This potassium salt is preferable because the potassium salt can be dissolved even in the electrolyte solution in which the lithium salt is dissolved in the mixed solvent described as the “organic solvent 2 suitable for low-temperature environment”. Although the details are described in Example, in the case where KFSI is used as a potassium salt, KFSI can be dissolved at 0.2 mol/L in an electrolyte solution in which LiPF₆ is dissolved at 1 mol/L in a mixed solvent containing FEC and MTFP at the volume ratio of 2:8. Note that the above value of 0.2 mol/L does not represent the upper limit of dissolution of KFSI.

### [Negative Electrode 2]

Here, items relating to the negative electrode, which are not mentioned in “negative electrode 1”, are described.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, a cellulose derivative such as carboxymethyl cellulose (CMC) like carboxymethyl cellulose-sodium (CMC-Na), methyl cellulose, ethyl cellulose, hydroxypropyl cellulose, diacetyl cellulose, or regenerated cellulose, starch, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of the water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer can stabilize the viscosity by being dissolved in water and can allow stable dispersion of the active material and another material combined as the binder, e.g., styrene-butadiene rubber, in an aqueous solution. Furthermore, a water-soluble polymer is expected to be easily and stably adsorbed on an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of the electrolyte solution at a potential at which a battery reaction occurs when the passivation film is formed on the active material surface, for example. Further preferably, the passivation film can conduct lithium ions while suppressing electrical conduction.

### <Conductive Material>

A conductive material is also referred to as a conductivity-imparting agent or a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following: a case where covalent bonding occurs, a case where bonding with the Van der Waals force occurs, a case where a conductive material covers part of the surface of an active material, a case where a conductive material is embedded in surface roughness of an active material, and a case where an active material and a conductive material are electrically connected to each other without being in contact with each other.

An active material layer such as a positive electrode active material layer or a negative electrode active material layer preferably includes a conductive material.

As the conductive material, for example, one or more of carbon black such as acetylene black or furnace black, graphite such as artificial graphite or natural graphite, carbon fibers such as a carbon nanofiber and a carbon nanotube, and a graphene compound can be used.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method. The active material layer may include, as a conductive material, metal powder or metal fiber of copper, nickel, aluminum, silver, gold, or the like, a conductive ceramic material, or the like.

The content of the conductive material to the total amount of the active material layer is preferably greater than or equal to 0.1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer, resulting in increased discharge capacity of the secondary battery.

A compound containing particulate carbon such as carbon black or graphite or a compound containing fibrous carbon such as a carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The secondary battery obtained by the fabrication method of one embodiment of the present invention can have high capacitive density and stability, and is effective as an in-vehicle secondary battery.

### <Current Collector>

For a current collector, it is possible to use a material which has high conductivity and does not alloy with carrier ions of lithium or the like, e.g., a metal such as stainless steel, gold, platinum, zinc, iron, copper, aluminum, or titanium, an alloy thereof, or the like. The current collector can have a sheet-like shape, a net-like shape, a punching-metal shape, an expanded-metal shape, or the like as appropriate. The current collectors each preferably have a thickness greater than or equal to 10 μm and less than or equal to 30 μm.

Note that a material that does not alloy with carrier ions of lithium or the like is preferably used for the negative electrode current collector.

### [Positive Electrode]

A positive electrode includes a positive electrode active material layer and a positive electrode current collector. The positive electrode active material layer includes a positive electrode active material and may further include at least one of a conductive material and a binder. Note that the positive electrode current collector, the conductive material, and the binder described in the section [Negative electrode 2] can be used.

For the current collector, metal foil such as aluminum foil can be used, for example. The positive electrode can be formed by applying slurry onto metal foil and drying the slurry. Note that pressing may be performed after drying. The positive electrode is obtained by forming an active material layer over the current collector.

Slurry refers to a material solution that is used to form an active material layer over the current collector and contains an active material, a binder, and a solvent, preferably also contains a conductive material mixed therein. The slurry may also be referred to as electrode slurry or active material slurry; in some cases, slurry for forming a positive electrode active material layer is referred to as positive electrode slurry.

### <Positive Electrode Active Material>

Next, the positive electrode active material of one embodiment of the present invention is described. As the positive electrode active material, lithium cobalt oxide and/or lithium nickel-cobalt-manganese oxide can be used.

As the lithium cobalt oxide, for example, it is preferable to use lithium cobalt oxide to which magnesium is added. It is preferable to use lithium cobalt oxide to which magnesium, aluminum, nickel, and titanium are added. It is preferable to use lithium cobalt oxide to which magnesium, aluminum, and nickel are added. As for the lithium cobalt oxide that can be used for the battery 10 of one embodiment of the present invention, a positive electrode active material 100 will be described in detail in Embodiment 2 and Embodiment 3.

As the lithium nickel-cobalt-manganese oxide, for example, lithium nickel-cobalt-manganese oxide with an atomic ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the positive electrode active material that can be used in a low-temperature environment, a lithium cobalt oxide described in Embodiment 2 or Embodiment 3 is preferably used. The lithium cobalt oxide described in Embodiment 2 or Embodiment 3 is a positive electrode active material that can be used at even a high level of charge voltage (also referred to as a high charge voltage) and that enables insertion and extraction of lithium ions at low temperatures.

Note that in this specification and the like, unless otherwise specified, “charge voltage” is shown with reference to the potential of a lithium metal. In this specification and the like, the “high charge voltage” is charge voltage, for example, higher than or equal to 4.6 V, preferably higher than or equal to 4.65 V, further preferably higher than or equal to 4.7 V, still further preferably higher than or equal to 4.75 V, or most preferably higher than or equal to 4.8 V. Note that for the positive electrode active material, two or more kinds of materials having different particle diameters and/or compositions can be used as long as the materials have less deterioration due to charge and discharge even at high charge voltage. In this specification and the like, the term “having different compositions” includes not only a case where at least one of the elements constituting a material are different from the elements constituting another material but also a case where the same elements constitute each of a material and another material and the ratios of the elements constituting the materials are different.

As described above, high charge voltage in this specification and the like is the voltage higher than or equal to 4.6 V with reference to the potential when a lithium metal is used for the negative electrode; however, high charge voltage is a voltage higher than or equal to 4.5 V with reference to the potential when graphite is used for the negative electrode. In short, charge voltage higher than or equal to 4.6 V is referred to as high charge voltage in the case of using a lithium metal as the negative electrode in a half cell, and charge voltage higher than or equal to 4.5 V is referred to as high charge voltage in the case of using graphite for the negative electrode in a full cell.

### <Second Positive Electrode Active Material>

The positive electrode of one embodiment of the present invention can contain a second positive electrode active material in addition to the above positive electrode active material containing lithium. The second positive electrode active material contains a metal M, and is a material into/from which metal M ions can be inserted and extracted in charging and discharging of the battery.

In the case where potassium is used as the metal M, one or more of KₓMnO₂, KₓCoO₂, KₓV₂O₅, KₓCrO₂, KₓFe_{0.5}Mn_{0.5}O₂, KₓMn_{0.8}Fe_{0.2}O₂, KₓCo_{0.5}Mn_{0.5}O₂, KₓNi_{0.05}Mn_{0.95}O₂, KₓMn_{0.7}Ni_{0.3}O₂, KₓMn_{0.8}Fe_{0.1}Ni_{0.1}O₂, and KₓFe_{0.1}Mn_{0.8}Ti_{0.1}O₂ can be used as the second positive electrode active material, for example. Note that x is greater than or equal to 0 and less than or equal to 1. It is particularly preferable to use one or more of KₓMnO₂, KₓCoO₂, KₓV₂O₅, and KₓCrO₂. In this example, the second positive electrode active material can be referred to as a positive electrode active material containing potassium. The positive electrode including the positive electrode active material containing potassium in addition to the positive electrode active material containing lithium can insert and extract lithium ions and potassium ions.

A positive electrode including the second positive electrode active material in addition to the positive electrode active material containing lithium can be formed by applying positive electrode slurry including the positive electrode active material containing lithium and the second positive electrode active material onto a metal foil and drying the slurry. Note that pressing may be performed after drying.

### [Insertion and Extraction of Ions]

The following describes insertion and extraction of ions (cations) in the case where the electrolyte solution contains a lithium salt and a metal M salt and graphite is used for a negative electrode of the battery of one embodiment of the present invention. Note that an example in which a potassium salt is used as the metal M salt is described below.

In a conventional lithium-ion battery, lithium ions are inserted or extracted between the negative electrode active material and the electrolyte solution, and lithium ions are inserted or extracted between the positive electrode active material and the electrolyte solution.

In an example of the battery of one embodiment of the present invention, in the case where the electrolyte solution contains the lithium salt and the metal M salt and the positive electrode includes only a positive electrode active material containing lithium, lithium ions and potassium ions are inserted into or extracted from the negative electrode, and only lithium ions are inserted into or extracted from the positive electrode.

Alternatively, in another example of the battery of one embodiment of the present invention, in the case where the electrolyte solution contains the lithium salt and the metal M salt and the positive electrode includes the second positive electrode active material in addition to the positive electrode material containing lithium, lithium ions and potassium ions are inserted into and extracted from the negative electrode, and lithium ions and potassium ions are inserted into and extracted from the positive electrode, as well.

In this manner, in the battery of one embodiment of the present invention, lithium ions and/or metal M ions are inserted into or extracted from the positive electrode or the negative electrode in accordance with a charge reaction or a discharge reaction.

Note that in the case where the metal M ions have lower reaction resistance with the positive electrode or the negative electrode than the lithium ions in a low-temperature environment, for example, it is contemplated that the metal M ions contribute more to a charge and discharge reaction of a battery in some cases.

### [Separator]

The separator is provided between the positive electrode and the negative electrode. The separator can be formed using, for example, polyimide, polyolefin, cellulosic fiber, nonwoven fabric, glass fiber, ceramics, nylon (polyamide), vinylon (polyvinyl alcohol-based fiber), polyester, acrylic, or polyurethane fiber. The separator is preferably processed into a pouch shape to enclose one of the positive electrode and the negative electrode.

The separator may have a multilayer structure. For example, an organic material film of polypropylene, polyethylene, polyimide, or the like can be coated with a ceramic-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

### [Exterior Body]

As the exterior body included in the battery, an exterior body made of a metal material such as aluminum, stainless steel, or titanium can be used, for example. Alternatively, a film-shaped exterior body can also be used. As the film-shaped exterior body, for example, it is possible to use a film having a three-layer structure in which a highly flexible metal thin film or metal foil of aluminum, stainless steel, titanium, copper, nickel, or the like is provided over a film formed of a resin material such as polyethylene, polypropylene, polycarbonate, ionomer, or polyamide, and over the metal thin film, an insulating synthetic resin film of a polyamide-based resin, a polyester-based resin, or the like is provided as the outer surface of the exterior body. Such a multi-layer film can be referred to as a laminate film. In that case, the laminate film can be referred to as an aluminum laminate film, a stainless steel laminate film, a titanium laminate film, a copper laminate film, a nickel laminate film, or the like, which is named after the material of the metal layer included in the laminate film.

The material or thickness of the metal layer in the laminate film may sometimes affect flexibility of the battery. As an exterior body used for a highly flexible (bendable) battery, for example, an aluminum laminate film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is preferably larger than or equal to 10 μm.

### [Laminated Secondary Battery and Method for Manufacturing the Battery]

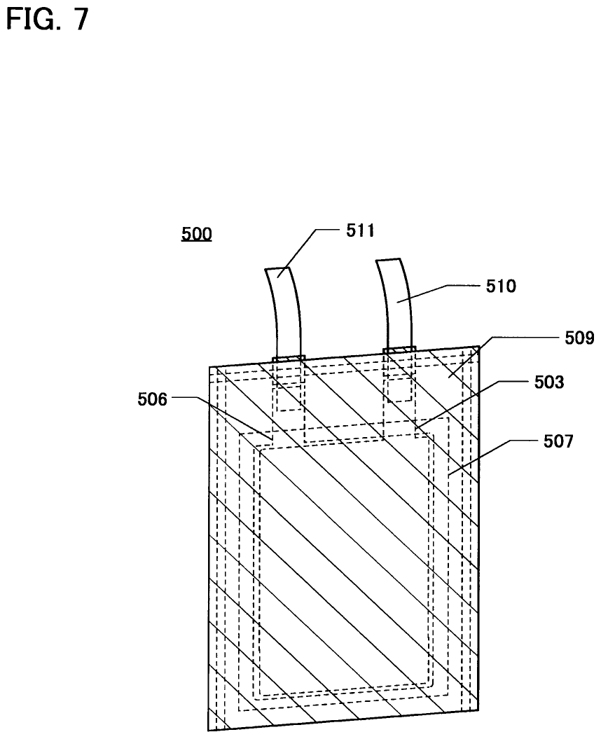

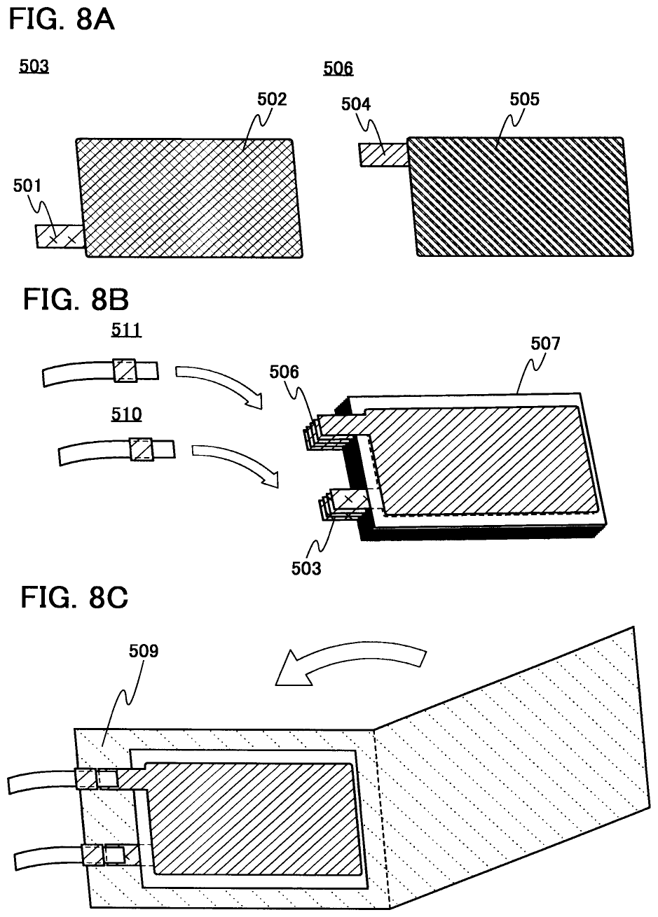

As an example of the battery 10 of one embodiment of the present invention, FIG. 7 and FIGS. 8A to 8C illustrate examples of external views of a laminated secondary battery 500. Note that the battery 10 of one embodiment of the present invention may be, for example, a cylindrical, rectangular, or coin-type battery, without being limited to a laminated battery.

An example of a method for fabricating the laminated secondary battery will be described with reference to FIGS. 8A to 8C. The laminated secondary battery illustrated in FIGS. 8A to 8C includes a positive electrode 503, a negative electrode 506, a separator 507, an exterior body 509, a positive electrode lead electrode 510, and a negative electrode lead electrode 511 as its component members. As illustrated in FIG. 8A, the positive electrode 503 includes a positive electrode current collector 501 and a positive electrode active material layer 502, and the negative electrode 506 includes a negative electrode current collector 504 and a negative electrode active material layer 505. When the laminated secondary battery has flexibility and is used in an electronic device at least part of which is flexible, the secondary battery can be bent accordingly as the electronic device is bent.

First, the negative electrode 506, the separator 507, and the positive electrode 503 are stacked. FIG. 8B illustrates a stack including the negative electrode 506, the separator 507, and the positive electrode 503. The secondary battery described here as an example includes five negative electrodes and four positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 8C. Then, the outer edges of the exterior body 509 are bonded to each other. The bonding can be performed by thermocompression, for example. At this time, a part (or one side) of the exterior body 509 is left unbonded to provide an inlet so that an electrolyte solution can be introduced later.

Next, an electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

When the positive electrode active material described in Embodiment 2 or Embodiment 3 is used in the positive electrode 503, the secondary battery 500 can have high discharge capacity and excellent cycle performance.

This embodiment can be implemented in combination with any of the other embodiments as appropriate.

### Embodiment 2

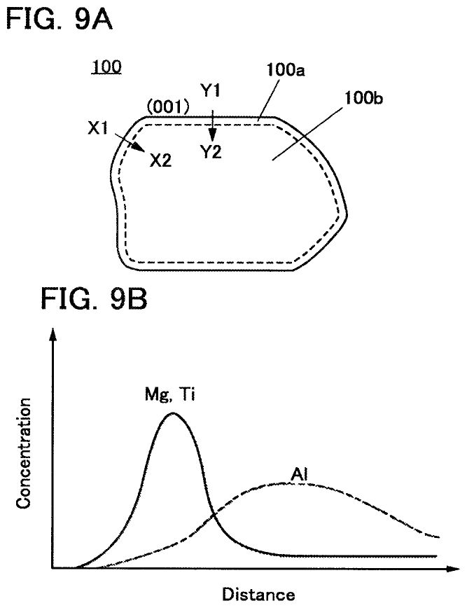

In this embodiment, the positive electrode active material 100 that can be used for the battery 10 of one embodiment of the present invention is described with reference to FIGS. 9A and 9B, FIG. 10, FIG. 11, FIGS. 12A to 12C, FIG. 13, FIG. 14, FIG. 15, FIG. 16, FIGS. 17A and 17B, and FIG. 18.

FIG. 9A is a cross-sectional view of the positive electrode active material 100 that can be used for the battery 10 of one embodiment of the present invention. FIG. 9B is a schematic view of element concentration distribution in the case of measurement from the surface toward the inner portion in cross-sectional analysis including the surface and the surface portion of the positive electrode active material 100. The measurement from the surface toward the inner portion is also regarded as measurement in the depth direction, and arrows X1-X2 and Y1-Y2 in FIG. 9A are examples of the depth direction.

As illustrated in FIG. 9A, the positive electrode active material 100 includes a surface portion 100a and an inner portion 100b. The dashed line in FIG. 9A denotes a boundary between the surface portion 100a and the inner portion 100b. In the drawing, (001) represents a (001) plane of LiMO₂. LiMO₂ belongs to a space group R-3m.

In this specification and the like, the surface portion 100a of the positive electrode active material 100 refers to a region that is in the range of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion. Note that “substantially perpendicular” refers to a state where an angle is greater than or equal to 80° and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region and a basal region. Here, the edge region has a surface exposed in a direction intersecting with the (001) plane (the surface is also referred to as a surface having an orientation other than the (001) orientation), and a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion refers to the edge region. Here, “intersect” means that an angle between a perpendicular line of a first plane (the (001) plane) and a normal of a second plane (a surface of the positive electrode active material 100) is greater than or equal to 10° and less than or equal to 90°, preferably greater than or equal to 30° and less than or equal to 90°, further preferably greater than or equal to 50° and less than or equal to 90°.

Moreover, the basal region has a surface parallel to the (001) plane (the surface is also referred to as a surface having the (001) orientation), and a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion refers to the basal region. Here, “parallel” means that an angle between the perpendicular line of the first plane (the (001) plane) and the normal of the second plane (the surface of the positive electrode active material 100) is greater than or equal to 0° and less than 10°, preferably greater than or equal to 0° and less than or equal to 5°, further preferably greater than or equal to 0° and less than or equal to 2.5°.

The surface of the positive electrode active material 100 refers to the surface of a composite oxide that includes the surface portion 100a and the inner portion 100b. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100 are not contained either in the positive electrode active material 100.

Although not illustrated, the positive electrode active material 100 may have a grain boundary. The crystal grain boundary refers to, for example, a portion where particles of the positive electrode active material 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed with a cross-sectional transmission electron microscope (TEM) image, a cross-sectional STEM image, or the like, i.e., a structure including another atom between lattices, a cavity, or the like. A crystal grain boundary can be regarded as a plane defect. The vicinity of the crystal grain boundary refers to a region ranging from the crystal grain boundary to 10 nm or less.

### <Contained Element>

The positive electrode active material 100 contains lithium, the transition metal M_{T}, oxygen, and an additive element. The transition metal M_{T} is one or more of cobalt, nickel, and manganese. Alternatively, the positive electrode active material 100 includes a composite oxide (LiM_{T}O₂) which contains lithium and the transition metal M_{T} and to which the additive element is added. Note that the positive electrode active material 100 that can be used for the battery 10 of one embodiment of the present invention preferably has a distribution of the additive element or a crystal structure described later. Therefore, the composition is not strictly limited to Li:M_{T}:O=1:1:2 (atomic ratio).

A positive electrode active material of a lithium-ion secondary battery needs to contain a transition metal which can involve in an oxidation-reduction reaction in order to maintain a neutrally charged state even when lithium ions are inserted and extracted. It is preferable that the positive electrode active material 100 that can be used for the battery 10 of one embodiment of the present invention mainly contain cobalt as a transition metal M_{T} involving in an oxidation-reduction reaction. Using cobalt at greater than or equal to 75 at %, preferably greater than or equal to 90 at %, further preferably greater than or equal to 95 at % as the transition metal contained in the positive electrode active material 100 brings many advantages such as relatively easy synthesis, easy handling, and excellent cycle performance, which is preferable.

The positive electrode active material 100 containing cobalt as the transition metal M_{T} at 75 at % or higher, preferably 90 at % or higher, further preferably 95 at % or higher has high stability when a large number of lithium ions are released by charging, as compared with a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel (III) accounts for the majority of the transition metal M_{T}, and a layer having an octahedral structure formed of nickel and oxygen is likely to be distorted. Thus, there is a concern that the crystal structure may break in charge-discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal M_{T}, such as lithium nickel oxide.

As the additive element contained in the positive electrode active material 100, one or more selected from magnesium, titanium, nickel, aluminum, fluorine, zirconium, vanadium, iron, manganese, chromium, niobium, arsenic, zinc, silicon, sulfur, phosphorus, boron, bromine, and beryllium are preferably used.

That is, the positive electrode active material 100 can include lithium cobalt oxide to which magnesium and titanium are added; lithium cobalt oxide to which magnesium, titanium, and fluorine are added; lithium cobalt oxide to which magnesium, nickel, aluminum, and titanium are added; lithium cobalt oxide to which magnesium, nickel, aluminum, titanium, and fluorine are added; lithium cobalt oxide to which magnesium is added; lithium cobalt oxide to which magnesium and fluorine are added; lithium cobalt oxide to which magnesium, nickel, and aluminum are added; lithium cobalt oxide to which magnesium, nickel, aluminum, and fluorine are added, or the like.

The additive element is preferably dissolved in the positive electrode active material 100. Thus, in STEM-energy dispersive X-ray spectroscopy (EDX) line analysis, for example, a position where the amount of the detected additive element increases is preferably at a deeper level than a position where the amount of the detected transition metal M_{T} increases, i.e., on the inner portion side of the positive electrode active material 100.

In this specification and the like, the depth at which the amount of detected element increases in STEM-EDX line analysis refers to the depth at which a measured value, which can be determined not to be a noise in terms of intensity, spatial resolution, and the like, is successively obtained.

Such an additive element further stabilizes the crystal structure of the positive electrode active material 100 as described later. In this specification and the like, an additive element can be rephrased as part of a raw material or a mixture.

Note that as the additive element, fluorine, zirconium, vanadium, iron, manganese, chromium, niobium, arsenic, zinc, silicon, sulfur, phosphorus, boron, bromine, or beryllium is not necessarily contained.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The positive electrode active material 100 contains the above-described additive element in the surface portion 100a. It is further preferable that a plurality of additive elements be contained. The surface portion 100a preferably has a higher concentration of one or more selected from the additive elements than the inner portion 100b. The surface portion 100a preferably has a larger detected amount of one or more of the additive elements than the inner portion 100b. The one or more of the additive elements contained in the positive electrode active material 100 preferably have a concentration gradient.

In addition, it is further preferable that the additive elements contained in the positive electrode active material 100 be differently distributed. For example, it is further preferable that peaks of the detected amounts of the additive elements in the surface portion be exhibited at different depths from the surface or the reference point in EDX line analysis described later. The peak of the detected amount here refers to a local maximum value of the detected amount in the surface portion 100a or a region ranging from the surface to 50 nm or less. The detected amount refers to counts in EDX line analysis.

### (Titanium)

When titanium is present in the surface portion 100a as the additive element, an effect of promoting insertion and extraction of lithium ions into and from the positive electrode active material 100 can be expected. However, when the concentration of titanium is too high or the region containing only titanium is too large, the layered rock-salt crystal structure of the positive electrode active material 100 may be distorted. Thus, another additive element such as nickel or magnesium is also preferably present in the surface portion 100a. Another additive element such as nickel or magnesium is expected to relieve the distortion of the crystal structure.

### [Distribution]

In order to exert the above effect, at least magnesium, nickel, and titanium of the additive elements preferably have higher concentrations in the surface portion 100a than in the inner portion 100b as illustrated in FIG. 9B. The detected amounts of at least magnesium, nickel, and titanium of the additive elements are preferably larger in the surface portion 100a than in the inner portion 100b. Peaks of the detected amounts are preferably observed in a region of the surface portion 100a that is closer to the surface. For example, the peaks of the detected amounts are preferably observed in a region ranging from the surface or the reference point to 3 nm or less. The distribution of magnesium and the distribution of nickel preferably overlap with each other. The peak of the detected amount of magnesium and that of the detected amount of nickel are at the same depth, the peak of magnesium may be closer to the surface, or the peak of nickel may be closer to the surface. The difference in depth between the peak of the detected amount of magnesium and the peak of the detected amount of nickel is preferably less than or equal to 3 nm, further preferably less than or equal to 1 nm. In addition, the half widths of the peaks of the detected amounts are preferably small.

Similarly, the distribution of magnesium and the distribution of titanium preferably overlap with each other. The peak of the detected amount of magnesium may be at the depth as that of the detected amount of titanium or the peak of magnesium may be closer to the surface than that of titanium, or the peak of titanium may be closer to the surface than that of magnesium. The difference in depth between the peak of the detected amount of magnesium and the peak of the detected amount of titanium is preferably less than or equal to 3 nm, further preferably less than or equal to 1 nm. In addition, the half widths of the detected amounts are preferably small.

The distributions of magnesium, nickel, and titanium preferably overlap with each other. The difference in depth among the peak of the detected amount of titanium, the peak of the detected amount of magnesium, and the peak of the detected amount of nickel is preferably less than or equal to 3 nm, further preferably less than or equal to 1 nm. In addition, the half widths of the detected amounts are preferably small.

A region where the distributions of magnesium and nickel overlap with each other, a region where the distributions of magnesium and titanium overlaps with each other, or a region where the distributions of magnesium, nickel, and titanium overlap with each other is preferably positioned in an edge region where lithium ions are inserted and extracted in the surface portion 100a. That is, the distributions of the additive elements in the schematic diagram in FIG. 9B is preferably observed in the direction indicated by the arrow X1-X2 in FIG. 9A. In contrast, in the surface portion 100a, the above overlapping region is not necessarily required in the basal region.

In some cases, the detected amount of nickel in the inner portion 100b is much smaller than that of nickel in the surface portion 100a or lower than or equal to 1 at %, or no nickel is detected in the inner portion 100b.

Although not illustrated in the drawing, as in the case of magnesium or nickel, the detected amount of fluorine is preferably larger in the surface portion 100a than in the inner portion. A peak of the detected amount of fluorine is preferably observed in a region of the surface portion 100a that is closer to the surface. For example, the peaks of the detected amounts of magnesium and nickel are preferably observed in a region ranging from the surface or the reference point to 3 nm or less. Similarly, the detected amounts of silicon, phosphorus, boron, and/or calcium are/is also preferably larger in the surface portion 100a than in the inner portion. Peaks of the detected amounts are preferably observed in a region of the surface portion 100a that is closer to the surface. For example, the peaks of the detected amounts are preferably observed in a region ranging from the surface or the reference point to 3 nm or less.

A peak of the detected amount of at least aluminum among the additive elements is preferably observed in a region that is located inward from regions in which peaks of the detected amounts of magnesium and titanium are observed. The distributions of magnesium and aluminum may overlap with each other as illustrated in FIG. 9B; however, the distributions of magnesium and aluminum may have almost no overlapping region. A peak of the detected amount of aluminum may be observed in the surface portion 100a or in a region at a larger depth than the surface portion 100a. For example, the peak is preferably observed in a region ranging from the surface or the reference point to 5 nm to 30 nm, inclusive, toward the inner portion.

When aluminum is distributed as described above, the layered rock-salt crystal structure of the positive electrode active material 100 can be more stable. For example, a change from a layered rock-salt crystal structure to a spinel crystal structure in the surface portion 100a of the positive electrode active material 100 is expected to be inhibited. Note that the spinel crystal structure generated in the layered rock-salt crystal structure is likely to move or spread along with transfer of electric charge of the transition metal M_{T}, for example. Defects such as a crystal grain boundary in the positive electrode active material 100 can serve as a diffusion path of lithium ions in the c-axis direction. The additive element such as aluminum can be contained in the vicinity of the defect. In other words, it is possible that the presence of aluminum easily causes diffusion of lithium ions.

Aluminum is distributed more inwardly than magnesium and titanium as described above. This is probably because the diffusion rate of aluminum is higher than those of magnesium and titanium. On the other hand, the detected amount of aluminum is small in the region that is the closest to the surface. This is presumably because aluminum can stay stably in a region other than a region where magnesium or the like is solid-soluted at a high concentration.

To be specific, in a region having a layered rock-salt crystal structure belonging to the space group R-3m or a cubic rock-salt crystal structure, the distance between a cation and oxygen in a region where magnesium is solid-soluted at a high concentration is longer than the distance between a cation and oxygen in LiAlO₂ having a layered rock-salt crystal structure, and aluminum is thus likely to be unstable. In the vicinity of cobalt, valence change due to replacement of Li⁺ with Mg²⁺ can be offset by Co²⁺ which is changed from Co³⁺, so that cation balance can be maintained. By contrast, Al is always trivalent and is thus presumed to be unlikely to stay stably in the vicinity of magnesium in a rock-salt or layered rock-salt crystal structure.

Although not illustrated, as in the case of aluminum, a peak of the detected amount of manganese is preferably observed in a region that is located inward from that of magnesium.

Note that the additive elements do not necessarily have similar concentration gradients or similar distributions throughout the surface portion 100a of the positive electrode active material 100.

The distributions of the additive elements at the surface having a (001) orientation may be different from those at other surfaces in the positive electrode active material 100. For example, the detected amount(s) of one or more of the additive elements may be smaller at the surface having the (001) orientation and the surface portion 100a thereof than at a surface having an orientation other than the (001) orientation. Specifically, the detected amount(s) of one or two or more of magnesium, nickel, and titanium may be small. Alternatively, at the surface having the (001) orientation and the surface portion 100a thereof, one or more of the additive elements may not be detected or may be detected at 1 at % or less. Specifically, it is acceptable that nickel is not detected or is detected at 1 at % or less. Especially in the case of an analysis method, e.g., EDX, in which characteristic X-rays are detected, the energy of cobalt (Co) Kβ line is close to that of nickel (Ni) Kα line and it is thus difficult to detect a slight amount of nickel in a material whose main element is cobalt. Alternatively, the peaks of the detected amounts of one or more of the additive elements at the surface having the (001) orientation and the surface portion 100a thereof may be positioned at portions shallower from the surface than the peaks of the detected amounts of the one or more of the additive elements at the surface having an orientation other than the (001) orientation. Specifically, the peaks of the detected amounts of magnesium and aluminum at the surface having the (001) orientation and the surface portion 100a thereof may be positioned shallower than the peaks of the detected amounts of magnesium and aluminum at the surface having an orientation other than the (001) orientation.

In a layered rock-salt crystal structure belonging to R-3m, cations are arranged parallel to the (001) plane. In other words, an M_{T}O₂ layer and a lithium layer are alternately stacked parallel to the (001) plane. Accordingly, a diffusion path of lithium ions is also parallel to the (001) plane.

The M_{T}O₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. Thus, for maintaining the crystal structure of the entire positive electrode active material 100, it is very important to reinforce the surface having an orientation other than the (001) orientation and the surface portion 100a.

Accordingly, in the positive electrode active material 100 of another embodiment of the present invention, it is important that the distribution of the additive element at the surface having an orientation other than the (001) orientation and the surface portion 100a thereof is the distribution shown in FIG. 9B. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface having an orientation other than the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface having an orientation other than the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in an embodiment below, in which high-purity LiM_{T}O₂ is formed, the additive element is mixed afterwards, and heating is performed, the additive element spreads mainly through a diffusion path of lithium ions. Thus, distribution of the additive element at the surface having an orientation other than the (001) orientation and the surface portion 100a thereof can easily fall within a preferred range.

### [Magnesium]

Magnesium is divalent, and a magnesium ion is more stable in a lithium site than in a cobalt site in a layered rock-salt crystal structure; thus, magnesium is likely to enter the lithium sites. An appropriate concentration of magnesium at the lithium sites of the surface portion 100a facilitates maintenance of the layered rock-salt crystal structure. This is presumably because magnesium at the lithium sites serves as a column supporting M_{T}O₂ layers. Moreover, the presence of magnesium can inhibit release of oxygen therearound in a state where x in LiₓCoO₂ is, for example, 0.24 or less. The presence of magnesium is also expected to increase the density of the positive electrode active material 100. In addition, a high magnesium concentration in the surface portion 100a can be expected to increase the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites as well as the lithium sites. Moreover, an undesired magnesium compound (e.g., an oxide or a fluoride) which does not enter the lithium site or the cobalt site might be unevenly distributed in the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

### [Nickel]

Nickel in a layered rock-salt crystal structure of LiM_{T}O₂ can be present at a cobalt site and/or a lithium site. Since nickel has a lower oxidation-reduction potential than cobalt, the presence of nickel at a cobalt site can facilitate release of lithium and electrons during charging, for example. As a result, the charge and discharge speed is expected to be increased. Accordingly, at the same charge voltage, the charge-discharge capacity in the case of the transition metal M_{T} being nickel can be higher than that in the case of the transition metal M_{T} being cobalt.

In addition, when nickel is present at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is presumably because nickel at the lithium sites also serves as a column supporting the M_{T}O₂ layers. Therefore, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO having a rock-salt crystal structure and CoO having a rock-salt crystal structure, and the orientations of NiO and LiCoO₂ are likely to be aligned with each other.

Ionization tendency is the lowest in nickel, followed in order by cobalt, aluminum, and magnesium (Mg>Al>Co>Ni). Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure. Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can be present at a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to suppress a change in the crystal structure. This would reduce degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charge tolerance. Moreover, an Al—O bond is stronger than a Co—O bond and thus release of oxygen around aluminum can be inhibited. These effects improve thermal stability. Therefore, a secondary battery that includes the positive electrode active material 100 containing aluminum as the additive element can have higher level of safety. In addition, the positive electrode active material 100 having a crystal structure that is unlikely to be broken by repeated charge and discharge can be provided.

Meanwhile, excess aluminum is liable to adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When part of oxygen in the surface portion 100a is replaced with fluorine, which is a monovalent anion, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when part of oxygen is replaced with fluorine in the surface portion 100a of the positive electrode active material 100, lithium ions near fluorine are likely to be extracted and inserted smoothly. Thus, a secondary battery including the positive electrode active material 100 can have improved charge-discharge characteristics, improved large current characteristics, or the like. When fluorine is present at the surface portion 100a including the surface that is in contact with an electrolyte solution, or when a fluoride is attached to the surface, an overreaction between the positive electrode active material 100 and the electrolyte solution can be suppressed. In addition, the corrosion resistance to hydrofluoric acid can be effectively increased.

In the case where a fluoride such as lithium fluoride that has a lower melting point than the other additive element sources, the fluoride can serve as a fusing agent (also referred to as a flux) for lowering the melting point of the other additive element sources. In the case where the fluoride contains LiF and MgF₂, the eutectic point of LiF and MgF₂ is around 742° C.; thus, the heating temperature in the heating step following the mixing of the additive element is preferably set higher than or equal to 742° C.

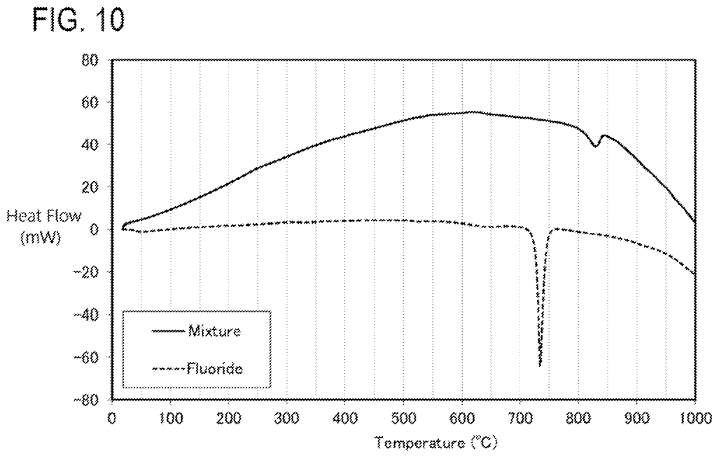

Here, differential scanning calorimetry measurement (DSC measurement) of a fluoride and a mixture is described with reference to FIG. 10. The fluoride in FIG. 10 is a mixture of LiF and MgF₂. The LiF and MgF₂ are mixed at the molar ratio of 1:3. The mixture in FIG. 10 is obtained by mixing of lithium cobalt oxide as lithium oxide and LiF and MgF₂ as the fluoride. LiCoO₂, LiF, and MgF₂ are mixed at the molar ratio of 100:0.33:1 to give the mixture.

As shown in FIG. 10, the endothermic peak of the fluoride is observed at around 735° C. The endothermic peak of the mixture is observed at around 830° C. Thus, the temperature of the heating following the mixing of the additive element is preferably higher than or equal to 742° C., further preferably higher than or equal to 830° C. The temperature of the heating may be higher than or equal to 800° C. between the above temperatures.

### [Other Additive Elements]

The surface portion 100a preferably contains phosphorus, in which case a short circuit can be sometimes inhibited while x in LiₓCoO₂ is kept small. For example, a compound containing phosphorus and oxygen is preferably included in the surface portion 100a.

When the positive electrode active material 100 contains phosphorus, phosphorus may react with hydrogen fluoride generated by the decomposition of the electrolyte solution or the electrolyte, which may decrease the hydrogen fluoride concentration in the electrolyte and is preferable.

In the case where the electrolyte contains LiPF₆, hydrogen fluoride might be generated by hydrolysis. In addition, hydrogen fluoride might be generated by the reaction between alkali and poly(vinylidene fluoride) (PVDF) used as a component of the positive electrode. The decrease in hydrogen fluoride concentration in the electrolyte may inhibit corrosion of a current collector and/or separation of a coating portion 104 or may inhibit a reduction in adhesion properties due to gelling and/or insolubilization of PVDF.

The positive electrode active material 100 preferably contains magnesium and phosphorus, in which case the crystal structure is extremely stable in a state with small x in LiₓCoO₂. When the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where the positive electrode active material 100 has a crack, crack development can be suppressed by phosphorus, more specifically, a compound containing phosphorus and oxygen or the like being in the inner portion, e.g., a hollow portion, of the positive electrode active material having the crack as a surface.

### [Synergistic Effect Between a Plurality of Additive Elements]

When the surface portion 100a contains both magnesium and nickel, divalent nickel can be more stable in the vicinity of divalent magnesium. Thus, even when x in LixM_{T}O₂ is small, dissolution of magnesium can be reduced, which can contribute to stabilization of the surface portion 100a.

For a similar reason, when the additive element is added to lithium cobalt oxide in the formation process, magnesium is preferably added in a step before addition of nickel. Alternatively, magnesium and nickel are preferably added in the same step. The reason is as follows: magnesium has a large ion radius and thus is likely to remain in the surface portion of lithium cobalt oxide regardless of in which step magnesium is added, but nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure of a wider region can be stabilized. For example, the stable crystal structure can be obtained in a wide region in the case where the positive electrode active material 100 contains, in the surface portion 100a, magnesium and nickel distributed in a region closer to the surface and aluminum distributed in a region deeper than magnesium and nickel, as compared with the case where only one or two of the additive elements are contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region ranging from the surface to 1 nm to 25 nm, both inclusive, in depth. Aluminum is preferably widely distributed in a region ranging from the surface to 0 nm to 100 nm, both inclusive, in depth, further preferably a region ranging from the surface to 0.5 nm to 50 nm, both inclusive, in depth, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, and/or a structure in which MgO and M_{T}O(II) are solid-soluted. Thus, the surface portion 100a should contain at least a metal element M_{T} typified by cobalt, also contain lithium in a discharged state, and have the path for insertion and extraction of lithium.

To ensure the sufficient path through which lithium is inserted and extracted, the concentration of cobalt is preferably higher than that of magnesium in the surface portion 100a. For example, when measurement by X-ray photoelectron spectroscopy (XPS) is performed from the surface of the positive electrode active material 100, the ratio of the number of magnesium (Mg) atoms to the number of cobalt (Co) atoms (Mg/Co) is preferably less than or equal to 0.62. In addition, the concentration of cobalt is preferably higher than those of nickel, aluminum, and fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and is present randomly also in the inner portion 100b at low concentrations. When magnesium and aluminum are present at the lithium sites of the inner portion 100b at appropriate concentrations, an effect of facilitating maintenance of the layered rock-salt crystal structure can be obtained in a manner similar to the above. When nickel is present in the inner portion 100b at an appropriate concentration, a shift in the layered structure formed of octahedrons of cobalt and oxygen can be suppressed in a manner similar to the above. Also in the case where both magnesium and nickel are contained, a synergistic effect of suppressing dissolution of magnesium can be expected in a manner similar to the above.

It is preferable that the crystal structure continuously change from the inner portion 100b toward the surface owing to the above-described concentration gradients of such additive elements. It is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the crystal orientation of the surface portion 100a that has a rock-salt crystal structure or has the features of both a rock-salt crystal structure and a layered rock-salt crystal structure is preferably substantially aligned with the crystal orientation of the layered rock-salt inner portion 100b.

Note that in this specification and the like, a layered rock-salt crystal structure, which belongs to the space group R-3m, of a composite oxide containing lithium and a transition metal such as cobalt is a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may be present. In the layered rock-salt crystal structure, strictly, a lattice of a rock-salt crystal is distorted in some cases.

A rock-salt crystal structure is a structure in which a cubic crystal structure such as a crystal structure belonging to a space group Fm-3m is included and cations and anions are alternately arranged. Note that a cation or anion vacancy may be present.

Having features of both a layered rock-salt crystal structure and a rock-salt crystal structure can be determined with use of electron diffraction, a TEM image, a cross-sectional STEM image, or the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in a rock-salt crystal structure in an ideal state, for instance, and on the (003) plane in a layered rock-salt crystal structure in an ideal state, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. Anions on the {111} plane of a cubic crystal structure form a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The crystal orientations in two regions being substantially aligned with each other can be determined, for example, from a TEM image, a STEM image, a high-angle annular dark field scanning TEM (HAADF-STEM) image, an annular bright-field scanning transmission electron microscope (ABF-STEM) image, an electron diffraction pattern, an FFT pattern of a TEM image, or an FFT pattern of a STEM image or the like. Furthermore, XRD, neutron diffraction, or the like can also be used for determination.

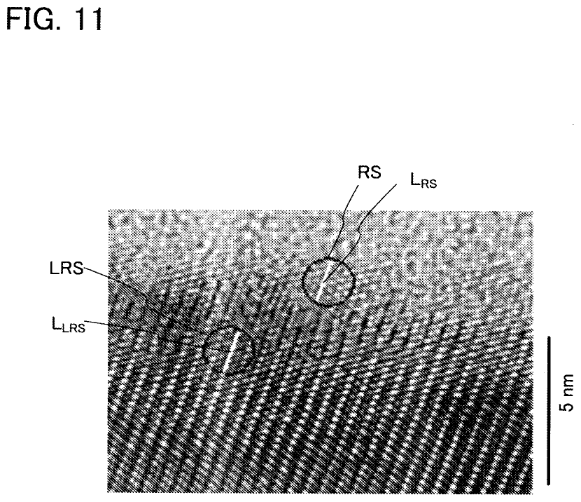

FIG. 11 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 11) is 5° or less or 2.5° or less in the TEM image, it can be determined that the crystal planes are substantially aligned with each other, that is, orientations of the crystals are substantially aligned with each other. Similarly, when the angle between the dark lines is 5° or less or 2.5° or less, it can be determined that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be determined that arrangements of the atoms are substantially aligned with each other, that is, orientations of the crystals are substantially aligned with each other. Similarly, when the angle between the dark lines is 5° or less or 2.5° or less, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, with an ABF-STEM image, crystal orientations can be determined as with a HAADF-STEM image.

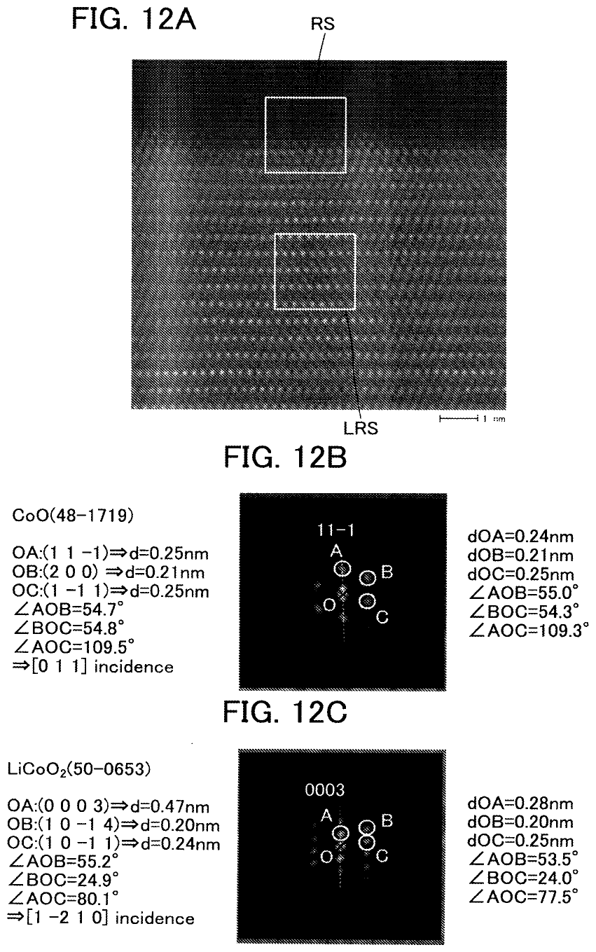

FIG. 12A shows an example of a STEM image in which orientations of the layered rock-salt crystal LRS and the rock-salt crystal RS are substantially aligned with each other. FIG. 12B shows an FFT pattern of a region of the rock-salt crystal RS, and FIG. 12C shows an FFT pattern of a region of the layered rock-salt crystal LRS. In FIGS. 12B and 12C, the composition, the JCPDS card number and d values and angles that are calculated from the JCPDS card data are shown on the left. The measured values are shown on the right. A spot denoted by O is zero-order diffraction.

A spot denoted by A in FIG. 12B is derived from 11-1 reflection of a cubic structure. A spot denoted by A in FIG. 12C is derived from 0003 reflection of a layered rock-salt crystal structure. FIGS. 12B and 12C show that the direction of the 11-1 reflection of the cubic structure and the direction of the 0003 reflection of the layered rock-salt crystal structure are substantially aligned with each other. That is, a straight line that passes through AO in FIG. 12B is substantially parallel to a straight line that passes through AO in FIG. 12C. Here, the terms “substantially aligned” and “substantially parallel” mean that the angle between the two lines is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1>orientation of the rock-salt crystal may be substantially aligned with each other. In that case, it is preferable that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 12C is derived from 10-14 reflection of the layered rock-salt crystal structure. This is sometimes observed at a position where the difference in orientation from the reciprocal lattice point derived from the 0003 reflection of the layered rock-salt crystal structure (A in FIG. 12C) is greater than or equal to 52° and less than or equal to 56° (i.e., ∠AOB is 52° to) 56° and d is greater than or equal to 0.19 nm and less than or equal to 0.21 nm. Note that these indices are just an example, and the spot does not necessarily correspond with them and may be, for example, a reciprocal lattice point equivalent to 0003 and 10-14.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 12B is derived from 200 reflection of the cubic structure. This diffraction spot is sometimes observed at a position where the difference in orientation of reflection derived from the 11-1 reflection of the cubic structure (A in FIG. 12B) is greater than or equal to 54° and less than or equal to 56° (i.e., ∠AOB is greater than or equal to 54° and less than or equal to) 56°. Note that these indices are just an example, and the spot does not necessarily correspond with them and may be, for example, a reciprocal lattice point equivalent to 11-1 and 200 of the cubic structure.

It is known that in a layered rock-salt positive electrode active material, such as lithium cobalt oxide, the (0003) plane and a plane equivalent thereto and the (10-14) plane and a plane equivalent thereto are likely to be crystal planes. Thus, to observe the (0003) plane with a TEM or the like, for example, a positive electrode active material particle in which a crystal plane that is presumably the (0003) plane is observed with a SEM or the like is preferably selected first; then, the positive electrode active material particle is preferably processed to be thin using a focused ion beam (FIB) or the like such that the (0003) plane can be observed with the TEM or the like with an electron beam thereof entering in [12-10]. To determine alignment of crystal orientations, a sample is preferably processed to be thin so that the (0003) plane of the layered rock-salt crystal structure is easily observed.

### <Crystal Structure>

<<x=1 in LiₓM_{T}O_{2>>}

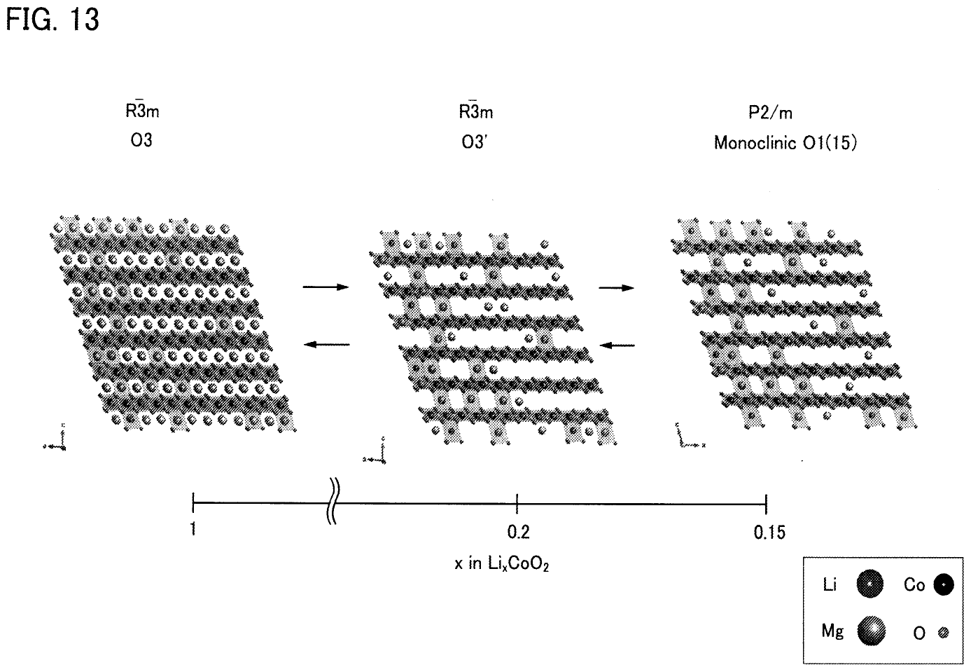

The positive electrode active material 100 that can be used in the battery 10 of one embodiment of the present invention preferably has a layered rock-salt crystal structure belonging to the space group R-3m in a discharged state, i.e., a state where x in LiₓM_{T}O₂ is 1. A composite oxide having a layered rock-salt crystal structure has high discharge capacity and a two-dimensional diffusion path for lithium ions and is thus suitable for an insertion/extraction reaction of lithium ions, and is favorably used as a positive electrode active material of a secondary battery accordingly. For this reason, it is particularly preferable that the inner portion 100b, which accounts for the majority of the volume of the positive electrode active material 100, have a layered rock-salt crystal structure. In FIG. 13, the layered rock-salt crystal structure is denoted by R-3m O3. In the R-3m O3 type structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 5).

Meanwhile, the surface portion 100a of the positive electrode active material 100 that can be used in the battery 10 of one embodiment of the present invention preferably has a function of reinforcing the layered structure, which is formed of octahedrons of the transition metal M_{T} and oxygen, of the inner portion 100b so that the layered structure does not break even when lithium is extracted from the positive electrode active material 100 by charging. The surface portion 100a preferably functions as a barrier film of the positive electrode active material 100. The surface portion 100a, which is the outer portion of the positive electrode active material 100, preferably reinforces the positive electrode active material 100. Here, the term “reinforce” means inhibiting release of oxygen and/or a structural change of the surface portion 100a and the inner portion 100b of the positive electrode active material 100 such as a shift in the layered structure formed of octahedrons of the transition metal M_{T} and oxygen, and/or inhibiting oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 that can be used in the battery 10 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. For example, it is presumable that a shift in the crystal structure of the layered structure formed of octahedrons of the transition metal M_{T} and oxygen in the surface portion 100a has an influence on the inner portion 100b to cause a shift in the crystal structure of the layered structure in the inner portion 100b, leading to degradation of the crystal structure in the entire positive electrode active material 100. Meanwhile, when the surface portion 100a can have sufficient stability, the layered structure, which is formed of octahedrons of the transition metal M_{T} and oxygen, of the inner portion 100b is difficult to break even when x in LiₓM_{T}O₂ is small, e.g., 0.24 or less. Furthermore, a shift in layers, which are formed of octahedrons of the transition metal M_{T} and oxygen, of the inner portion 100b can be suppressed.

In the inner portion 100b of the positive electrode active material 100, the density of defects including dislocation is preferably low. In the positive electrode active material 100, the crystallite size measured by XRD is preferably large. In other words, the inner portion 100b preferably has high crystallinity. Furthermore, the positive electrode active material 100 preferably has a smooth surface. These features are important factors for assuring the reliability of the positive electrode active material 100 in a secondary battery. A secondary battery can have a high upper limit of a charge voltage when including a highly reliable positive electrode active material and thereby can have high charge and discharge capacity.

Dislocation in the inner portion 100b can be observed with a TEM, for example. Defects such as dislocation are sometimes not observed in a specific 1-μm-square region of an observation sample in the case where the density of defects including dislocation is sufficiently low. Note that dislocation is a kind of crystal defect and is different from a vacancy defect.

The larger the crystallite size is, the more easily the O3′ type structure is maintained and contraction of the c-axis length is inhibited in the state where x in LiₓCoO₂ is small as described later.

It is presumed that the crystallite size measured by XRD is larger when fewer defects including dislocation are observed with a TEM.

To obtain an XRD pattern for calculation of a crystallite size, a positive electrode that includes a positive electrode active material, a current collector, a binder, a conductive material, and the like may be subjected to XRD, although it is preferable that only the positive electrode active material be subjected to XRD. Note that the positive electrode active material particles in the positive electrode are likely to be oriented such that the crystal planes of the positive electrode active material particles are oriented in the same direction owing to, for example, pressure application in a formation process. When many of the positive electrode active material particles are oriented in the above manner, the crystallite size might fail to be calculated accurately. Thus, it is preferable to obtain an XRD pattern in the following manner: a positive electrode active material layer is taken from the positive electrode, the binder and the like in the positive electrode active material layer are removed to some extent using a solvent or the like, and a sample holder is filled with the resultant positive electrode active material, for example. Alternatively, a powder sample of the positive electrode active material or the like may be attached onto a reflection-free silicon plate to which grease is applied, for example.

The crystallite size can be calculated using ICSD coll. code. 172909 as literature data of lithium cobalt oxide and a diffraction pattern that is obtained with Bruker D8 ADVANCE, for example, under the following conditions: CuKα is used as an X-ray, the 2θ range is from 15° to 90°, an increment is 0.005, and a detector is LYNXEYE XE-T. Analysis can be conducted using DIFFRAC.TOPAS ver. 6 as crystal structure analysis software, and for example, settings are as follows.
Emission Profile: CuKa5.lam
Background: Chebychev polynomial of degree 5
Instrument
Primary radius: 280 mm
Secondary radius: 280 mm
Linear PSD 2Th angular range: 2.9
FDS angle: 0.3
Full Axial Convolution
Filament length: 12 mm
Sample length: 15 mm
Receiving Slit length: 12 mm
Primary Sollers: 2.5
Secondary Sollers: 2.5
Corrections
Specimen displacement: Refine
LP Factor: 0

A value of LVol-IB, which is a crystallite size calculated by the above method, is preferably employed as a crystallite size. Note that in a sample whose preferred orientation is calculated to be less than 0.8, too many particles are oriented in the same direction; thus, this sample is not suitable for calculation of a crystallite size in some cases.

<<Small x in LiₓM_{T}O_{2>>}

In the positive electrode active material 100 that can be used in the battery 10 of one embodiment of the present invention, the crystal structure of the positive electrode active material 100 in a state where x in LiₓM_{T}O₂ is small is different from that of a conventional positive electrode active material because the positive electrode active material 100 has the above-described additive element distribution and/or crystal structure in a discharged state. Here, “x is small” means 0.1<x≤0.24.

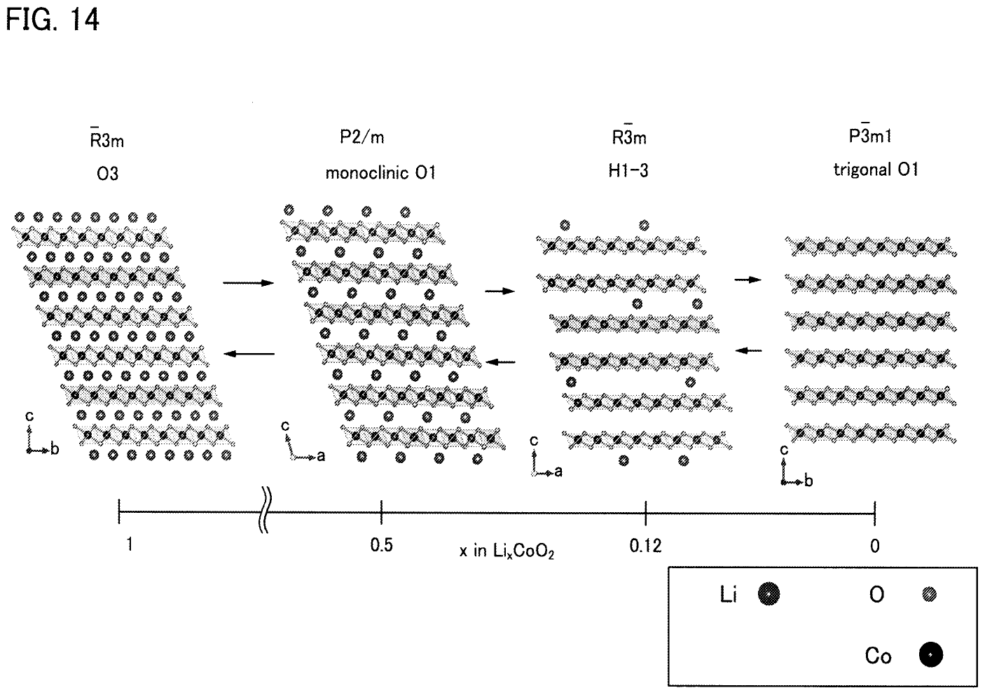

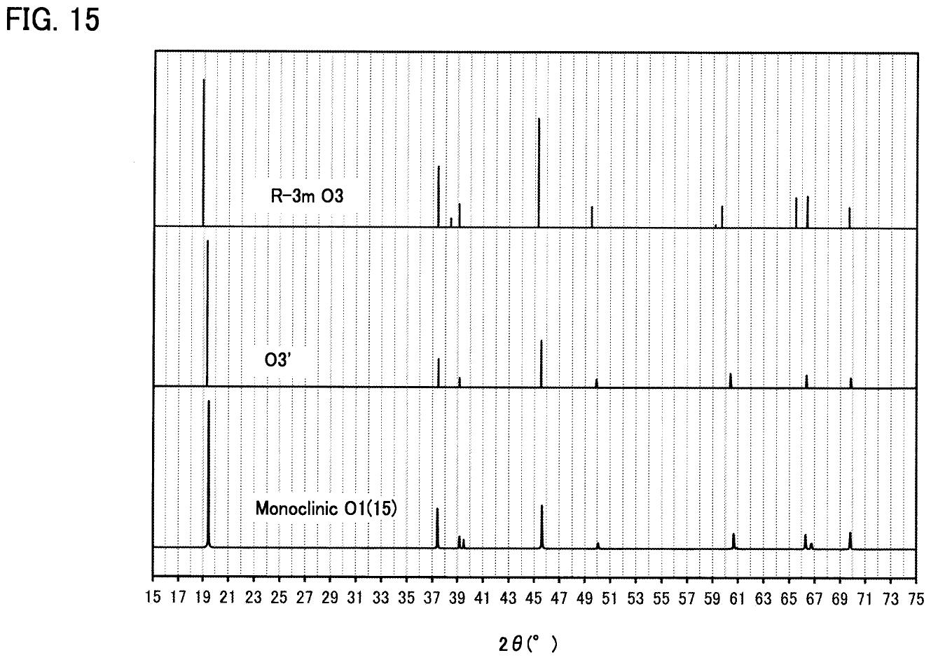

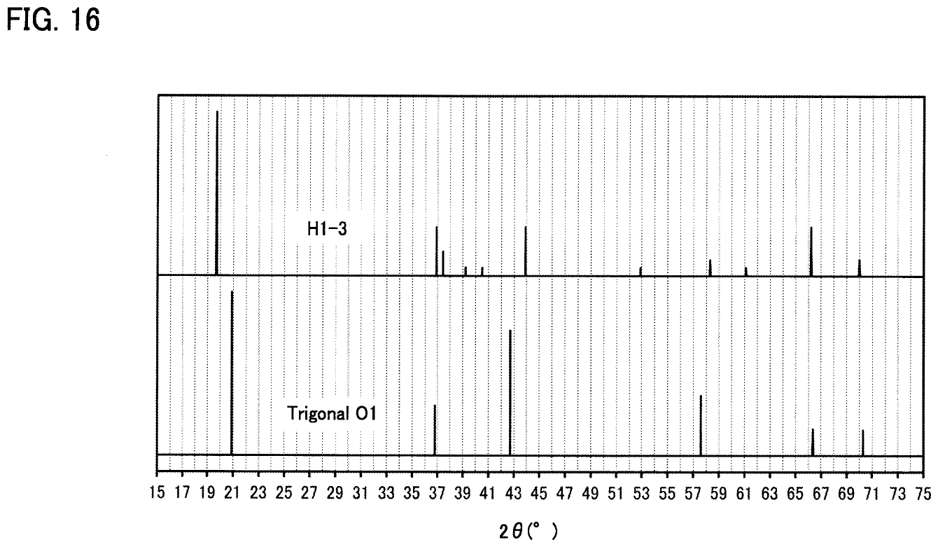

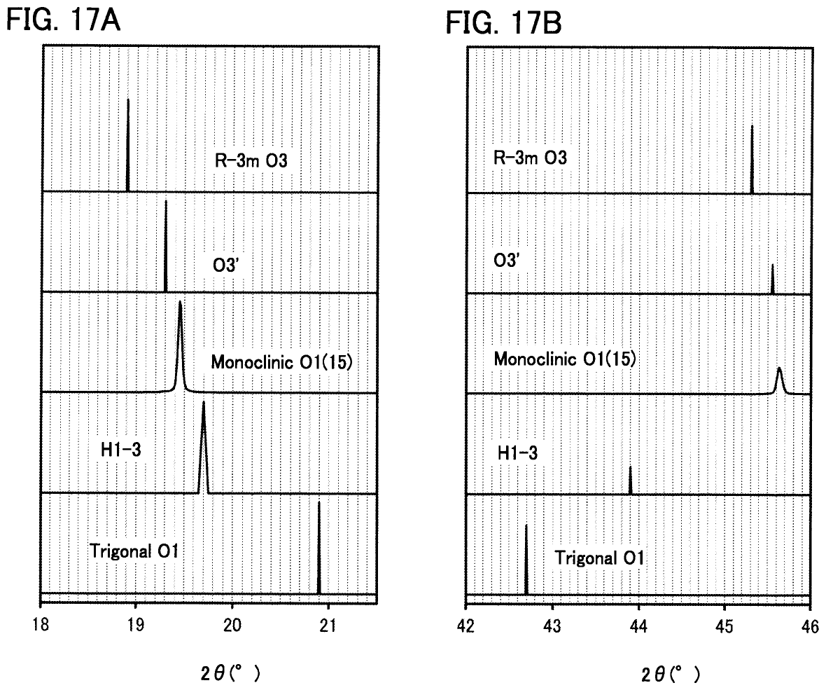

A conventional positive electrode active material and the positive electrode active material 100 that can be used in the battery 10 of one embodiment of the present invention are compared, and changes in the crystal structures owing to a change in x in LiₓM_{T}O₂ will be described with reference to FIG. 13, FIG. 14, FIG. 15, FIG. 16, and FIGS. 17A and 17B.

A change in the crystal structure of the conventional positive electrode active material is shown in FIG. 14. The conventional positive electrode active material shown in FIG. 14 is lithium cobalt oxide (LiCoO₂) containing no additive element. A change in the crystal structure of lithium cobalt oxide containing no additive element is described in Non-Patent Documents 1 to 3 and the like.

In FIG. 14, the crystal structure of lithium cobalt oxide with x in LiₓCoO₂ being 1 is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that since insertion and extraction of lithium do not necessarily uniformly occur in the positive electrode active material in reality, the lithium concentrations can vary. Thus, the H1-3 type structure is started to be observed when x is approximately 0.25 in an experiment. The number of cobalt atoms per unit cell in the actual H1-3 type structure is twice that in other structures in practice. However, in this specification including FIG. 14, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charge that makes x in LiₓCoO₂ be 0.24 or less and discharge are repeated, the crystal structure of conventional lithium cobalt oxide repeatedly changes between the H1-3 type structure and the R-3m O3 type structure in a discharged state (i.e., an unbalanced phase change).

However, there is a large shift in the CoO₂ layers between these two crystal structures. As denoted by the dotted lines and the arrows in FIG. 14, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. Thus, the difference between the H1-3 type structure and the R-3m O3 type structure in a discharged state that contain the same number of cobalt atoms is greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites which lithium can occupy stably and makes insertion and extraction of lithium difficult.

Meanwhile, in the positive electrode active material 100 that can be used in the battery 10 of one embodiment of the present invention illustrated in FIG. 13, a change in the crystal structure between a discharged state with x in LiₓCoO₂ of 1 and a state with x of 0.24 or less is smaller than that in a conventional positive electrode active material. Specifically, a shift in the M_{T}O₂ layers between the state with x of 1 and the state with x of 0.24 or less can be small. Furthermore, a change in the volume can be small in the case where the positive electrode active materials have the same number of cobalt atoms. Thus, the positive electrode active material 100 that can be used in the battery 10 of one embodiment of the present invention can have a crystal structure that is difficult to break even when charge that makes x be 0.24 or less and discharge are repeated, and obtain excellent cycle performance. In addition, the positive electrode active material 100 that can be used in the battery 10 of one embodiment of the present invention with x in LiₓM_{T}O₂ of 0.24 or less can have a more stable crystal structure than a conventional positive electrode active material. Thus, in the positive electrode active material 100 that can be used in the battery 10 of one embodiment of the present invention, a short circuit is less likely to occur in a state where x in LiₓM_{T}O₂ is kept at 0.24 or less. This is preferable because the safety of a secondary battery is further improved.

FIG. 13 shows crystal structures of the inner portion 100b of the positive electrode active material 100 in a state where x in LiₓM_{T}O₂ is 1, approximately 0.2, and approximately 0.15. The inner portion 100b, accounting for the majority of the volume of the positive electrode active material 100, largely contributes to charge and discharge and is accordingly a portion where a shift in M_{T}O₂ layers and a volume change matter most.

The positive electrode active material 100 with x of 1 has the R-3m O3 type structure, which is the same as that of conventional lithium cobalt oxide.

However, in a state where x is 0.24 or less, e.g., approximately 0.2 or approximately 0.15, the positive electrode active material 100 has a crystal structure different from the H1-3 type structure of conventional lithium cobalt oxide.

The positive electrode active material 100 that can be used in the battery 10 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 13, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹⁰ m), further preferably 2.807≤a≤2.827 (×10⁻¹⁰ m), typically a=2.817 (×10⁻¹⁰ m). The lattice constant of the c-axis is preferably 13.681≤c≤13.881 (×10⁻¹⁰ m), further preferably 13.751≤c≤13.811 (×10⁻¹⁰ m), typically, c=13.781 (×10⁻¹⁰ m).

When x is approximately 0.15, the positive electrode active material 100 that can be used in the battery 10 of one embodiment of the present invention has a monoclinic crystal structure belonging to the space group P2/m. In this structure, a unit cell includes one CoO₂ layer. Here, lithium in the positive electrode active material 100 is approximately 15 at % of that in a discharged state. Thus, this crystal structure is referred to as a monoclinic O1 (15) type structure. In FIG. 13, this crystal structure is denoted by P2/m monoclinic O1 (15).

In the unit cell of the monoclinic O1 (15) type structure, the coordinates of cobalt and oxygen can be represented by Co1 (0.5, 0, 0.5), Co2 (0, 0.5, 0.5), O1 (X_{O1}, 0, Z_{O1}) where 0.23≤X_{O1}≤0.24 and 0.61≤ Z_{O1}≤0.65, and O2 (X_{O2}, 0.5, Z_{O2}) where 0.75≤X_{O2}≤0.78 and 0.68≤Z_{O2}≤0.71. The unit cell has lattice constants a=4.880±0.05 (×10⁻¹⁰ m), b=2.817±0.05 (×10⁻¹⁰ m), c=4.839±0.05 (×10⁻¹⁰ m), α=90°, β=109.6±0.1°, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) where 0.21≤Z_{O}≤0.23. The unit cell has lattice constants a=2.817±0.02 (×10⁻¹⁰ m) and c=13.68±0.1 (×10⁻¹⁰ m).

In both the O3′ type structure and the monoclinic O1 (15) type structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 13, the CoO₂ layers hardly shift between the R-3m 03 structure in a discharged state, the O3′ type structure, and the monoclinic O1 (15) type structure.

The difference between the R-3m O3 type structure in a discharged state and the O3′ type structure that contain the same number of cobalt atoms is 2.5% or less, specifically 2.2% or less, typically 1.8%.

The difference between the R-3m O3 type structure in a discharged state and the monoclinic O1 (15) type structure that contain the same number of cobalt atoms is 3.3% or less, specifically 3.0% or less, typically 2.5%.

Table 7 shows a difference in volume of one cobalt atom between the R-3m O3 type structure in a discharged state, the O3′ type structure, the monoclinic O1 (15) type structure, the H1-3 type structure, and the trigonal O1 type structure. For the lattice constants of the R-3m O3 type structure in a discharged state and the trigonal O1 type structure in Table 7, which are used for the calculation, ICSD coll. code. 172909 and 88721 can be referred to. For the lattice constants of the R-3m O3 type structure in a discharged state and the trigonal O1 type structure, the values in the documents (ICSD coll. code. 172909 and 88721) can be referred to. For the lattice constants of the H1-3 type structure, Non-Patent Document 3 can be referred to. The lattice constants of the O3′ type structure and the monoclinic O1 (15) type structure can be calculated from the experimental values of XRD.

TABLE 7

| | | | | | Volume per | | Volume |
|---|---|---|---|---|---|---|---|
| Crystal | Lattice constant | | | | unit cell | Volume per | change |
| structure | a(Å) | b(Å) | c(Å) | β(°) | (Å³) | Co (Å3) | rate (%) |
| R-3m O3 (LiCoO₂) | 2.8156 | 2.8156 | 14.0542 | 90 | 96.49 | 32.16 | — |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 that can be used in the battery 10 of one embodiment of the present invention, a change in the crystal structure caused when x in LiₓM_{T}O₂ is small, i.e., when a large amount of lithium is extracted, is smaller than that in a conventional positive electrode active material. In addition, a change in the volume in the case where the positive electrode active materials having the same number of cobalt atoms are compared is reduced. Thus, the crystal structure of the positive electrode active material 100 is less likely to break even when charge that makes x be 0.24 or less and discharge are repeated. Therefore, a decrease in charge and discharge capacity of the positive electrode active material 100 in charge-discharge cycles is reduced. Furthermore, the positive electrode active material 100 can stably use a larger amount of lithium than a conventional positive electrode active material and thus has large discharge capacity per weight and per volume. Thus, with the use of the positive electrode active material 100, a secondary battery with large discharge capacity per weight and per volume can be fabricated.

Note that the positive electrode active material 100 actually has the O3′ type structure in some cases when x in LiₓM_{T}O₂ is greater than or equal to 0.15 and less than or equal to 0.24, and is assumed to have the O3′ type structure even when x is greater than 0.24 and less than or equal to 0.27. In addition, the positive electrode active material 100 actually has the monoclinic O₁ (15) type structure in some cases when x in LiₓM_{T}O₂ is greater than 0.1 and less than or equal to 0.2, typically greater than or equal to 0.15 and less than or equal to 0.17. However, the crystal structure is influenced by not only x in LiₓM_{T}O₂ but also the number of charge-discharge cycles, a charge current and a discharge current, temperature, an electrolyte, and the like, so that the range of x is not limited to the above.

Thus, when x in LiₓM_{T}O₂ is greater than 0.1 and less than or equal to 0.24, the positive electrode active material 100 may have the O3′ type structure and/or the monoclinic O1 (15) type structure. Not all the particles contained in the inner portion 100b of the positive electrode active material 100 necessarily have the O3′ type structure and/or the monoclinic O1 (15) type structure. Some of the particles may have another crystal structure or be amorphous.

In order to make x in LiₓM_{T}O₂ small, charge at a high charge voltage is necessary in general. Therefore, the state where x in LiₓM_{T}O₂ is small can be rephrased as a state where charge at a high charge voltage has been performed.

That is, it is also can be said that the positive electrode active material 100 that can be used in the battery 10 of one embodiment of the present invention is preferable because the R-3m O3 structure having symmetry can be maintained even when charge at a high charge voltage, e.g., 4.6 V or higher is performed at 25° C.

At a far higher charge voltage, the H1-3 type structure is eventually observed in the positive electrode active material 100 in some cases. As described above, the crystal structure is influenced by the number of charge-discharge cycles, a charge current and a discharge current, temperature, an electrolyte, and the like, so that the positive electrode active material 100 that can be used in the battery 10 of one embodiment of the present invention may sometimes have the O3′ type structure even at a lower charge voltage, e.g., a charge voltage of higher than or equal to 4.5 V and lower than 4.6 V at 25° C. Similarly, the positive electrode active material 100 may sometimes have the monoclinic O1 (15) type structure at a charge voltage of higher than or equal to 4.65 V and lower than or equal to 4.7 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although lithium occupies all lithium sites in the O3′ type structure and the monoclinic O1 (15) type structure with an equal probability in the illustration of FIG. 13, the present invention is not limited thereto. Lithium may occupy unevenly in only some of the lithium sites. For example, lithium may be symmetrically present as in the monoclinic O1 type structure (Li_{0.5}CoO₂) in FIG. 14. Distribution of lithium can be analyzed by neutron diffraction, for example.

Each of the O3′ type structure and the monoclinic O1 (15) type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

### <<Crystal Grain Boundary>>

It is further preferable that the additive element contained in the positive electrode active material 100 that can be used in the battery 10 of one embodiment of the present invention have the above-described distribution and be at least partly unevenly distributed at the crystal grain boundary and the vicinity thereof.

In this specification and the like, uneven distribution refers to a state where the concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary and the vicinity thereof in the positive electrode active material 100 is preferably higher than that in the other regions in the inner portion 100b. In addition, the fluorine concentration at the crystal grain boundary and the vicinity thereof is preferably higher than that in the other regions in the inner portion 100b. In addition, the nickel concentration at the crystal grain boundary and the vicinity thereof is preferably higher than that in the other regions in the inner portion 100b. In addition, the aluminum concentration at the crystal grain boundary and the vicinity thereof is preferably higher than that in the other regions in the inner portion 100b.

The crystal grain boundary is a plane defect, and thus tends to be unstable and suffer a change in the crystal structure like the surface of the particle. Thus, the higher the concentration of the additive element at the crystal grain boundary and the vicinity thereof is, the more effectively the change in the crystal structure can be reduced.

In the case where the magnesium concentration and the fluorine concentration are high at the crystal grain boundary and the vicinity thereof, the magnesium concentration and the fluorine concentration in the vicinity of a surface generated by a crack are also high even if the crack is generated along the crystal grain boundary of the positive electrode active material 100 that can be used in the battery 10 of one embodiment of the present invention. Thus, the positive electrode active material including a crack can also have an increased corrosion resistance to hydrofluoric acid. In addition, the positive electrode active material including a crack can suppress a side reaction between the electrolyte solution and the positive electrode active material.

### <Particle Diameter>

When the particle diameter of the positive electrode active material 100 that can be used in the battery 10 of one embodiment of the present invention is too large, there are problems such as difficulty in lithium diffusion and large roughness of the surface of an active material layer at the time when the material is applied to a current collector. By contrast, too small a particle diameter causes problems such as an overreaction with the electrolyte solution.

The particle diameter of the positive electrode active material 100 can be measured with a laser diffraction particle size distribution analyzer, for example. As the particle diameter of the positive electrode active material 100 measured by a laser diffraction particle size distribution analyzer, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

A positive electrode is preferably formed using a mixture of particles having different particle diameters to have an increased electrode density and enable a high energy density of a secondary battery. The positive electrode active material 100 with a relatively small particle diameter is expected to enable favorable charge-discharge rate characteristics. A secondary battery that includes the positive electrode active material 100 having a relatively large particle diameter is expected to have high charge-discharge cycles performance and maintain high discharge capacity.

### <Analysis Method>

Whether or not a positive electrode active material is the positive electrode active material 100 that can be used in the battery 10 of one embodiment of the present invention, which has the O3′ type structure and/or the monoclinic O1 (15) type structure when x in LiₓM_{T}O₂ is small, can be determined by analyzing a positive electrode including the positive electrode active material with small x in LiₓM_{T}O₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. Among some kinds of XRD, powder XRD enables that diffraction peaks appearing in powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the influence of orientation of positive electrode active materials due to pressure or the like is removed. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 that can be used in the battery 10 of one embodiment of the present invention is a small change in the crystal structure between a state with x in LiₓM_{T}O₂ of 1 and a state with x of 0.24 or less. A material 50% or more of which has the crystal structure to be largely changed by high-voltage charge is not preferable because the material cannot withstand repetition of high-voltage charge and discharge. It is noted that the O3′ type structure or the monoclinic O1 (15) type structure is not obtained in some cases only by addition of the additive element. For example, in a state with x in LiₓM_{T}O₂ of 0.24 or less, lithium cobalt oxide containing magnesium and fluorine or lithium cobalt oxide containing magnesium and aluminum has the O3′ type structure and/or the monoclinic O1 (15) type structure at 60% or more in some cases, and has the H1-3 type structure at 50% or more in other cases, depending on the concentration and distribution of the additive element.

In addition, in a state where x in LiₓM_{T}O₂ is too small, e.g., 0.1 or less, or charge voltage is higher than 4.9 V, the positive electrode active material 100 that can be used in the battery 10 of the present invention might have the H1-3 structure or the trigonal O1 structure. Thus, to determine whether or not a positive electrode active material is the positive electrode active material 100 that can be used in the battery 10 of one embodiment of the present invention, analysis of the crystal structure by XRD and other methods and data such as charge capacity or charge voltage are needed.

Note that the crystal structure of a positive electrode active material in a state with small x may be changed when the positive electrode active material is exposed to the air. For example, the O3′ type structure and the monoclinic O1 (15) type structure change into the H1-3 type structure in some cases. For that reason, all samples to be used for analysis of the crystal structure are preferably handled in an inert atmosphere such as an argon atmosphere.

Whether the additive element contained in a positive electrode active material has the above-described distribution can be determined by analysis using XPS, EDX, electron probe microanalysis (EPMA), or the like.

The crystal structure of the surface portion 100a, the crystal grain boundary, or the like can be analyzed by electron diffraction of a cross section of the positive electrode active material 100, for example.

### <<Charge Method>>

Whether or not a composite oxide is the positive electrode active material 100 that can be used in the battery 10 of one embodiment of the present invention can be determined by charging a CR2032 coin cell (with a diameter of 20 mm and a height of 3.2 mm) that is formed using the composite oxide and a lithium metal respectively for a positive electrode and a counter electrode, for example. The coin cell includes an electrolyte solution, a separator, a positive electrode can, and a negative electrode can.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is charged to a freely selected voltage (e.g., 4.5 V, 4.55 V, 4.6 V, 4.65 V, 4.7 V, 4.75 V, or 4.8 V). The charge conditions are not particularly limited as long as charge to a freely selected voltage can be performed for sufficient time. In the case of CCCV charge, for example, CC charge can be performed with a current higher than or equal to 20 mA/g and lower than or equal to 100 mA/g, and CV charge can be ended with a current higher than or equal to 2 mA/g and lower than or equal to 10 mA/g. To observe a phase change of the positive electrode active material, charge with such a small current value is preferably performed. Meanwhile, in the case where a current does not reach higher than or equal to 2 mA/g and lower than or equal to 10 mA/g even when CV charge is performed for a long time, the CV charge may be ended after the sufficient time passes from the start because the current is probably consumed not for charging the positive electrode active material but for decomposing the electrolyte solution. The sufficient time in this case can be longer than or equal to 1.5 hours and shorter than or equal to 3 hours. The temperature is set to 25° C. or 45° C. After the charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere for various analyses to be performed later. For example, XRD can be performed on the positive electrode active material enclosed in an airtight container with an argon atmosphere. After the charge is completed, the positive electrode is preferably taken out immediately and analyzed. Specifically, the positive electrode is preferably analyzed within 1 hour after the completion of the charge, further preferably within 30 minutes after the completion of the charge.

In the case where the crystal structure in a charged state after multiple charge-discharge cycles is analyzed, the conditions of the multiple charge-discharge cycles may be different from the above-described charge conditions. For example, the charge can be performed in the following manner: constant current charge to a freely selected voltage (e.g., 4.6 V, 4.65 V, 4.7 V, 4.75 V, or 4.8 V) at a current value of higher than or equal to 20 mA/g and lower than or equal to 100 mA/g is performed and then, constant voltage charge is performed until the current value becomes higher than or equal to 2 mA/g and lower than or equal to 10 mA/g. As the discharge, constant current discharge can be performed at higher than or equal to 20 mA/g and lower than or equal to 100 mA/g until the discharge voltage reaches 2.5 V.

Also in the case where the crystal structure in a discharged state after the multiple charge-discharge cycles is analyzed, constant current discharge can be performed at a current value of higher than or equal to 20 mA/g and lower than or equal to 100 mA/g until the discharge voltage reaches 2.5 V, for example.

### <<XRD>>

The apparatus and conditions adopted in the XRD measurement are not particularly limited. The measurement can be performed with the apparatus and conditions as described below, for example.
XRD apparatus: Bruker AXS D8 ADVANCE
X-ray: CuKα₁ radiation
Output: 40 kV, 40 mA
Angle of divergence: Div. Slit, 0.5° Detector: LynxEye
Scanning method: 2θ/θ continuous scan
Measurement range (2θ): from 15° to 90°
Step width (2θ): 0.01° counting time: 1 sec/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be attached to a substrate with a double-sided adhesive tape and the positive electrode active layer can be set at the level of a measurement plane required by the apparatus.

FIG. 15, FIG. 16, and FIGS. 17A and 17B show ideal powder XRD patterns with CuKα₁ radiation that are calculated from models of the O3′ type structure, the monoclinic O1 (15) type structure, and the H1-3 type structure. For comparison, ideal XRD patterns calculated from the crystal structure of LiCoO₂ (O3) with x in LiₓCoO₂ of 1 and the trigonal O1 type structure with x of 0 are also shown. FIGS. 17A and 17B each show the XRD pattern of the O3′ type structure, that of the monoclinic O1 (15) type structure, and that of the H1-3 type structure together; FIG. 17A is an enlarged view showing a range of 2θ of 18° to 21°, both inclusive, and FIG. 17B is an enlarged view showing a range of 2θ of 42° to 46°, both inclusive. Note that the patterns of LiCoO₂ (O3) and CoO₂ (O1) are made on the basis of crystal structure data obtained from the Inorganic Crystal Structure Database (ICSD) (see Non-Patent Document 4) with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type structure is similarly made on the basis of the crystal structure data disclosed in Non-Patent Document 3. The O3′ type structure and the monoclinic O1(15) type structure are estimated from the XRD pattern of the positive electrode active material, the crystal structures are fitted with TOPAS ver. 3 (crystal structure analysis software produced by Bruker Corporation), and the XRD patterns of the O3′ type structure and the monoclinic O1(15) type structure are made in a similar manner to other structures.

As shown in FIG. 15 and FIGS. 17A and 17B, the O3′ type structure exhibits diffraction peaks at 2θ of 19.25±0.12° (greater than or equal to 19.13° and less than) 19.37° and 2θ of 45.47±0.10° (greater than or equal to 45.37° and less than 45.57°).

The monoclinic O1 (15) type structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 16 and FIGS. 17A and 17B, the H1-3 type structure and the trigonal O1 type structure do not exhibit peaks at these positions. Thus, exhibiting the peak at 2θ of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 that can be used in the battery 10 of one embodiment of the present invention.

It can be said that, in the positive electrode active material 100 that can be used in the battery 10 of one embodiment of the present invention, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 that can be used in the battery 10 of one embodiment of the present invention has the O3′ type structure and/or the monoclinic O1(15) type structure in some cases when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1 (15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to 50%, preferably greater than or equal to 60%, further preferably greater than or equal to 66% can have sufficiently good cycle performance.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed.

Furthermore, even after 100 or more charge-discharge cycles after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 2θ value. In the case of the above-described measurement conditions, the peak observed in the 2θ range of 43° to 46°, both inclusive, preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity greatly contributes to stability of the crystal structure after charging.

The crystallite size of the O3′ type structure and the monoclinic O1(15) type structure of the positive electrode active material 100 is decreased to approximately 1/20 of that of LiCoO₂ (O3) in a discharged state. Thus, the peak of the O3′ type structure and/or the monoclinic O1(15) type structure can be clearly observed when x in LiₓCoO₂ is small even under the same XRD measurement conditions as those of a positive electrode before charging and discharging. By contrast, conventional LiCoO₂ has a small crystallite size and exhibits a broad and small peak although it can partly have a structure similar to the O3′ type structure and/or the monoclinic O1 (15) type structure. The crystallite size can be calculated from the half width of the XRD peak.

As described above, the influence of the Jahn-Teller effect is preferably small in the positive electrode active material 100 that can be used in the battery 10 of one embodiment of the present invention. The positive electrode active material 100 that can be used in the battery 10 of one embodiment of the present invention may contain a transition metal such as nickel or manganese as the additive element in addition to cobalt as long as the influence of the Jahn-Teller effect is small.

For example, the value of a-axis/c-axis tends to significantly change between nickel concentrations of 5 at % and 7.5 at %, and the distortion of the a-axis becomes large at a nickel concentration of 7.5 at %. This distortion is likely to be derived from the Jahn-Teller distortion of trivalent nickel. Therefore, among the transition metals M_{T} contained in the positive electrode active material 100, nickel is preferably contained at less than 7.5 at %.

It is also indicated that the lattice constant changes differently at manganese concentrations of 5 at % or higher and does not follow the Vegard's law. Thus, among the transition metals M_{T} contained in the positive electrode active material 100, manganese is preferably contained at 4 at % or lower.

Note that the nickel concentration and the manganese concentration in the surface portion 100a are not limited to the above ranges. In other words, the nickel concentration and the manganese concentration in the surface portion 100a may be higher than the above concentrations.

Preferable ranges of the lattice constants of the positive electrode active material of one embodiment of the present invention are examined above. In the layered rock-salt crystal structure of the positive electrode active material 100 in a discharged state or a state where charge and discharge are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charge and discharge are not performed may be the state of powder before the formation of a positive electrode of a secondary battery.

Alternatively, in the layered rock-salt crystal structure of the positive electrode active material 100 in a discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in a discharged state or the state where charge and discharge are not performed is subjected to XRD analysis, a first peak is observed in the 2θ range of 18.50° to 19.30°, both inclusive, and a second peak is observed in the 2θ range of 38.00° to 38.80°, both inclusive, in some cases.

### <<XPS>>

In an inorganic oxide, a region that is approximately 2 nm to 8 nm (normally, less than or equal to 5 nm) in depth from a surface can be analyzed by XPS using monochromatic aluminum Kα radiation as an X-ray source; thus, the concentrations of elements in approximately half the depth of the surface portion 100a can be quantitatively analyzed. The bonding states of the elements can be analyzed by narrow scanning. Note that in many cases, the quantitative accuracy of XPS is approximately +1 at %, and the lower detection limit is approximately 1 at % but depends on the element.

In the positive electrode active material 100 that can be used in the battery 10 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected elements in the entire positive electrode active material 100. For this reason, for example, it is preferable that the concentration of one or more additive elements selected from the surface portion 100a, which is measured by XPS or the like, be higher than the average concentration of the additive elements in the entire positive electrode active material 100, which is measured by ICP-MS, GD-MS, or the like. For example, the concentration of magnesium of at least part of the surface portion 100a, which is measured by XPS or the like, is preferably higher than the average concentration of magnesium of the entire positive electrode active material 100. The concentration of titanium of at least part of the surface portion 100a is preferably higher than the average concentration of titanium of the entire positive electrode active material 100. The concentration of nickel of at least part of the surface portion 100a is preferably higher than the average concentration of nickel of the entire positive electrode active material 100. The concentration of aluminum of at least part of the surface portion 100a is preferably higher than the average concentration of aluminum of the entire positive electrode active material 100. The concentration of fluorine of at least part of the surface portion 100a is preferably higher than the average concentration of fluorine of the entire positive electrode active material 100.

Note that the surface and the surface portion 100a of the positive electrode active material 100 that can be used in the battery 10 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt enables comparison while reducing the influence of a carbonate or the like which is chemically adsorbed after formation of the positive electrode active material, which is preferable. For example, in the XPS analysis, the ratio of the number of magnesium atoms to the number of cobalt atoms (Mg/Co) is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentrations of cobalt and lithium in at least part of the surface portion 100a, which are measured by XPS or the like, are preferably higher than that of magnesium in at least part of the surface portion 100a, which is measured by XPS or the like. The concentrations of cobalt and lithium in at least part of the surface portion 100a, which are measured by XPS or the like, are preferably higher than that of nickel in at least part of the surface portion 100a, which is measured by XPS or the like. In addition, the concentrations of cobalt and lithium in at least part of the surface portion 100a, which are measured by XPS or the like, are preferably higher than that of aluminum in at least part of the surface portion 100a, which is measured by XPS or the like. Moreover, the concentrations of cobalt and lithium in at least part of the surface portion 100a, which are measured by XPS or the like, are preferably higher than that of fluorine in at least part of the surface portion 100a, which is measured by XPS or the like.

It is further preferable that aluminum be widely distributed in a deep region, for example, in a region ranging from the surface or the reference point to a depth of 5 nm to 50 nm, both inclusive. Therefore, aluminum is detected by analysis on the entire positive electrode active material 100 by ICP-MS, GD-MS, or the like, but the concentration of aluminum is preferably 1 at % or lower or aluminum is not detected by XPS or the like.

Moreover, when XPS analysis is performed on the positive electrode active material 100 that can be used in the battery 10 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably 0.3 times or more and 0.9 times or less, further preferably 0.1 times or more and 1.1 times or less the number of cobalt atoms. When the ratio is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray, for example. An extraction angle is, for example, 45°. For example, the measurement can be performed using the following apparatus and conditions.
Measurement apparatus: PHI Quantera II
X-ray: monochromatic Al Kα (1486.6 eV)
Detection area: 100 μmϕ
Detection depth: approximately 4 to 5 nm (extraction angle) 45°
Measurement spectrum: wide scan, narrow scan of each detected element

In addition, when the positive electrode active material 100 that can be used in the battery 10 of one embodiment of the present invention is analyzed by XPS, a peak indicating the bonding energy of fluorine with another element is preferably at greater than or equal to 682 eV and less than 685 eV, further preferably approximately 684.3 eV. This value is different from the bonding energy of lithium fluoride (685 eV) and that of magnesium fluoride (686 eV).

Furthermore, when the positive electrode active material 100 that can be used in the battery 10 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### <<EDX>>

One or more selected from the additive elements contained in the positive electrode active material 100 preferably have a concentration gradient. It is further preferable that the additive elements contained in the positive electrode active material 100 exhibit concentration peaks at different depths from the surface. For example, the concentration gradient of the additive element can be evaluated by exposing a cross section of the positive electrode active material 100 using a focused ion beam (FIB) or the like and analyzing the cross section using energy dispersive X-ray spectroscopy (EDX), electron probe microanalysis (EPMA), or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as EDX line analysis in some cases. The measurement of a region without scanning is referred to as point analysis.

By EDX area analysis (e.g., element mapping), the concentrations of the additive elements in the surface portion 100a, the inner portion 100b, the vicinity of the crystal grain boundary, and the like of the positive electrode active material 100 can be quantitatively analyzed. By EDX line analysis, the concentration distributions and the highest concentrations of the additive elements can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M_{T} (e.g., Co, Ni, Mn, Fe, or the like) that is oxidized or reduced due to insertion and extraction of lithium are present and a region where oxygen and the transition metal M are absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, when STEM-EDX line analysis or the like in the depth direction is described, the reference point is a point where the detected amount of the characteristic X-ray of the transition metal M_{T} is equal to 50% of the sum of the average value M_{TAVE} of the detected amounts of the characteristic X-ray of the transition metal M_{T} in the inner portion and the average value M_{TBG} of the detected amounts of the characteristic X-ray of the transition metal M_{T} of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M_{T} is equal to 50% of the sum of the average value of the detected amounts of the characteristic X-ray of the transition metal M_{T} in the inner portion and the average value of the detected amounts of the characteristic X-ray of the transition metal M_{T} of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M_{T} is equal to 50% of the sum of the average value M_{TAVE} of the detected amounts of the characteristic X-ray of the transition metal M_{T} in the inner portion and the average value M_{TBG} of the detected amounts of the characteristic X-ray of the transition metal M_{T} of the background can be employed as the reference point. In the case of a positive electrode active material containing a plurality of the transition metals M_{T}, the reference point can be determined using M_{TAVE} and M_{TBG} of the element whose detected amount of the characteristic X-ray in the inner portion is larger than that of any other element.

The average value M_{TBG} of the detected amounts of the characteristic X-ray of the transition metal M_{T} of the background can be calculated by averaging the amount in the range of 2 nm or more, preferably 3 nm or more, which is outside the positive electrode active material and excludes the neighborhood of the portion at which the detected amount of the characteristic X-ray of the transition metal M_{T} begins to increase, for example. The average value M_{TAVE} of the detected amounts of the characteristic X-ray of the transition metal M_{T} in the inner portion can be calculated by averaging the detected amounts in the range of 2 nm or more, preferably 3 nm or more in a portion that ranges down to at least 30 nm, preferably greater than 50 nm in a depth direction from the depth at which the detected amounts of the characteristic X-ray of the transition metal M_{T} and oxygen are saturated and stabilized, e.g., the depth at which the detected amount of the characteristic X-ray of the transition metal M_{T} begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image.

The spatial resolution of STEM-EDX is approximately 1 nm. Thus, the position where the detected amount of the characteristic X-ray of the additive element has the maximum value may be shifted by approximately 1 nm. For example, even when the position where the detected amount of the characteristic X-ray of the additive element such as magnesium has the maximum value is outside the surface determined in the above-described manner, it can be said that a difference between the maximum value and the surface is within the margin of error when the difference is less than 1 nm.

The adverse effect of a noise can be reduced by scanning the same portion a plurality of times under the same conditions. For example, an integrated value obtained by performing scanning six times can be used to make the graph of the characteristic X-ray of each element. The number of times of scanning is not limited to six and an average of measured values obtained by performing scanning seven or more times can be used to make the graph of the characteristic X-ray of each element.

STEM-EDX line analysis can be performed as follows, for example. First, a protective film is deposited over a surface of a positive electrode active material. For example, carbon can be deposited with an ion sputtering apparatus (MC1000, Hitachi High-Tech Corporation).

Next, the positive electrode active material is thinned to fabricate a sample that is subjected to cross-section observation by STEM analysis. For example, the positive electrode active material can be thinned with an FIB-SEM apparatus (XVision 200TBS, Hitachi High-Tech Corporation). Here, picking up can be performed by a micro probing system (MPS), and the acceleration voltage at final processing can be, for example, 10 kV.

The STEM-EDX line analysis can be performed using, for example, a STEM apparatus (HD-2700, Hitachi High-Tech Corporation) and Octane T Ultra W (EDAX Inc) as an EDX detector. In the EDX line analysis, the emission current of the STEM apparatus is set to be in the range of 6 μA to 10 μA, both inclusive, and a portion of the thinned sample, which is not positioned at a deep level and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

EDX area analysis or EDX point analysis of the positive electrode active material 100 that can be used in the battery 10 of one embodiment of the present invention reveals that the concentration of each additive element, specifically, magnesium or the like in the surface portion 100a is preferably higher than that in the inner portion 100b.

For example, EDX area analysis or EDX point analysis of the positive electrode active material 100 containing magnesium as the additive element preferably reveals that the magnesium concentration in the surface portion 100a is higher than that in the inner portion 100b. In the EDX line analysis, a peak of the magnesium concentration in the surface portion 100a is preferably observed in a region ranging, toward the center of the positive electrode active material 100, from the surface thereof or a reference point to a depth of 3 nm, further preferably a depth of 1 nm, still further preferably a depth of 0.5 nm. In addition, the magnesium concentration preferably attenuates to less than or equal to 60% of the peak concentration at a depth of 1 nm from the point where the concentration reaches the peak. In addition, the magnesium concentration preferably attenuates to less than or equal to 30% of the peak concentration at a depth of 2 nm from the point where the concentration reaches the peak. Here, “a peak of concentration (also referred to as a peak top)” refers to the local maximum value of concentration.

In the EDX line analysis, the maximum value of the magnesium concentration (the detected amount of magnesium/the sum of the detected amounts of magnesium, oxygen, cobalt, fluorine, aluminum, titanium, and nickel) in the surface portion 100a is preferably higher than or equal to 0.5 at % and lower than or equal to 10 at %, further preferably higher than or equal to 1 at % and lower than or equal to 5 at %.

In the EDX line analysis, the maximum value of the titanium concentration (the detected amount of titanium/the sum of the detected amounts of magnesium, oxygen, cobalt, fluorine, aluminum, titanium, and nickel) in the surface portion 100a is preferably higher than or equal to 0.2 at % and lower than or equal to 5 at %, further preferably higher than or equal to 0.5 at % and lower than or equal to 2 at %.

In the EDX line analysis, the maximum value of the nickel concentration (the detected amount of nickel/the sum of the detected amounts of magnesium, oxygen, cobalt, fluorine, aluminum, titanium, and nickel) in the surface portion 100a is preferably higher than or equal to 0.2 at % and lower than or equal to 5 at %, further preferably higher than or equal to 0.5 at % and lower than or equal to 3 at %.

When the positive electrode active material 100 contains magnesium and fluorine as the additive elements, the distribution of fluorine preferably includes a region that overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a is preferably observed in a region ranging from the surface of the positive electrode active material 100 or a reference point to a depth of 3 nm, further preferably a depth of 1 nm, still further preferably a depth of 0.5 nm toward the center of the positive electrode active material 100. It is further preferable that a peak of the fluorine concentration be slightly closer to the surface side than a peak of the magnesium concentration is, which increases resistance to hydrofluoric acid.

For example, it is preferable that a peak of the fluorine concentration be closer to the surface side than a peak of the magnesium concentration is by 0.5 nm or more, further preferably 1.5 nm or more.

In the positive electrode active material 100 containing nickel as the additive element, a peak of the nickel concentration in the surface portion 100a is preferably observed in a region ranging from the surface of the positive electrode active material 100 or a reference point to a depth of 3 nm, further preferably a depth of 1 nm, still further preferably a depth of 0.5 nm toward the center of the positive electrode active material 100. When the positive electrode active material 100 contains magnesium and nickel, the distribution of nickel preferably includes a region that overlaps with the distribution of magnesium. For example, a difference in the depth direction between a peak of the nickel concentration and a peak of the magnesium concentration is preferably within 3 nm, further preferably within 1 nm.

In the positive electrode active material 100 containing titanium as the additive element, a peak of the titanium concentration in the surface portion 100a is preferably observed in a region ranging from the surface of the positive electrode active material 100 or a reference point to a depth of 3 nm, further preferably a depth of 1 nm, still further preferably a depth of 0.5 nm toward the center of the positive electrode active material 100. When the positive electrode active material 100 contains magnesium and titanium, the distribution of titanium preferably includes a region that overlaps with the distribution of magnesium. For example, a difference in the depth direction between a peak of the titanium concentration and a peak of the magnesium concentration is preferably within 3 nm, further preferably within 1 nm.

In the case where the positive electrode active material 100 contains aluminum as the additive element, in the EDX line analysis, the peak of the magnesium concentration, the nickel concentration, or the fluorine concentration is preferably closer to the surface than the peak of the aluminum concentration is in the surface portion 100a. For example, the peak of the aluminum concentration is preferably observed in a region ranging from the surface of the positive electrode active material 100 or a reference point to a depth of from 0.5 nm to 50 nm, both inclusive, further preferably a depth of from 5 nm and to 50 nm, both inclusive, toward the center of the positive electrode active material 100.

In the case where the positive electrode active material 100 contains magnesium, titanium, nickel, and aluminum, the battery using the positive electrode active material 100 can achieve both “high cycle performance” in which discharge capacity degradation by repetition of high-voltage charge (e.g., charge with an upper limit of 4.6 V) and discharge can be inhibited, and “excellent low-temperature characteristics” enabling high discharge capacity at low temperatures (e.g., 0° C., −20° C., and −40° C.).

EDX line, area, or point analysis of the positive electrode active material 100 reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of aluminum to cobalt (Al/Co) at a peak of the aluminum concentration is preferably greater than or equal to 0.05 and less than or equal to 0.6, further preferably greater than or equal to 0.1 and less than or equal to 0.45. The atomic ratio of nickel to cobalt (Ni/Co) at a peak of the nickel concentration is preferably greater than or equal to 0 and less than or equal to 0.2, further preferably greater than or equal to 0.01 and less than or equal to 0.1. The atomic ratio of fluorine to cobalt (F/Co) at a peak of the fluorine concentration is preferably greater than or equal to 0 and less than or equal to 1.6, further preferably greater than or equal to 0.1 and less than or equal to 1.4.

When the line analysis or the area analysis is performed on the positive electrode active material 100, the atomic ratio of the additive element A to cobalt Co (A/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the linear analysis or area planar analysis is performed on the positive electrode active material 100 containing magnesium as the additive element, the atomic ratio of magnesium to cobalt (Mg/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted by EPMA. In area analysis, the distribution of each element can be analyzed.

In EPMA area analysis of a cross section of the positive electrode active material 100 that can be used in the battery 10 of one embodiment of the present invention, one or two selected from the additive elements preferably have a concentration gradient, as in the EDX analysis. It is further preferable that the additive elements exhibit concentration peaks at different depths from the surface. The preferable ranges of the concentration peaks of the additive elements are the same as those in the case of EDX.

In EPMA, a region from a surface to a depth of approximately 1 μm is analyzed. Thus, the quantitative value of each element is sometimes different from measurement results obtained by other analysis methods. For example, when EPMA surface analysis is performed on the positive electrode active material 100, the concentration of the additive element in the surface portion 100a may be lower than the concentration obtained in XPS in some cases.

### <<Raman Spectroscopy>>

As described above, at least part of the surface portion 100a of the positive electrode active material 100 that can be used in the battery 10 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that has entered a lithium site, cobalt that is present at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with a several square micrometers and a depth of approximately 1 μm of a surface portion, a Co—O bond only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that an appropriate range of the surface portion 100a of the positive electrode active material 100 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not occupy too excessively the surface portion 100a, in particular, the outermost surface (e.g., a region ranging from the surface to a depth of 1 nm). This is because a diffusion path of lithium can be ensured and a function of stabilizing a crystal structure can be enhanced in the case where the additive element such as magnesium is present in the lithium layer while the outermost surface has a layered rock-salt crystal structure as compared with the case where the outermost surface is covered with a rock-salt crystal structure.

Therefore, for example, when a nanobeam electron diffraction pattern of a region that extends from the surface to a depth less than or equal to 1 nm and a nanobeam electron diffraction pattern of a region that extends from a depth of 3 nm to a depth of 10 nm are obtained, a difference between lattice constants calculated from the patterns is preferably small.

For example, a difference between lattice constants calculated from a measured portion that is at a depth less than or equal to 1 nm from the surface and a measured portion that is at a depth greater than or equal to 3 nm and less than or equal to 10 nm from the surface is preferably less than or equal to 0.1 (×10⁻¹ m) for a-axis and less than or equal to 0.1 (×10⁻¹ m) for c-axis. The difference is further preferably less than or equal to 0.05 (×10⁻¹⁰ m) for a-axis and less than or equal to 0.6 (×10⁻¹⁰ m) for c-axis, still further preferably less than or equal to 0.04 (×10⁻¹⁰ m) for a-axis and less than or equal to 0.3 (×10⁻¹⁰ m) for c-axis.

### <<Surface Roughness and Specific Surface Area>>

The positive electrode active material 100 that can be used in the battery 10 of one embodiment of the present invention preferably has a smooth surface with little unevenness. A smooth surface with little unevenness indicates that a fusing agent described later adequately functions and the surfaces of the additive element source and lithium cobalt oxide melt. Thus, a smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

For example, the level of surface smoothness of the positive electrode active material 100 can also be quantified from the ratio of an actual specific surface area SR measured by a constant-volume gas adsorption method to an ideal specific surface area Si.

The ideal specific surface area Si is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 that can be used in the battery 10 of one embodiment of the present invention, the ratio of the actual specific surface area S_{R} to the ideal specific surface area Sᵢ obtained from the median diameter D50 (S_{R}/Sᵢ) is preferably less than or equal to 2.1.

Alternatively, the level of the surface smoothness of the positive electrode active material 100 can be quantified from its cross-sectional SEM image by a method as described below.

First, a surface SEM image of the positive electrode active material 100 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value obtained by the quantification is referred to as a grayscale value. By obtaining such a grayscale value, the unevenness of the positive electrode active material can be evaluated quantitatively.

In addition, a variation in luminance in a target region can also be represented with a histogram. A histogram shows distribution of gradation levels in a target region three-dimensionally and is also referred to as a luminance histogram. A luminance histogram enables visually easy-to-understand evaluation of unevenness of the positive electrode active material.

In the case where the positive electrode active material 100 that can be used in the battery 10 of one embodiment of the present invention is evaluated, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

<Particle-Size Distribution Analysis with Cross-Sectional SEM Image of Positive Electrode>

The particle size distribution of the positive electrode active material 100 can also be calculated from the cross-sectional SEM image of the positive electrode active material 100 by the following method.

First, an analysis region is cut out from the obtained cross-sectional SEM image. For example, a sufficient area for image analysis can be, but not limited to, a range of 50 μm or larger×100 μm or larger. A smaller area or a larger area than the range may be cut out depending on factors such as the size of the positive electrode active material.

Note that a function of image processing software may be used to cut out the analysis region from the cross-sectional SEM image. For example, ImageJ may be used as the image processing software and an image may be cut out by Crop function of Image J.

Next, a first image cut out by the image processing software is binarized and subjected to particle analysis.

ImageJ can be used as image processing software, for example. The binarization process is described below. The first image represented by a 256-level grayscale is used as a frequency graph excluding black (a value of 0) and white (a value of 255). As the half width at half maximum (HWHM) of the maximum peak, HWHM on the low-level side (HWHM_L) and HWHM on the high-level side (HWHM_H) are obtained. Next, the minimum value a in a range that is twice HWHM_L on the low-level side and the maximum value b in a range that is twice HWHM_H on the high-level side are determined from the peak top (maximum frequency) of the maximum peak.

Next, binarization processing is performed as follows: the range of values less than a is white, the range of values from a to b, inclusive, is black, and the range of values greater than b is white. Specifically, the binarization as Threshold (a, b) is performed with Threshold function of ImageJ. After that, random bright spots that are probably attributed to the conductive material are removed under the conditions of Gray Morphology (radius=3, operator=open, type=circle) and Gray Morphology (radius=1, operator=close, type=circle), so that a second image can be obtained.

Next, particles with a particle size (the projected area) of 0.5 μm² to 700 μm² are detected in the second image with Analyze Particles function of ImageJ, whereby the area S of each particle is obtained. Next, the diameter r of each particle is calculated on the basis of the area S of each particle (Numerical Formula 1).

$$\begin{matrix}[ Numerical Formula 1 ] & \\ r = 2 \times \sqrt{( S / π )} & ( 1 )\end{matrix}$$

In this manner, the particle size distributions can each be calculated from the cross-sectional SEM image. The above analysis is referred to as particle size distribution analysis using a cross-sectional SEM image of a positive electrode.

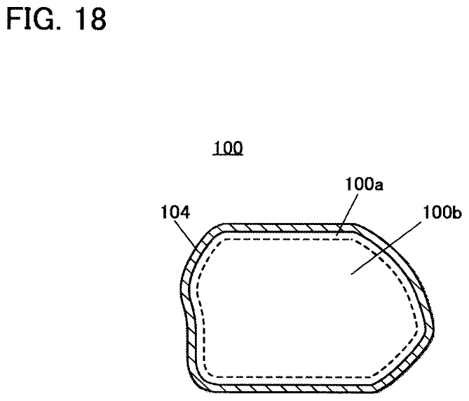

A coating portion may be attached to at least part of the surface of the positive electrode active material 100. FIG. 18 illustrates an example of the positive electrode active material 100 to which a coating portion 104 is attached.

The coating portion 104 is preferably formed by deposition of a decomposition product of an electrolyte and an organic electrolyte solution due to charge and discharge, for example. In particular, in the case of repetition of charge making x in LiₓCoO₂ be 0.24 or less and discharge, a coating portion originating from an electrolyte solution, which is formed on the surface of the positive electrode active material 100, is expected to improve charge and discharge cycle performance. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

### <<Powder Resistivity Measurement>>

The positive electrode active material 100 that can be used in the battery 10 of one embodiment of the present invention has a stable crystal structure even at a high voltage. The stable crystal structure of the positive electrode active material in a charged state can reduce a decrease in charge and discharge capacities due to repeated charge and discharge. In <<XRD>>, the positive electrode active material 100 having excellent characteristics as described above has a feature of having the O3′ type structure and/or the monoclinic O1 (15) type structure when x in LiₓCoO₂ is small. In <<EDX>>, the preferable distribution of the additive elements when the positive electrode active material 100 is subjected to the STEM-EDX analysis is described. Furthermore, the positive electrode active material 100 that can be used in the battery 10 of one embodiment of the present invention also has a feature in the volume resistivity of powder.

As the feature of the positive electrode active material 100 that can be used in the battery 10 of one embodiment of the present invention, the volume resistivity of the powder of the positive electrode active material 100 is preferably higher than or equal to 1.0×−10⁸ Ω·cm and lower than or equal to 1.0×10¹⁰ Ω·cm, further preferably higher than or equal to 5.0×10⁸ Ω·cm and lower than or equal to 1.5×10⁹ Ω·cm under a pressure of 64 MPa.

The positive electrode active material 100 with the above volume resistivity has a stable crystal structure at a high voltage. Thus, the volume resistivity of the powder of the positive electrode active material 100 falling within the above-described range can indicate the favorable formation of the surface portion 100a, which is an important factor for a stable crystal structure of the positive electrode active material in a charged state.

A method for measuring the volume resistivity of the powder of the positive electrode active material 100 that can be used in the battery 10 of one embodiment of the present invention is described.

A measurement instrument for the volume resistivity of the powder preferably includes a device portion including terminals for measuring resistance and a mechanism for applying pressure to powder serving as a measurement target. The terminals for measuring resistance are preferably four terminals (also referred to as four probes). As such a measurement instrument that includes the terminals for resistance measurement and the mechanism for applying pressure to the powder as a measurement target (sample), for example, MCP-PD51 (Mitsubishi Chemical Analytech Co., Ltd.) can be used. As the resistance measurement instrument, the low resistivity meter Loresta-GP or the high resistivity meter Hiresta-GP can be used. The Loresta-GP can be used for measurement of a low-resistant sample, and the Hiresta-GP can be used for measurement of a high-resistant sample. Note that the measurement environment is preferably a stable environment such as a dry room. An example of a preferable environment of the dry room is that the temperature is 25° C. and the dew point is lower than or equal to −40° C. When the measurement is performed under a high-humidity environment, the electric resistance may be lowered by the influence of moisture in the air, so that an original physical property value cannot be obtained in some cases.

The measurement of the volume resistivity of the powder using the above-described measurement instrument is described. First, a powder sample is set in the measurement unit. The measurement unit has a structure in which the powder sample and the terminals for measuring resistance are in contact with each other, and pressure can be applied to the powder sample. A structure for measuring the volume of a powder sample set in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of powder, the electric resistance and volume of the powder under pressure are measured. The pressure applied to the powder can be varied. For example, the electric resistance and volume of the powder can be measured under pressures of 16 MPa, 25 MPa, 38 MPa, 51 MPa, and 64 MPa. The volume resistivity of the powder can be calculated from the measured electric resistance and volume of the powder.

In the case where the above-described measurement is performed and the volume resistivity of the powder of the positive electrode active material 100 that can be used for the battery 10 of one embodiment of the present invention is higher than or equal to 1.0×10⁸ Ω·cm and lower than or equal to 1.0×10¹⁰ Ω·cm under the pressure of 64 MPa, good cycle performance is obtained in a charge-discharge cycle test under the high charge voltage condition, and better cycle performance is obtained in the charge-discharge cycle test under the high charge voltage condition in the case where the volume resistivity is higher than or equal to 5.0×10⁸ Ω·cm and lower than or equal to 1.5×10⁹ Ω·cm.

In this specification and the like, unless otherwise specified, the volume resistivity measured as described above is the volume resistivity of the powder.

### <<Ion Chromatography>>

A method for measuring ion chromatography of the powder of the positive electrode active material 100 that can be used for the battery 10 of one embodiment of the present invention is described. In the ion chromatography measurement, a pretreatment step of dissolving the powder of the positive electrode active material 100 in acid to obtain a measurement solution and a measurement step of measuring the solution are performed.

There is no particular limitation on the apparatus and conditions for ion chromatography. The measurement can be performed with the apparatus and conditions as described below, for example. As an apparatus for ion chromatography, an ion chromatography system Dionex ICS-2100 (Thermo Fisher Scientific Inc.) can be used, for example.

An example of the pretreatment of ion chromatography is described. Into a glass container with a lid, 250 mg of a powder of the positive electrode active material 100 and 2 ml of a 0.05 mol/L H₂SO₄ aqueous solution are put and mixed, whereby a first mixture solution is obtained. For the mixing, an ultrasonic wave is preferably applied for approximately 1 hour. After that, the container is left to stand at room temperature for 12 hours or longer. After that, 1 ml of a filtrate obtained by filtration of the first mixed solution and 9 ml of pure water are mixed, whereby a second mixed solution is obtained. In this manner, pretreatment of the powder of the positive electrode active material 100 can be performed.

Next, ion chromatography is performed using the second mixed solution obtained in the above pretreatment. Anion analysis and cation analysis are preferably performed in ion chromatography.

An example of the analysis conditions of anion is shown below. The anion analysis can be performed at 35° C. with the use of a Dionex IonPac AG20 column (2×50 mm) and a Dionex IonPac AS20 column (2×250 mm). The eluent is preferably a KOH aqueous solution and the flow rate is preferably 0.44 ml/min. Note that it is preferable to perform a gradient analysis where the concentration of the KOH aqueous solution gradually increases. A conductivity detector can be used as the detector. A calibration curve can be created with reference to an anion mixed standard solution (Kanto Chemical Co., Inc).

An example of the analysis conditions of cation is shown below. The cation analysis can be performed at 30° C. with the use of a Dionex IonPac CG16 column (3×50 mm) and a Dionex IonPac CS16 column (3×250 mm). The eluent is preferably an aqueous methanesulfonic acid (MSA) solution and the flow rate thereof is preferably 0.36 ml/min. Note that isocratic analysis is preferably performed with the concentration of the aqueous MSA solution kept constant. A conductivity detector can be used as the detector. A calibration curve can be created with reference to a cation mixed standard solution (Kanto Chemical Co., Inc).

The ion chromatography measurement described above allows quantitative measurement of fluorine (F), chlorine (Cl), or the like in the anion analysis, for example, and allows quantitative measurement of lithium (Li), magnesium (Mg), cobalt (Co), nickel (Ni), or the like in the cation analysis, for example.

In the ion chromatography measurement of the powder of the positive electrode active material 100 that can be used for the battery 10 of one embodiment of the present invention, the weight of fluorine is preferably greater than or equal to 100 ppm and less than or equal to 1000 ppm, further preferably greater than or equal to 100 ppm and less than or equal to 200 ppm with respect to the weight of the powder.

This embodiment can be implemented in combination with any of the other embodiments.

### Embodiment 3

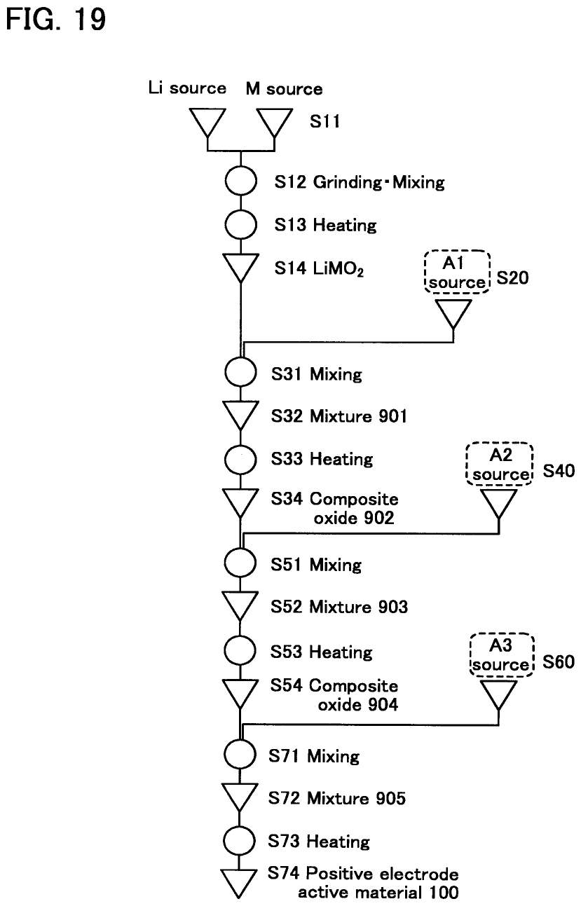

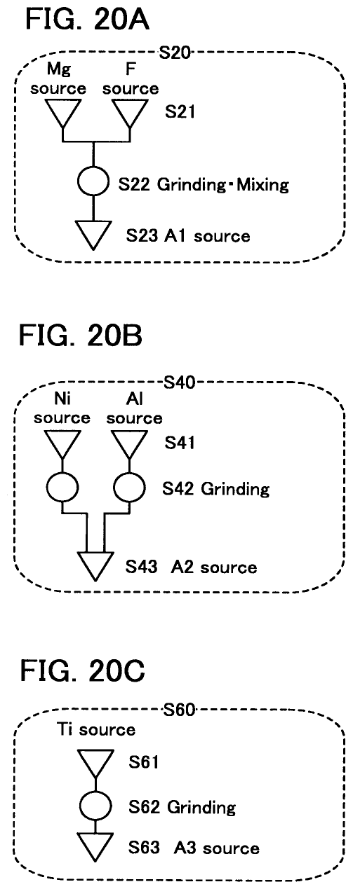

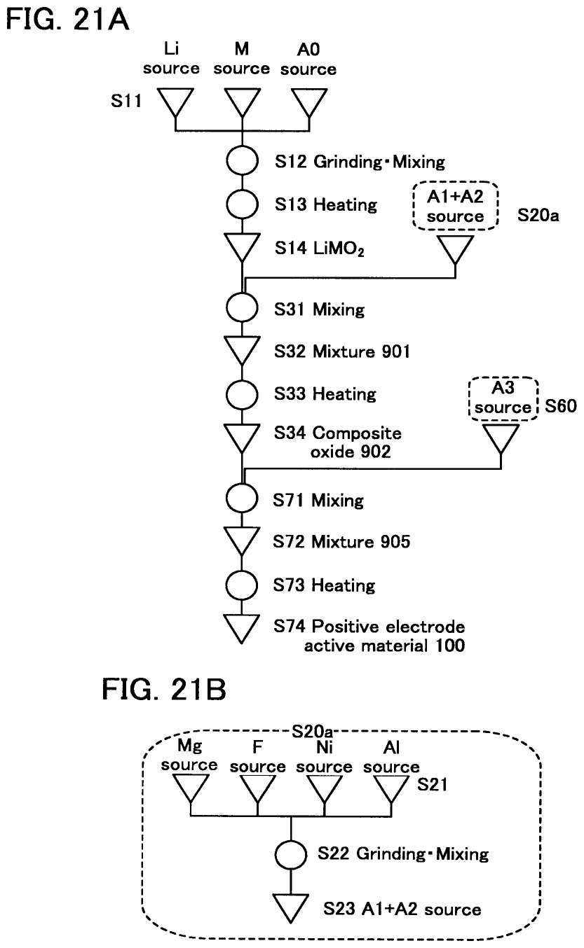

This embodiment will describe an example of a manufacturing method of a positive electrode active material 100 that can be used in the battery 10 of one embodiment of the present invention with reference to FIG. 19, FIGS. 20A to 20C, and FIGS. 21A and 21B.

A way of adding an additive element is important in forming the positive electrode active material 100 having the distribution of the additive element, the composition, and/or the crystal structure described in the above embodiment. Favorable crystallinity of the inner portion 100b is also important.

Thus, in the formation process of the positive electrode active material 100, preferably, lithium cobalt oxide is synthesized first, then an additive element source is mixed, and heat treatment is performed.

In a method of synthesizing lithium cobalt oxide containing an additive element by mixing an additive element source concurrently with a cobalt source and a lithium source, it is sometimes difficult to increase the concentration of the additive element in the surface portion 100a. In addition, after lithium cobalt oxide is synthesized, only mixing an additive element source without performing heating causes the additive element to be just attached to, not solid-soluted in, the lithium cobalt oxide. It is difficult to distribute the additive element favorably without sufficient heating. Therefore, it is preferable that lithium cobalt oxide be synthesized, and then an additive element source be mixed and heat treatment be performed. The heat treatment after mixing of the additive element source may be referred to as annealing.

However, annealing at an excessively high temperature may cause cation mixing, which increases the possibility of entry of the additive element such as magnesium into the cobalt sites. Magnesium that has entered at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. Lowering the melting points makes it easier to distribute the additive element favorably at a temperature at which cation mixing is less likely to occur.

### <<Formation Method 1 of Positive Electrode Active Material>>

A formation method 1 of the positive electrode active material 100 is described with reference to FIG. 19 and FIGS. 20A to 20C.

### <Step S11>

In Step S11 shown in FIG. 19, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide such as tricobalt tetroxide, cobalt hydroxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be provided.

Furthermore, the cobalt source preferably has high crystallinity and for example, the cobalt source preferably includes single crystal grains. The crystallinity of the cobalt source can be evaluated with a TEM image, an STEM image, a HAADF-STEM image, or an ABF-STEM image or by XRD, electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 19, the lithium source and the cobalt source are ground and mixed to form a mixed material. The grinding and mixing can be performed by a dry method or a wet method. A wet method is preferable because it can crush a material into a smaller size. In the case of a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the circumferential speed is preferably higher than or equal to 100 mm/s and lower than or equal to 2000 mm/s in order to inhibit contamination from the medium. In this embodiment, the grinding and mixing are performed at a circumferential speed of 838 mm/s (the number of rotations: 400 rpm, the ball mill diameter: 40 mm).

### <Step S13>

Next, in Step S13 shown in FIG. 19, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature may lead to insufficient decomposition and melting of the lithium source and the cobalt source. An excessively high temperature may lead to a defect due to evaporation of lithium from the lithium source and/or excessive reduction of cobalt, for example. An oxygen vacancy or the like may be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that may enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flow”.

In the case where the heating atmosphere is an oxygen-containing atmosphere, flow is not necessarily performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool down, and the time for temperature falling to a room temperature from a predetermined temperature is preferably longer than or equal to 10 hours and shorter than or equal to 50 hours. Note that the temperature does not necessarily need to fall to the room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization of a material can be prevented.

A crucible that has been used a plurality of times is preferred to a new crucible. In this specification and the like, a new crucible refers to a crucible that is subjected to heating two or less times while a material containing lithium, the transition metal M_{T}, and/or the additive element is contained therein. A crucible that has been used a plurality of times refers to a crucible that is subjected to heating three or more times while a material containing lithium, the transition metal M, and/or the additive element is contained therein. In the case where a new crucible is used, some materials such as lithium fluoride are liable to be absorbed by, diffused in, transferred to, and/or attached to a sagger. Loss of some materials due to such phenomena increases a concern that an element is not distributed in a preferable range particularly in the surface portion of the positive electrode active material. In contrast, such a risk is low in the case of a crucible that has been used a plurality of times.

The heated material is ground as needed and may be made to pass through a sieve. The collection of the heated material may be performed after the material is moved from the crucible to a mortar. As the mortar, an aluminum oxide mortar is preferably used. An aluminum oxide mortar is made of a material that hardly releases impurities. Specifically, a mortar made of aluminum oxide with a purity higher than or equal to 90%, preferably higher than or equal to 99% is used. Note that heating conditions similar to those in Step S13 can be employed in a later-described heating step other than Step S13.

### <Step S14>

Through the above steps, lithium cobalt oxide (LiCoO₂) can be synthesized as Step S14 in FIG. 19.

Although the example is described in which the composite oxide is formed by a solid phase method as in Steps S11 to S14, the composite oxide may be formed by a coprecipitation method. Alternatively, the composite oxide may be formed by a hydrothermal method.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive elements are preferably added to the lithium cobalt oxide. Because the formation method of the positive electrode active material described in this embodiment can separate addition of the additive elements into a plurality of steps, in the flowchart illustrated in FIG. 19, the additive element to be added first is described as A1, the additive element to be added second is referred to as A2, and the additive element to be added third is referred to as A3. The step of adding the additive element A1 is described with reference to FIG. 20A.

### <Step S21>

In Step S21 shown in FIG. 20A, an additive element source (A1 source) to be added to the lithium cobalt oxide is prepared. A lithium source may be prepared in addition to the A1 source.

As the additive element A1, any of the additive elements described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used also as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), nitrogen trifluoride (NF₃), or the like may be used and mixed in the atmosphere in a heating step described later. Two or more of these fluorine sources may be used.

In Formation method 1 of positive electrode active material described with reference to FIG. 19 and FIGS. 20A to 20C, magnesium and fluorine are used as the additive element A1. Lithium fluoride (LiF) is prepared as the fluorine source, and magnesium fluoride (MgF₂) is prepared as the fluorine source and the magnesium source. When lithium fluoride and magnesium fluoride are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or the vicinity thereof). Note that in this specification and the like, “a vicinity of a given value” means a value greater than 0.9 times and less than 1.1 times the given value.

### <Step S22>

Next, in Step S22 shown in FIG. 20A, the magnesium source and the fluorine source are ground and mixed. Any of the conditions for the grinding and mixing that are described for Step S12 can be selected to perform Step S22.

### <Step S23>

Next, in Step S23 shown in FIG. 20A, the materials ground and mixed in the above step are collected to give the A1 source. Note that the additive element A1 source in Step S23 contains a plurality of starting materials and can be referred to as a mixture.

As for the particle diameter of the mixture, its D50 (median diameter) is preferably greater than or equal to 600 nm and less than or equal to 10 μm, further preferably greater than or equal to 1 μm and less than or equal to 5 μm. Also when one kind of material is used as the additive element source, the D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion 100a of the composite oxide after heating.

### <Step S31>

Next, in Step S31 shown in FIG. 19, the lithium cobalt oxide and the A1 source are mixed. The ratio of the number of cobalt (Co) atoms in the lithium cobalt oxide to the number of magnesium (Mg) atoms in the A1 source (Co: Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 19, the materials mixed in the above step are collected, whereby a mixture 901 is obtained. At the time of the collection, the materials may be crushed and made to pass through a sieve as needed.

### <Step S33>

Then, in Step S33 shown in FIG. 19, the mixture 901 is heated. Any of the heating conditions described for Step S13 can be selected. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d} that is 0.757 times the melting temperature Tₘ. Accordingly, the heating temperature in Step S33 may be higher than or equal to 650° C.

Needless to say, the reaction more easily proceeds at a temperature higher than or equal to the temperature at which one or more of the materials contained in the mixture 901 are melted. For example, in the case where LiF and MgF₂ are used as the additive element sources, the lower limit of the heating temperature in Step S33 is preferably higher than or equal to 742° C. because the eutectic point of LiF and MgF₂ is around 742° C.

The mixture 901 in which LiCoO₂, LiF, and MgF₂ are mixed at the molar ratio of 100:0.33:1 exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At a temperature in the vicinity of the decomposition temperature, a slight amount of the lithium cobalt oxide might be decomposed. Thus, the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 901, the partial pressure of fluorine or a fluoride originating from the fluorine source or the like is preferably controlled to be within an appropriate range.

In the formation method described in this embodiment, one or some of the materials, e.g., LiF as the fluorine source, function as a fusing agent in some cases. Owing to the material functioning as a fusing agent, the heating temperature can be lowered to a temperature below the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 901 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 901 is preferably heated in an atmosphere containing LiF, i.e., the mixture 901 is preferably heated in a state where the partial pressure of LiF in the heating furnace is high. Such heating can inhibit volatilization of LiF in the mixture 901.

The heating in this step is preferably performed in a manner that can prevent the particles of the mixture 901 from being adhered to each other. Adhesion of the particles of the mixture 901 during the heating might decrease the area of contact with oxygen in the atmosphere and block a path of diffusion of the additive element (e.g., fluorine), thereby hindering distribution of the additive element (e.g., magnesium and fluorine) in the surface portion.

It is contemplated that uniform distribution of the additive element (e.g., fluorine) in the surface portion leads to a smooth positive electrode active material with little unevenness. Thus, it is preferable that the particles of the mixture 901 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flow of an atmosphere is preferably performed after an atmosphere is purged first and an oxygen atmosphere is introduced into the kiln. Oxygen flow, which might cause evaporation of the fluorine source, is not preferable for maintaining the smoothness of the surface.

In the case of using a roller hearth kiln for the heating, the mixture 901 can be heated in an atmosphere containing LiF with the container in which the mixture 901 is put covered with a lid.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

In the case where the lithium cobalt oxide in Step S14 in FIG. 19 has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 7 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 19, in which crushing is performed as needed; thus, a composite oxide 902 is obtained. Note that in this formation method, the composite oxide 902 can be referred to as lithium cobalt oxide to which magnesium is added or lithium cobalt oxide to which magnesium and fluorine are added. That is, it is acceptable that the steps in and after Step S40 are not performed, in which case the composite oxide 902 may be used as the positive electrode active material 100 of the battery 10.

### <Step S40>

In Step S40 shown in FIG. 19, an additive element source (A2 source) is used. As the additive element A2, any of the additive elements mentioned in description of Step S21 can be used. In Formation method 1 of positive electrode active material described with reference to FIG. 19 and FIGS. 20A to 20C, nickel and aluminum are used as the additive element A2. As the nickel source, nickel oxide, nickel hydroxide, or the like can be used. As the aluminum source, aluminum oxide, aluminum hydroxide, or the like can be used. As shown in Steps S41 to S43 in FIG. 20B, the nickel source and the aluminum source can be ground to serve as the A2 source. For the conditions of grinding, the description of Step S22 can be referred to.

### <Step S51>

Next, in Step S51 shown in FIG. 19, the composite oxide 902 and the A2 source are mixed. For the mixing conditions, the description of Step S31 can be referred to.

### <Step S52>

Next, in Step S52 in FIG. 19, the materials mixed in the above step are collected, whereby a mixture 903 is obtained. At the time of the collection, the materials may be crushed and made to pass through a sieve as needed.

### <Step S53>

Then, in Step S53 shown in FIG. 19, the mixture 903 is heated. For the heating conditions, the description of Step S33 can be referred to.

### <Step S54>

Next, the heated material is collected in Step S54 shown in FIG. 19, in which crushing is performed as needed; thus, a composite oxide 904 is obtained. Note that in this formation method, the composite oxide 904 can be referred to as lithium cobalt oxide to which magnesium, nickel, and aluminum are added or lithium cobalt oxide to which magnesium, fluorine, nickel, and aluminum are added. That is, it is acceptable that the steps in and after Step S60 are not performed, in which case the composite oxide 904 may be used as the positive electrode active material 100 of the battery 10.

### <Step S60>

Next, in Step S60 shown in FIG. 19, an additive element source (A3 source) is used. As the additive element A3, any of the additive elements mentioned in description of Step S21 can be used. In Formation method 1 of positive electrode active material described with reference to FIG. 19 and FIGS. 20A to 20C, titanium is used as the additive element A3. As a titanium source, lithium titanate, titanium oxide, titanium hydroxide, or the like can be used. As shown in Step S61 to Step S63 in FIG. 20C, the titanium source can be ground to serve as the A3 source. For the grinding conditions, the description of Step S22 can be referred to.

### <Step S71>

In Step S71 shown in FIG. 19, the composite oxide 904 and the A3 source are mixed. For the mixing conditions, the description of Step S31 can be referred to.

### <Step S72>

Next, in Step S72 in FIG. 19, the materials mixed in the above step are collected, whereby a mixture 905 is obtained. At the time of the collection, the materials may be crushed and made to pass through a sieve as needed.

### <Step S73>

Then, in Step S73 shown in FIG. 19, the mixture 905 is heated. For the heating conditions, the description of Step S33 can be referred to.

### <Step S74>

Next, the heated material is collected in Step S74 shown in FIG. 19, in which crushing is performed as needed; thus, the positive electrode active material 100 is obtained. Here, the collected particles are preferably made to pass through a sieve. Through the above process, the positive electrode active material 100 that can be used for the battery 10 of one embodiment of the present invention can be formed. The positive electrode active material of one embodiment of the present invention has a smooth surface.

The positive electrode active material 100 with a smooth surface may be less likely to be physically broken by pressure application or the like than a positive electrode active material without a smooth surface. For example, the positive electrode active material 100 is unlikely to be broken in a test involving pressure application such as a nail penetration test, meaning that the positive electrode active material 100 has high safety.

### [Initial Heating]

In the manufacturing method described above, heat treatment is further preferably performed between the synthesis of the lithium cobalt oxide and the mixing of the additive element in some cases. This heating is referred to as initial heating.

Since lithium is extracted from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is easy to diffuse into the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, Me-O distance is 2.09 (×10⁻¹⁰ m) and 2.11 (×10⁻¹⁰ m) in Ni_{0.5}Mg_{0.5}O having a rock-salt crystal structure and MgO having a rock-salt crystal structure, respectively. Even when a spinel phase is formed in part of the surface portion 100a, Me-O distance is 2.0125 (×10⁻¹⁰ m) and 2.02 (×10⁻¹⁰ m) in NiAl₂O₄ having a spinel structure and MgAl₂O₄ having a spinel structure, respectively. In each case, Me-O distance is longer than 2 (×10⁻¹⁰ m).

Meanwhile, in a layered rock-salt crystal structure, the bond distance between oxygen and a metal other than lithium is shorter than the above-described distance. For example, Al—O distance is 1.905 (×10⁻¹⁰ m) (Li—O distance is 2.11 (×10⁻¹⁰ m) in LiAlO₂ having a layered rock-salt crystal structure. In addition, Co—O distance is 1.9224 (×10⁻¹⁰ m) (Li—O distance is 2.0916 (×10⁻¹⁰ m) in LiCoO₂ having a layered rock-salt crystal structure.

According to Shannon's ionic radii, the ion radius of hexacoordinated aluminum and the ion radius of hexacoordinated oxygen are 0.535 (×10⁻¹⁰ m) and 1.4 (×10⁻¹⁰ m), respectively, and the sum of these values is 1.935 (×10⁻¹⁰ m).

From the above, aluminum is considered to be stable at sites other than lithium sites more in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface,

Moreover, the initial heating is expected to increase the crystallinity of the layered rock-salt crystal structure of the inner portion 100b.

However, the initial heating is not necessarily performed. In some cases, by controlling the atmosphere, temperature, time, or the like in another heating step, e.g., annealing, the positive electrode active material 100 that has the O3′ type structure when x in LiₓCoO₂ is small can be formed.

### <<Formation Method 2 of Positive Electrode Active Material>>

Next, as one embodiment of the present invention, Formation method 2 of positive electrode active material, which is different from Formation method 1 of positive electrode active material, is described with reference to FIGS. 21A and 21B. Formation method 2 of positive electrode active material is different from Formation method 1 mainly in the number of times of adding additive elements. For the description except for the above, the description of Formation method 1 of positive electrode active material can be referred to.

Formation method 1 of positive electrode active material has described the formation method in which the addition of the additive element is performed only after formation of LiM_{T}O₂, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. The additive element source added at this time is shown as an AO source in FIG. 21A. Then, lithium cobalt oxide containing the additive element can be obtained in Step S13. In that case, there is no need to separately perform Steps S11 to S14 and Steps S21 to S23, so that the method is simplified and enables increased productivity.

Alternatively, lithium cobalt oxide that contains one or some of the additive elements in advance may be used. When lithium cobalt oxide to which magnesium and fluorine are added is used, for example, Steps S11 to S14 and one or some steps of Step S20 can be skipped, so that the method is simplified and enables increased productivity.

In addition, the additive element may be added to lithium cobalt oxide to which magnesium and fluorine are added in advance.

Formation method 1 of positive electrode active material has described that magnesium and fluorine are used as the additive element A1 and nickel and aluminum are used as the additive element A2 and the elements are added at different timings; however, magnesium, fluorine, nickel, and aluminum may be added at the same time. FIGS. 21A and 21B illustrate a method for adding magnesium, fluorine, nickel, and aluminum at the same time as Step S20a. This formation method can also be regarded as being simple and highly productive because the number of mixing and heating steps can be reduced.

This embodiment can be implemented in combination with any of the other embodiments.

### Embodiment 4

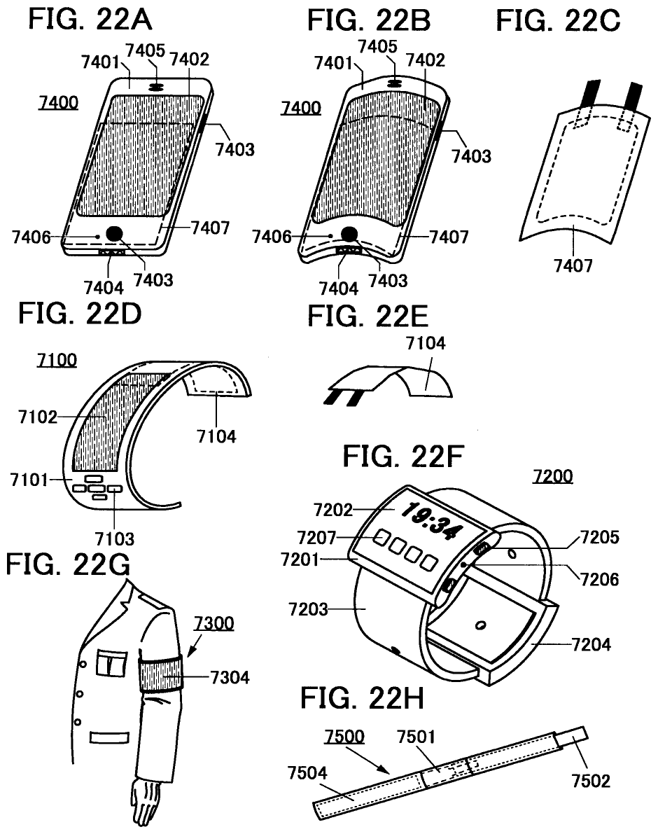

In this embodiment, examples of electronic devices each including the secondary battery of one embodiment of the present invention are described with reference to FIGS. 22A to 22H, FIGS. 23A to 23D, and FIGS. 24A to 24C.

FIGS. 22A to 22G show examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 22A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 22B illustrates the mobile phone 7400 in a state of being bent. When the whole mobile phone 7400 is bent by the external force, the secondary battery 7407 included in the mobile phone 7400 is also bent. FIG. 22C illustrates the secondary battery 7407 that is being bent in that state. The secondary battery 7407 is a thin storage battery. The secondary battery 7407 is fixed in a state of being bent. The secondary battery 7407 includes a lead electrode electrically connected to a current collector.

FIG. 22D illustrates an example of a bangle-type display device. A portable display device 7100 includes a housing 7101, a display portion 7102, operation buttons 7103, and a secondary battery 7104. FIG. 22E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm, both inclusive. When the radius of curvature of the main surface of the secondary battery 7104 ranges from 40 mm to 150 mm, both inclusive, the reliability can be kept high. By using the secondary battery of one embodiment of the present invention as the secondary battery 7104, a lightweight long-life portable display device can be provided.

FIG. 22F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, hands-free calling is possible with mutual communication between the portable information terminal 7200 and a headset capable of wireless communication.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless charge without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 22E that is in the state of being curved can be provided in the housing 7201. Alternatively, the secondary battery 7104 in FIG. 22E can be provided in the band 7203 such that it can be curved.

The portable information terminal 7200 preferably includes a sensor. As the sensor, a human body sensor such as a fingerprint sensor, a pulse sensor, or a temperature sensor; a touch sensor; a pressure sensitive sensor; or an acceleration sensor is preferably mounted, for example.

FIG. 22G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charge operation may be performed by wireless charge without using the input/output terminal.

By using the secondary battery of one embodiment of the present invention as the secondary battery included in the display device 7300, a lightweight long-life display device can be provided.

An example of an electronic device including the secondary battery with excellent cycle performance described in the above embodiment is described with reference to FIG. 22H.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high discharge capacity are desired in consideration of handling ease for users.

FIG. 22H is a perspective view of a device called a vaporizer (electronic cigarette). In FIG. 22H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 22H includes an external terminal for connection to a charger. When the electronic cigarette 7500 is held by a user, the secondary battery 7504 is at the tip of the device; thus, it is preferable that the secondary battery 7504 have a short total length and be lightweight. With the secondary battery of one embodiment of the present invention, which has high discharge capacity and excellent cycle performance, the small, lightweight, and long-term usable electronic cigarette 7500 that can be used for long hours can be provided.

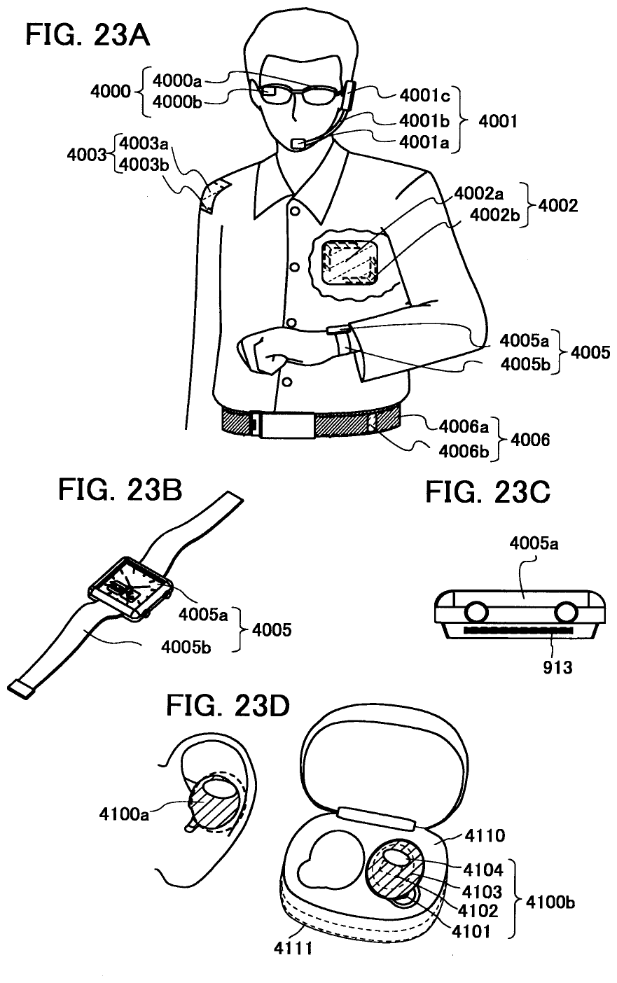

FIG. 23A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 23A. The glasses-type device 4000 includes a frame 4000a and a display part 4000b. The secondary battery is provided in a temple of the frame 4000a having a curved shape, whereby the glasses-type device 4000 can be lightweight and can have a well-balanced weight and a long continuous use time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone unit 4001a, a flexible pipe 4001b, and an earphone unit 4001c. The secondary battery can be provided in the flexible pipe 4001b and/or the earphone unit 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 23B is a perspective view of the watch-type device 4005 that is detached from an arm.

FIG. 23C is a side view illustrating a state where the secondary battery 913 is incorporated in the watch-type device 4005. The secondary battery 913 is the secondary battery described in the above embodiment. The secondary battery 913, which is small and lightweight, is provided at a position overlapping with the display portion 4005a.

FIG. 23D illustrates an example of wireless earphones. The wireless earphones shown as an example consist of, but not limited to, a pair of earphone bodies 4100a and 4100b.

The earphone bodies 4100a and 4100b include a driver unit 4101, an antenna 4102, and a secondary battery 4103. The earphone bodies 4100a and 4100b may also include a display portion 4104. Moreover, the earphone bodies 4100a and 4100b preferably include a substrate where a circuit such as a wireless IC is provided, a terminal for charge, and the like. The earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, a coin-type secondary battery or a cylindrical secondary battery can be used for example. A secondary battery whose positive electrode includes the positive electrode active material 100 obtained in Embodiment 2 or 3 has a high energy density; thus, with the use of the secondary battery as the secondary battery 4103 and the secondary battery 4111, space saving required with downsizing of the wireless earphones can be achieved.

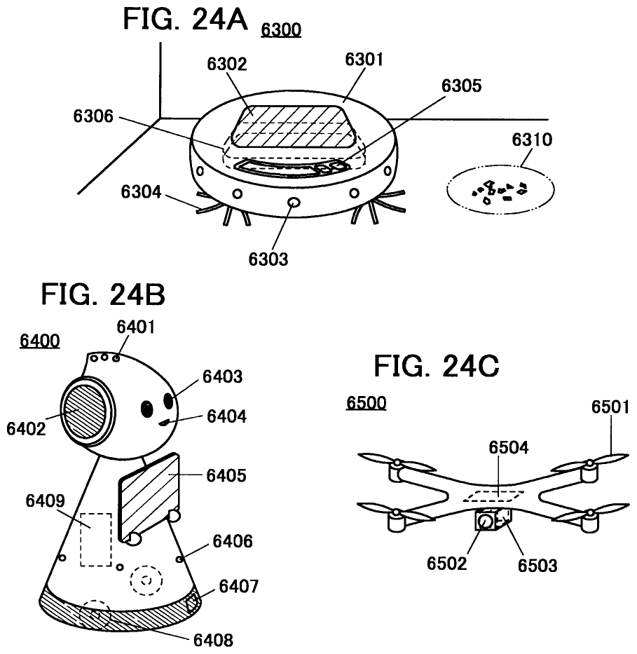

FIG. 24A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 24B illustrates an example of a robot. A robot 6400 illustrated in FIG. 24B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 24C illustrates an example of a flying object. A flying object 6500 illustrated in FIG. 24C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 5

In this embodiment, examples of vehicles each including the secondary battery containing a positive electrode active material of one embodiment of the present invention are described.

The use of secondary batteries in vehicles enables production of next-generation clean energy vehicles such as hybrid vehicles (HV), electric vehicles (EV), and plug-in hybrid vehicles (PHV).

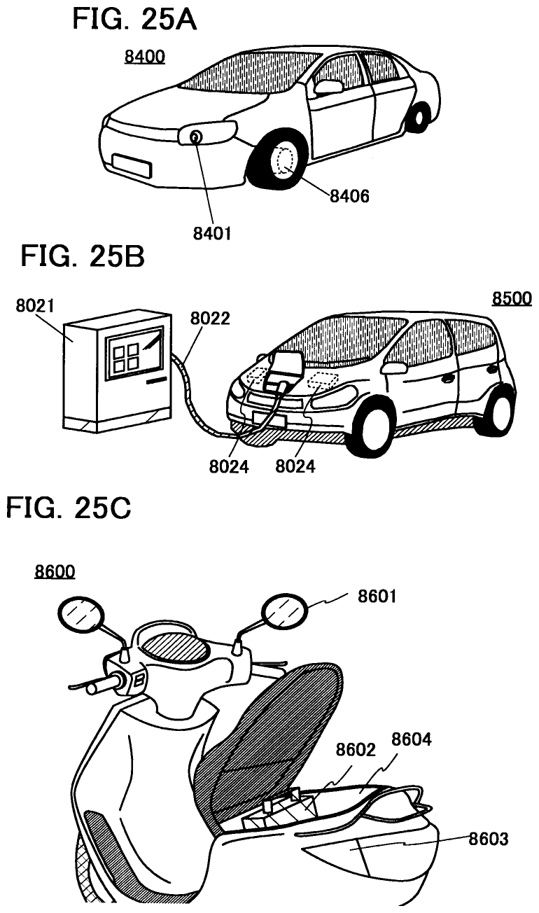

FIGS. 25A to 25C illustrate examples of vehicles each including the secondary battery of one embodiment of the present invention. An automobile 8400 illustrated in FIG. 25A is an electric vehicle that runs on the power of an electric motor. Alternatively, the automobile 8400 is a hybrid vehicle capable of driving using an electric motor or an engine as appropriate. The use of one embodiment of the present invention allows fabrication of a high-mileage vehicle. The automobile 8400 includes the secondary battery. For example, the modules of the secondary battery can be arranged in a floor portion in the automobile to be used. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 25B illustrates an automobile 8500 including the secondary battery. The automobile 8500 can be charged when the secondary battery is supplied with electric power from external charging equipment by a plug-in system and/or a contactless power feeding system, for example. In FIG. 25B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charge method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from the outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 25C illustrates an example of a motorcycle including the secondary battery of one embodiment of the present invention. A motor scooter 8600 illustrated in FIG. 25C includes a secondary battery 8602, side mirrors 8601, and indicators 8603. The secondary battery 8602 can supply electric power to the indicators 8603.

In the motor scooter 8600 illustrated in FIG. 25C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors and charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Embodiment 6

In this embodiment, examples of space equipment including the secondary battery of one embodiment of the present invention are described.

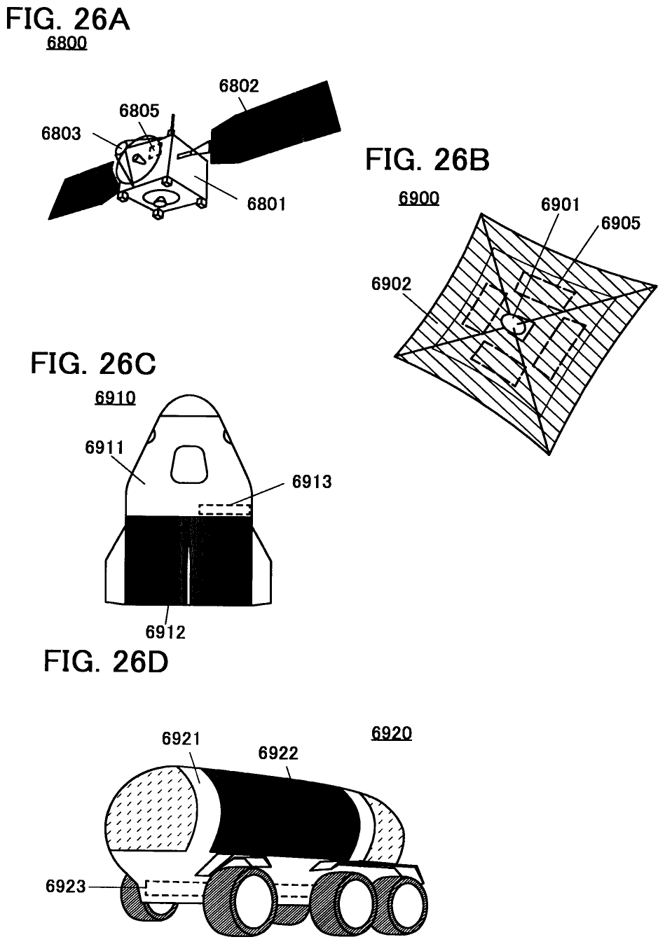

FIG. 26A illustrates an artificial satellite 6800 as an example of space equipment. The artificial satellite 6800 includes an artificial satellite body 6801, a solar panel 6802, an antenna 6803, and a secondary battery 6805. Such a solar panel is referred to as a solar cell module in some cases.

When the solar panel 6802 is illuminated by sunlight, electric power required for operation of the artificial satellite 6800 is generated. However, for example, in the situation where the solar panel is not illuminated by sunlight or the situation where the solar panel is illuminated with a slight amount of sunlight, the amount of generated electric power is small. Accordingly, a sufficient amount of electric power required for operation of the artificial satellite 6800 may be difficult to generate. In order to operate the artificial satellite 6800 even with a small amount of generated electric power, the artificial satellite 6800 is preferably provided with the secondary battery 6805. The positive electrode active material of the present invention is used in the secondary battery, whereby the secondary battery can have high discharge capacity and excellent cycle performance.

The artificial satellite 6800 can generate a signal. The signal is transmitted through the antenna 6803, and can be received by a ground-based receiver or another artificial satellite, for example. When the signal transmitted by the artificial satellite 6800 is received, the position of a receiver that receives the signal can be measured. Thus, the artificial satellite 6800 can make up part of a satellite positioning system.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 26B illustrates a probe 6900 including a solar sail as an example of space equipment. The probe 6900 includes a probe body 6901, a solar sail 6902, and a secondary battery 6905. The positive electrode active material of the present invention is used in the secondary battery, whereby the secondary battery can have high discharge capacity and excellent cycle performance. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed such that the solar sail 6902 is furled in a small size until it goes beyond the earth's atmosphere, and is unfurled to have a large sheet-like shape as illustrated in FIG. 26B in the space beyond the earth's atmosphere (outer space).

FIG. 26C illustrates a spacecraft 6910 as an example of space equipment. The spacecraft 6910 includes a spacecraft body 6911, a solar panel 6912, and a secondary battery 6913. The positive electrode active material of the present invention is used in the secondary battery, whereby the secondary battery can have high discharge capacity and excellent cycle performance. The spacecraft body 6911 can include a pressurized cabin and an unpressurized cabin, for example. The pressurized cabin may be designed so that the crew can get into the cabin. Electric power that is generated by illumination of sunlight on the solar panel 6912 can be stored in the secondary battery 6913.

FIG. 26D illustrates a rover 6920 as an example of space equipment. The rover 6920 includes a rover body 6921 and a secondary battery 6923. The positive electrode active material of the present invention is used in the secondary battery, whereby the secondary battery can have high discharge capacity and excellent cycle performance. The rover 6920 may include a solar panel 6922.

The rover 6920 may be designed so that the crew can get into the rover. Electric power that is generated by illumination of sunlight on the solar panel 6912 may be stored in the secondary battery 6923, or electric power generated by another power source such as a fuel cell or a radioisotope thermoelectric generator, for example, may be stored in the secondary battery 6923.

This embodiment can be combined with any of the contents in the other embodiments as appropriate.

### Example

In this example, the lithium ion battery described in Embodiments or the like was formed and battery characteristics of the battery were measured. The measurement result is shown below.

### <Fabrication of Electrode>

Crystalline carbon, specifically spherical natural graphite (FormulaBT 1520 produced by Superior Graphite, an average particle diameter of 20 μm) was prepared as an active material. SBR and CMC-Na were prepared as a binder and a thickener, respectively. Carbon fiber (VGCF (registered trademark) produced by Showa Denko) was prepared as a conductive material. Then, spherical natural graphite, VGCF, CMC-Na, and SBR were mixed at the weight ratio of 97:1:1:1 to obtain a slurry. As a solvent of the slurry, water was used.

After a current collector was coated with the slurry, the solvent was volatilized. Through the above steps, an electrode was obtained. In the electrode, the loading level of the active material in the electrode was approximately 7.5 mg/cm². The electrode was circular with a diameter of 12 mm.

### <Electrolyte Solution>

As the electrolyte solution, LiPF₆ and KFSI were dissolved in a mixed solvent containing FEC and MTFP at a volume ratio of 20:80 (FEC/MTFP mixed solvent). Here, LiPF₆ was dissolved at 1 mol/L in the FEC/MTFP mixed solvent. KFSI was dissolved at 0.2 mol/L in the FEC/MTFP mixed solvent containing LiPF₆. With use of the mixed solvent, an electrolyte solution was prepared in this manner. Note that no additive agent was used.

### <Fabrication of Coin Cell>

The coin cell was fabricated using the electrode, lithium metal foil, a separator, the electrolyte solution, a coin cell positive electrode can, and a coin cell negative electrode can. The coin cell had a size of 2032 (a diameter of 20 mm and a thickness of 3.2 mm). Note that a cell including lithium metal foil in a negative electrode as described above is also referred to as a half cell.

As a separator, a porous polyimide film was used. Three 23-μm-thick polyimide films were stacked and placed as a separator between the electrode and the lithium metal foil.

### <Initial Charge>

Discharge and charge at 25° C. were performed as initial charge (aging). As discharge, constant current discharge (CC discharge) was performed at a current of 0.1 C until the voltage of the coin cell reached 0.01 V, and then constant voltage discharge (CV discharge) was performed until the current reached 0.01 C. As charge, constant current charge was performed at a current of 0.1 C until the voltage of the coin cell reached 1.00 V. In this example, 1 C was set to 372 mA per weight of the active material (1 C=372 mA/g).

### <Measurement of Temperature Characteristics>

The temperature characteristics in discharge and charge of the coin cell after the initial charge were measured.

The discharge conditions were as follows: constant current discharge was performed at a current of 0.1 C until the voltage of the coin cell reached 0.01 V, and then constant voltage discharge was performed until the current reached 0.01 C. Constant current charge was performed at a current of 0.1 C until the voltage of the coin cell reached 1.00 V.

The discharge temperature characteristics and the charge temperature characteristics were measured. The temperature of the measurement environment and the measurement order are described.

### [Discharge Temperature Characteristics]

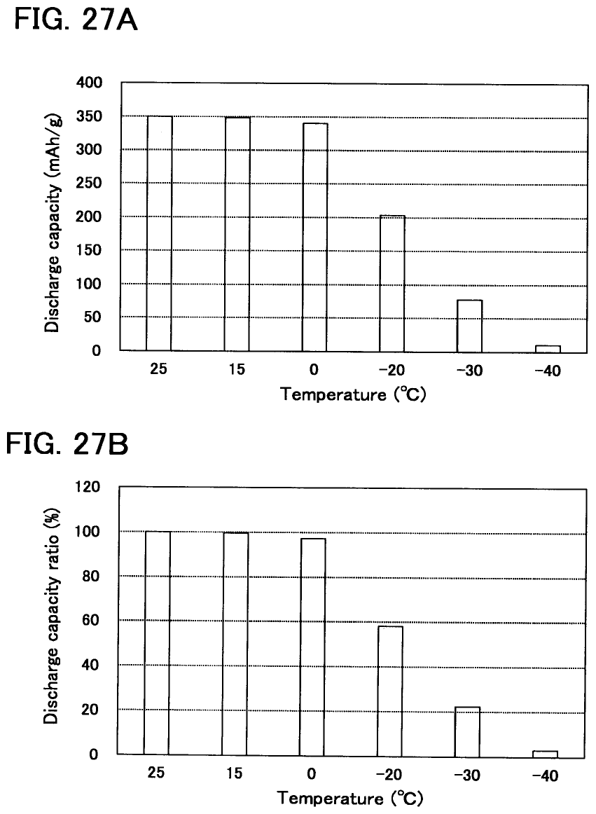

The measurement conditions of the discharge temperature characteristics are described. The conditions for discharging and charging are as described above. The temperature of the measurement environment and the measurement order were as follows: 25° C. discharge, 25° C. charge, 15° C. discharge, 25° C. charge, 0° C. discharge, 25° C. charge, −20° C. discharge, 25° C. charge, −30° C. discharge, 25° C. charge, −40° C. discharge, and 25° C. charge. FIG. 27A shows the discharge capacity at each temperature, and FIG. 27B shows the discharge capacity ratio. Table 8 shows the discharge capacity, the charge capacity, and the discharge capacity ratio. Note that the discharge capacity and the charge capacity are each capacity per weight of the active material, and the discharge capacity ratio is expressed in percentage of the discharge capacity at each temperature with respect to the discharge capacity at 25° C.

TABLE 8

| | Discharge | Charge | Discharge |
|---|---|---|---|
| Temperature | capacity | capacity | capacity |
| [° C.] | [mAh/g] | [mAh/g] | ratio [%] |
| 25 | 350.07 | 354.01 | 100.00 |
| 15 | 348.47 | 350.19 | 99.54 |
| 0 | 340.28 | 341.37 | 97.20 |
| −20 | 203.14 | 203.12 | 58.03 |
| −30 | 78.15 | 78.20 | 22.32 |
| −40 | 10.77 | 10.78 | 3.08 |

### [Charge Temperature Characteristics]

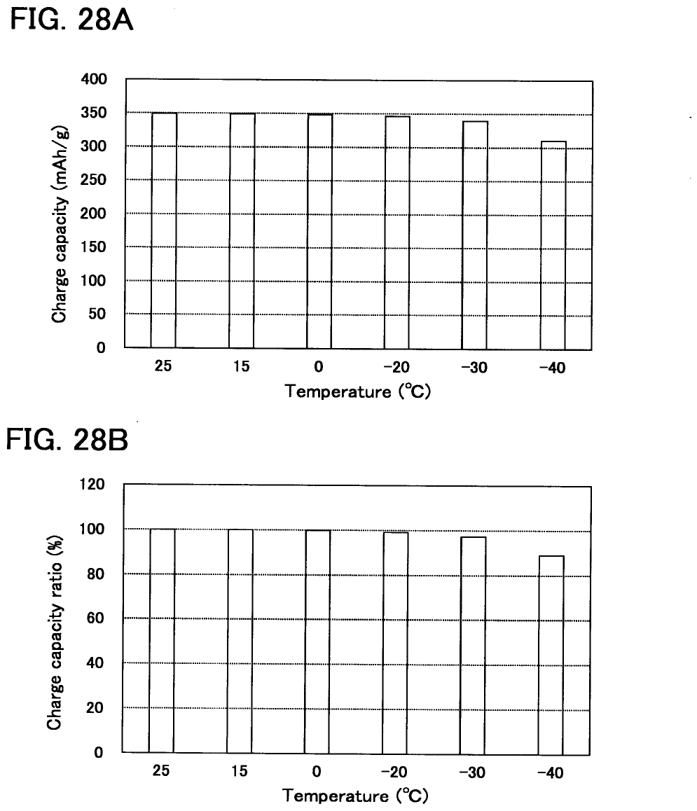

The measurement conditions of the charge temperature characteristics are described. The conditions for discharge and charge are as described above. The temperature of the measurement environment and the measurement order were as follows: 25° C. discharge, 25° C. charge, 25° C. discharge, 15° C. charge, 25° C. discharge, 0° C. charge, 25° C. discharge, −20° C. charge, 25° C. discharge, −30° C. charge, 25° C. discharge, and −40° C. charge. FIG. 28A shows the charge capacity at each temperature, and FIG. 28B shows the charge capacity ratio. Table 9 shows discharge capacity, charge capacity, and charge capacity ratio. Note that the discharge capacity and the charge capacity are each capacity per weight of the active material, and the charge capacity ratio is expressed in percentage of the charge capacity at each temperature with respect to the charge capacity at 25° C.

TABLE 9

| | Discharge | Charge | Charge |
|---|---|---|---|
| Temperature | capacity | capacity | capacity |
| [° C.] | [mAh/g] | [mAh/g] | ratio [%] |
| 25 | 349.16 | 353.15 | 100.00 |
| 15 | 349.04 | 350.79 | 99.96 |
| 0 | 348.38 | 350.12 | 99.78 |
| −20 | 346.07 | 349.49 | 99.11 |
| −30 | 339.41 | 347.78 | 97.21 |
| −40 | 310.65 | 341.65 | 88.97 |

FIGS. 27A and 27B and FIGS. 28A and 28B, Table 8, and Table 9 confirm that the coin cell, which is an example of the battery of one embodiment of the present invention, can operate as a battery even in a low-temperature environment at 0° C. or lower.

This application is based on Japanese Patent Application Serial No. 2023-119024 filed with Japan Patent Office on Jul. 21, 2023, the entire contents of which are hereby incorporated by reference.

What is claimed is:

1. A battery comprising:
a positive electrode;
a negative electrode;
an electrolyte solution; and
a separator,
wherein the electrolyte solution and the separator are included between the positive electrode and the negative electrode,
wherein the negative electrode comprises a carbon material, and
wherein the electrolyte solution comprises a lithium salt, a potassium salt, a fluorinated cyclic carbonate, a fluorinated linear carbonate, and an anion.

2. The battery according to claim 1,
wherein the carbon material comprises graphite.

3. The battery according to claim 2,
wherein the graphite comprises natural graphite.

4. The battery according to claim 1,
wherein the lithium salt comprises LiPF₆,
wherein the potassium salt comprises KFSI,
wherein the fluorinated cyclic carbonate comprises fluoroethylene carbonate, and
wherein the fluorinated linear carbonate comprises methyl trifluoropropionate.

5. The battery according to claim 2,
wherein the lithium salt comprises LiPF₆,
wherein the potassium salt comprises KFSI,
wherein the fluorinated cyclic carbonate comprises fluoroethylene carbonate, and
wherein the fluorinated linear carbonate comprises methyl trifluoropropionate.

6. The battery according to claim 3,
wherein the lithium salt comprises LiPF₆,
wherein the potassium salt comprises KFSI,
wherein the fluorinated cyclic carbonate comprises fluoroethylene carbonate, and
wherein the fluorinated linear carbonate comprises methyl trifluoropropionate.

7. The battery according to claim 4,
wherein the positive electrode comprises lithium cobalt oxide to which magnesium, aluminum, and nickel are added.

8. The battery according to claim 4,
wherein the positive electrode comprises lithium cobalt oxide to which magnesium, aluminum, nickel, and titanium are added.

9. A battery comprising:
a positive electrode;
a negative electrode;
an electrolyte solution; and
a separator,
wherein the electrolyte solution and the separator are included between the positive electrode and the negative electrode,
wherein the negative electrode comprises a carbon material,
wherein the positive electrode comprises a positive electrode active material,
wherein the positive electrode active material comprises lithium cobalt oxide, magnesium, and aluminum, and
wherein the electrolyte solution comprises a lithium salt, a potassium salt, a fluorinated cyclic carbonate, a fluorinated linear carbonate, and an anion.

10. The battery according to claim 9,
wherein the carbon material comprises graphite.

11. The battery according to claim 9,
wherein the graphite comprises natural graphite.

12. The battery according to claim 9,
wherein the lithium salt comprises LiPF₆,
wherein the potassium salt comprises KFSI,
wherein the fluorinated cyclic carbonate comprises fluoroethylene carbonate, and
wherein the fluorinated linear carbonate comprises methyl trifluoropropionate.

13. The battery according to claim 9,
wherein the positive electrode active material further comprises titanium.

14. A battery comprising:
a positive electrode;
a negative electrode;
an electrolyte solution; and
a separator,
wherein the electrolyte solution and the separator are included between the positive electrode and the negative electrode,
wherein the negative electrode comprises a carbon material,
wherein the positive electrode comprises a positive electrode active material,
wherein the positive electrode active material comprises lithium cobalt oxide, magnesium, aluminum, and nickel, and
wherein the electrolyte solution comprises a lithium salt, a potassium salt, a fluorinated cyclic carbonate, a fluorinated linear carbonate, and an anion.

15. The battery according to claim 14,
wherein the carbon material comprises graphite.

16. The battery according to claim 14,
wherein the graphite comprises natural graphite.

17. The battery according to claim 14,
wherein the lithium salt comprises LiPF₆,
wherein the potassium salt comprises KFSI,
wherein the fluorinated cyclic carbonate comprises fluoroethylene carbonate, and
wherein the fluorinated linear carbonate comprises methyl trifluoropropionate.
